(19) United States
(12) Patent Application Publication
(10) Pub. No.: US 2014/0310196 A1
(43) Pub. Date: Oct. 16, 2014

(54) INFORMATION PROCESSING APPARATUS, INFORMATION PROCESSING METHOD, INFORMATION PROCESSING PROGRAM, AND RECORDING MEDIUM

(71) Applicant: Hiroomi Yamamura, Shinagawa-ku (JP)

(72) Inventor: Hiroomi Yamamura, Shinagawa-ku (JP)

(73) Assignee: RAKUTEN, INC., Shinagawa-ku, Tokyo (JP)

(21) Appl. No.: 14/349,582

(22) PCT Filed: Jul. 31, 2012
(86) PCT No.: PCT/JP2012/069402

§ 371 Date: Apr. 3, 2014

(30) Foreign Application Priority Data
Nov. 28, 2011 (JP) 2011-259080

(51) Int. Cl. G06Q 10/08

(52) U.S. Cl. CPC G06Q 10/083
USPC 705/337

(57) ABSTRACT

An information processing apparatus that allows a user to easily change a delivery date of an ordered item after the date arranged in advance by the user is set as the delivery date is provided. The information processing device includes: a date acquiring means that, when a user has ordered an item without designating a delivery date, acquires an earliest date on which an ordered item can be delivered among dates stored in a date storing means that stores predetermined dates arranged in advance by the user as dates when the user can receive an item; a delivery information storage controlling means that stores delivery information that includes the date acquired by the date acquiring means as a delivery date in a delivery information storing means that stores delivery information that includes a delivery date of an ordered item as delivery information of the ordered item; and a changing means that, when a user has ordered an item by designating a delivery date, changes the delivery date included in the delivery information stored in the delivery information storing means to the designated delivery date.

### TECHNICAL FIELD

The present invention relates to the technical field of an information processing apparatus and an information processing method of arranging a delivery date of an item as information used for delivery of an ordered item.

### BACKGROUND ART

In recent years, electronic commerce where items are sold and bought on the Internet has been active. In the electronic commerce, an item ordered by a user is delivered to the home of the user from an order recipient shop by a home delivery service, a postal service, or the like, for example. Thus, the user can purchase an item at home. Moreover, when ordering an item, the user can designate a delivery date of the item and a time period in which an item is delivered. In this way, the user can receive the item when it is convenient for the user.

However, it is time-consuming for a user to designate a delivery date each time when ordering items. In this regard, Patent Literature 1 discloses a method of designating the date and time when a recipient can receive a cargo in advance. Specifically, a delivery company registers the date and time when a recipient is available to receive a cargo in a calendar and a business office views the calendar to determine whether the recipient can receive the cargo on the delivery date and time desired by a sender and requests a change of the delivery date and time if the recipient cannot receive the cargo.

### PRIOR ART LIST

### Patent Literature

Patent Literature 1: JP 2002-41735 A

### SUMMARY OF THE INVENTION

### Problem to be Solved by the Invention

The method disclosed in Patent Literature 1 may be employed in ordering of items. In this case, an available receipt date designated in advance by a user is set as the delivery date of an ordered item. Thus, the user does not need to designate the delivery date of each order of items.

However, the user may want to change the delivery date that has been arranged in the above-described manner. In this case, the user has to change the delivery date of each of the items of which the delivery dates are set. Thus, it is time-consuming for the user to change the delivery dates.

With the foregoing in view, it is an object of the present invention to provide an information processing apparatus, an information processing method, an information processing program, and a recording medium, capable of allowing a user to easily change a delivery date of an ordered item after the date arranged in advance by the user is set as the delivery date.

### Means for Solving the Problem

In order to solve the above problem, the invention according to claim 1 is an information processing apparatus comprising:

a date acquiring means that, when a user has ordered an item without designating a delivery date, acquires an earliest date on which an ordered item can be delivered among dates stored in a date storing means that stores predetermined dates arranged in advance by the user as dates when the user can receive an item;

a delivery information storage controlling means that stores delivery information that includes the date acquired by the date acquiring means as a delivery date in a delivery information storing means that stores delivery information that includes a delivery date of an ordered item as delivery information of the ordered item; and

a changing means that, when a user has ordered an item by designating a delivery date, changes the delivery date included in the delivery information stored in the delivery information storing means to the designated delivery date.

According to this invention, when a user has ordered an item without designating a delivery date, the earliest date on which the item can be delivered among the dates arranged in advance by the user is set as the delivery date. Moreover, when a user has ordered an item by designating a delivery date, a delivery date of an already ordered item is changed to the presently designated delivery date. Thus, the user does not need to additionally change the delivery date of the already ordered item. Thus, it is possible to easily change the delivery date of an ordered item after the date arranged in advance by the user is set as the delivery date.

The invention according to claim 2 is the information processing apparatus according to claim 1,

wherein the delivery information storing means stores the delivery information for each slip used for delivery of items,

when an item whose delivery information is stored in the delivery information storing means is designated by a user as an item to be delivered in a batch with a presently ordered item, the date acquiring means acquires an earliest date on which both the designated item and the presently ordered item can be delivered from the date storing means, and

the delivery information storage controlling means stores the delivery information that includes the date acquired by the date acquiring means as a delivery date in the delivery information storing means, and arranges the date acquired by the date acquiring means in the delivery date included in the delivery information of the designated item.

According to this invention, when a user has ordered an item without designating a delivery date and has designated to have the presently ordered item and an already ordered item to be delivered in a batch, the delivery dates of the presently ordered item and the already ordered item are the same. Thus, the user can receive the items in a batch.

The invention according to claim 3 is the information processing apparatus according to claim 2, further comprising:

a first determining means that, when a user has ordered an item by designating a delivery date, determines whether an item whose delivery information is stored in the delivery information storing means can be delivered on the designated delivery date,

wherein the changing means changes the delivery date included in the delivery information of an item which is determined by the first determining means to be deliverable on the designated delivery date among the delivery information stored in the delivery information storing means, and does not change the delivery date included in the delivery information of each of a plurality of items when the first determining means determines that at least one of a plurality of items delivered in a batch cannot be delivered on the designated delivery date.

According to this invention, when a user has ordered an item by designating a delivery date, the delivery dates of a plurality of already ordered items which is designated to be delivered in a batch are not changed unless all of the plurality of items can be delivered on the presently designated delivery date. Thus, it is possible to prevent the delivery date of only a portion of the plurality of items designated to be delivered in a batch from being changed. Thus, since the delivery dates of the plurality of items are the same, the user can receive the items in a batch.

The invention according to claim 4 is the information processing apparatus according to any one of claims 1 to 3,

wherein the date storing means stores the date in association with identification information for identifying a user who has arranged the date when the user can receive an item,

an earliest date on which the ordered item can be delivered among the dates associated with the identification information of the user who has ordered an item and the date associated with the identification information of another user having the same address as the user is acquired.

According to this invention, when another user having the same address as the user who has ordered an item is present, the date arranged in advance by the other user may be set as the delivery date of the ordered item. Thus, another user can receive the item even when it is not convenient for the user who has ordered the item. As a result, the user who has ordered the item can receive the item.

The invention according to claim 5 is the information processing apparatus according to any one of claims 1 to 4,

wherein the delivery information storing means stores the delivery information in association with the identification information of a user who has ordered an item, and

the changing means changes the delivery date included in the delivery information associated with the identification information of the user who has ordered the item, and the delivery date included in the delivery information associated with the identification information of another user having the same address as the user.

According to this invention, when another user having the same address as the user who has ordered an item is present, the delivery date of an item that has already been ordered by the other user is changed to the delivery date designated by the user who has ordered the present item. Thus, the user who has ordered the present item can receive the item ordered by the other user. As a result, the other user can receive the item ordered by himself/herself.

The invention according to claim 6 is the information processing apparatus according to any one of claims 1 to 5,

wherein the date storing means stores the date in association with identification information for identifying a user who has arranged the date when the user can receive an item,

the information processing apparatus further comprises an identification information acquiring means that, when the user who has ordered an item has input specific information that specifies another user who receives the ordered item, acquires the identification information of the another user based on the specific information, and

the date acquiring means acquires an earliest date on which the ordered item can be delivered among the dates associated with the identification information acquired by the identification information acquiring means.

According to this invention, when a user who orders an item has input information that specifies a recipient using another user different from the user as the recipient, the earliest date on which the item can be delivered among the dates arranged in advance by the recipient is set as the delivery date. Thus, even when the recipient is different from the user who orders the item, the recipient can receive an item when it is convenient for the recipient.

The invention according to claim 7 is the information processing apparatus according to any one of claims 1 to 6, further comprising:

a second determining means that, when a user has ordered an item by designating a delivery date, determines whether the delivery date included in the delivery information stored in the delivery information storing means is later than the designated delivery date,

wherein the changing means changes the delivery date which is determined by the second determining means to be later than the designated delivery date among the delivery dates included in the delivery information stored in the delivery information storing means, to the designated delivery date.

According to this invention, when a user has ordered an item by designating a delivery date, the delivery date of an already ordered item can be changed in such a manner of shifting the delivery date ahead. Thus, it is possible to prevent the delivery of an item from being delayed.

The invention according to claim 8 is the information processing apparatus according to any one of claims 1 to 7, further comprising:

a transmitting means that, when the changing means has changed the delivery date to a delivery date that is earlier than the delivery date before changing, sends an email for notifying a user who receives an item of the change in the delivery date.

According to this invention, when the delivery date of an already ordered item is brought forward, a notification is sent to the user. Thus, it is possible to prevent a deliveryman from going out to deliver an item when the user is not informed of.

The invention according to claim 9 is the information processing apparatus according to any one of claims 1 to 8,

wherein the delivery information storing means stores the delivery information for each slip used for delivery of items, the information processing apparatus,

the information processing apparatus further comprising:

a completion information acquiring means that acquires completion information indicating completion of delivery of an item whose delivery information is stored in the delivery information storing means;

a third determining means that, when the completion information is acquired by the completion information acquiring means, determines whether a plurality of items having different slips has been received in a batch by the user; and

a first reward information storage controlling means, when the third determining means determines that a plurality of items having different slips has been received in a batch by the user, stores reward information in a reward information storing means that stores the reward information indicating a reward that the user obtains.

According to this invention, when the user has received a plurality of items which is handled separately with regard to delivery in a batch, a reward is granted to the user. Thus, it can be expected that the user receives a plurality of items in a batch. Thus, it is possible to prevent the deliveryman from going out to deliver to the same address many times.

The invention according to claim 10 is the information processing apparatus according to any one of claims 1 to 9, further comprising:

a fourth determining means that determines whether the item has been received by the user at the first delivery based on a history stored in a history storing means that stores the history of a delivery state of an item whose delivery information is stored in the delivery information storing means; and

a second reward information storage controlling means that, when the fourth determining means determines that the item has been received by the user at the first delivery, stores the reward information in a reward information storing means that stores the reward information indicating reward information that the user obtains.

According to this invention, when a user has received an item at the first delivery, a reward is granted to the user. Thus, it can be expected that the user receives the item on the delivery date. Thus, it is possible to prevent the deliveryman from going out to deliver the same item many times.

The invention according to claim 11 is an information processing method, which is executed by an information processing apparatus,

the information processing method comprising:

a date acquiring step of, when a user has ordered an item without designating a delivery date, acquiring an earliest date on which an ordered item can be delivered among dates stored in a date storing means that stores predetermined dates arranged in advance by the user as dates when the user can receive an item;

a delivery information storage controlling step of storing delivery information that includes the date acquired by the date acquiring step as a delivery date in a delivery information storing means that stores delivery information that includes a delivery date of an ordered item as delivery information of the ordered item; and

a changing step of, when a user has ordered an item by designating a delivery date, changing the delivery date included in the delivery information stored in the delivery information storing means to the designated delivery date.

The invention according to claim 12 is an information processing program for causing a computer included in an information processing apparatus to function as:

a date acquiring means that, when a user has ordered an item without designating a delivery date, acquires an earliest date on which an ordered item can be delivered among dates stored in a date storing means that stores predetermined dates arranged in advance by the user as dates when the user can receive an item;

a delivery information storage controlling means that stores delivery information that includes the date acquired by the date acquiring means as a delivery date in a delivery information storing means that stores delivery information that includes a delivery date of an ordered item as delivery information of the ordered item; and

a changing means that, when a user has ordered an item by designating a delivery date, changes the delivery date included in the delivery information stored in the delivery information storing means to the designated delivery date.

The invention according to claim 13 is a recording medium having stored thereon a computer-readable information processing program, which causes a computer included in an information processing apparatus to function as:

a date acquiring means that, when a user has ordered an item without designating a delivery date, acquires an earliest date on which an ordered item can be delivered among dates stored in a date storing means that stores predetermined dates arranged in advance by the user as dates when the user can receive an item;

a delivery information storage controlling means that stores delivery information that includes the date acquired by the date acquiring means as a delivery date in a delivery information storing means that stores delivery information that includes a delivery date of an ordered item as delivery information of the ordered item; and

a changing means that, when a user has ordered an item by designating a delivery date, changes the delivery date included in the delivery information stored in the delivery information storing means to the designated delivery date.

### Advantageous Effects of the Invention

According to this invention, when a user has ordered an item without designating a delivery date, the earliest date on which the item can be delivered among the dates arranged in advance by the user is set as the delivery date. Moreover, when a user has ordered an item by designating a delivery date, a delivery date of an already ordered item is changed to the presently designated delivery date. Thus, the user does not need to additionally change the delivery date of the already ordered item. Thus, it is possible to easily change the delivery date of an ordered item after the date arranged in advance by the user is set as the delivery date.

### BRIEF DESCRIPTION OF THE DRAWINGS

FIG. 1 is a diagram illustrating an example of a schematic configuration of a delivery system S according to an embodiment.

FIG. 2 is a diagram illustrating the flow of an online mall's home delivery service from ordering of items to delivery of items.

FIG. 3 illustrates a screen display example of an available receipt date and time arrangement calendar page.

FIGS. 4A and 4B are diagrams illustrating an example of determining a scheduled delivery date and time when a user has not designated a delivery date and time during ordering of items and FIGS. 4C and 4D are diagrams illustrating an example of determining a scheduled delivery date and time when the user has designated a delivery date and time during ordering of items.

FIG. 5A is a diagram illustrating an example of contents registered in a membership information DB 1a, FIG. 5B is a diagram illustrating an example of contents registered in an item information DB 22a, and FIG. 5C is a diagram illustrating an example of contents registered in a purchase history DB 22b.

FIG. 6 is a block diagram illustrating an example of a schematic configuration of an online mall server 2 according to an embodiment.

FIG. 7 is a block diagram illustrating an example of a schematic configuration of a home delivery server 3 according to an embodiment.

FIG. 8A is a diagram illustrating an example of contents registered in a service area information DB 32a, FIG. 8B is a diagram illustrating an example of contents registered in a distribution center information DB 32b, FIG. 8C is a diagram illustrating an example of contents registered in an available receipt date and time information DB 32c, FIG. 8D is a diagram illustrating an example of contents registered in a delivery management information DB 32d, and FIG. 8E is a diagram illustrating an example of contents registered in a delivery state history DB 32e.

FIG. 9 is a diagram illustrating an example of transitions of webpages until an order of items is completed.

FIG. 10 is a diagram illustrating a screen display example of a payment and delivery method selection page.

FIG. 11 is a diagram illustrating a screen display example of a batch delivery item selection page.

FIG. 12 is a flowchart illustrating a processing example of a payment and delivery method selection page transmission process of a system control unit 24 of an online mall server 2 according to an embodiment.

FIG. 13 is a flowchart illustrating a processing example of a delivery request information reception process of a system control unit 34 of a home delivery server 3 according to an embodiment.

FIG. 14 is a flowchart illustrating a processing example of a delivery request information reception process of the system control unit 34 of the home delivery server 3 according to an embodiment.

FIG. 15 is a flowchart illustrating a processing example of a scheduled delivery date and time determining process of the system control unit 34 of the home delivery server 3 according to an embodiment.

FIG. 16 is a flowchart illustrating a processing example of a scheduled delivery date and time changing process of the system control unit 34 of the home delivery server 3 according to an embodiment.

FIG. 17 is a flowchart illustrating a processing example of a scheduled delivery date and time changing process of the system control unit 34 of the home delivery server 3 according to an embodiment.

FIG. 18 is a flowchart illustrating a processing example of a batch delivery item selection page request reception process of the system control unit 34 of the home delivery server 3 according to an embodiment.

FIG. 19 is a flowchart illustrating a processing example of a batch delivery information reception process of the system control unit 34 of the home delivery server 3 according to an embodiment.

FIG. 20 is a flowchart illustrating a processing example of a delivery state information reception process of the system control unit 34 of the home delivery server 3 according to an embodiment.

FIG. 21 is a flowchart illustrating a processing example of a delivery state information reception process of the system control unit 34 of the home delivery server 3 according to an embodiment.

FIG. 22 is a sequence diagram illustrating a processing example during viewing of the delivery state of the delivery system S according to an embodiment.

FIG. 23 is a diagram illustrating a screen display example of a delivery state list page.

FIG. 24 is a diagram illustrating a screen display example of a delivery date and time change candidate list page.

### MODE FOR CARRYING OUT THE INVENTION

Hereinafter, embodiments of the present invention will be described in detail with reference to the drawings. Also, the embodiments described below are embodiments in a case where the present invention is applied to a delivery system.

[1. Overview of Configuration and Function of Delivery System]

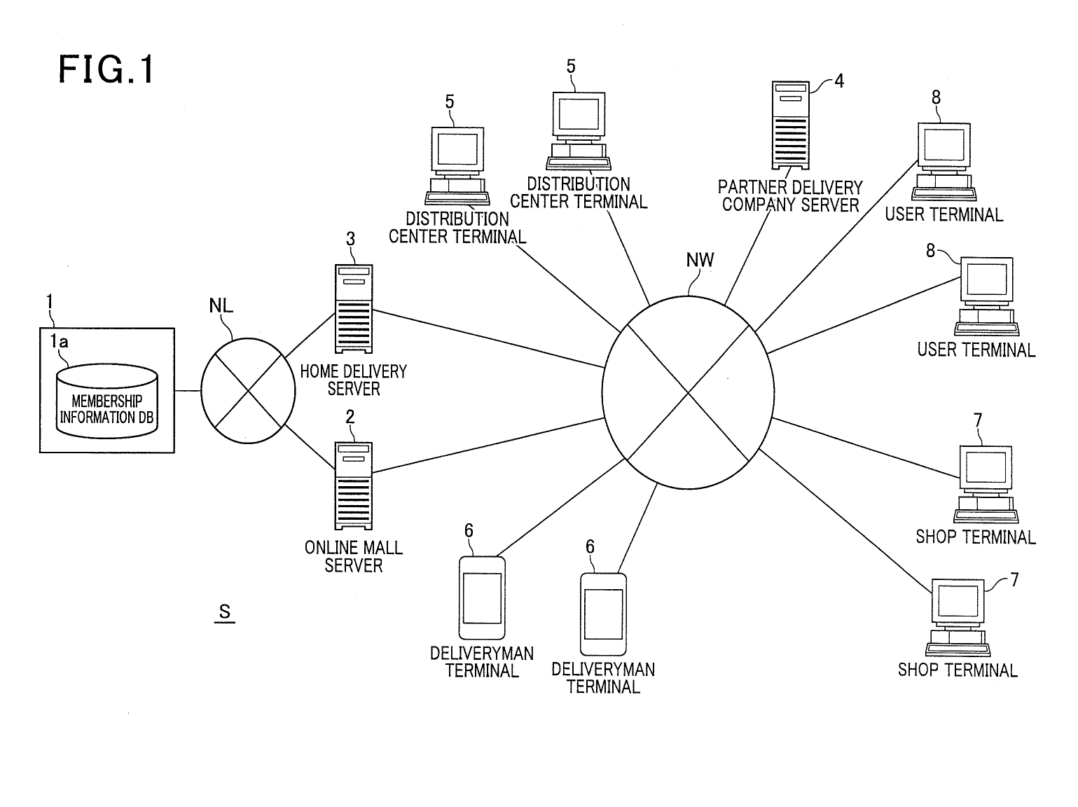

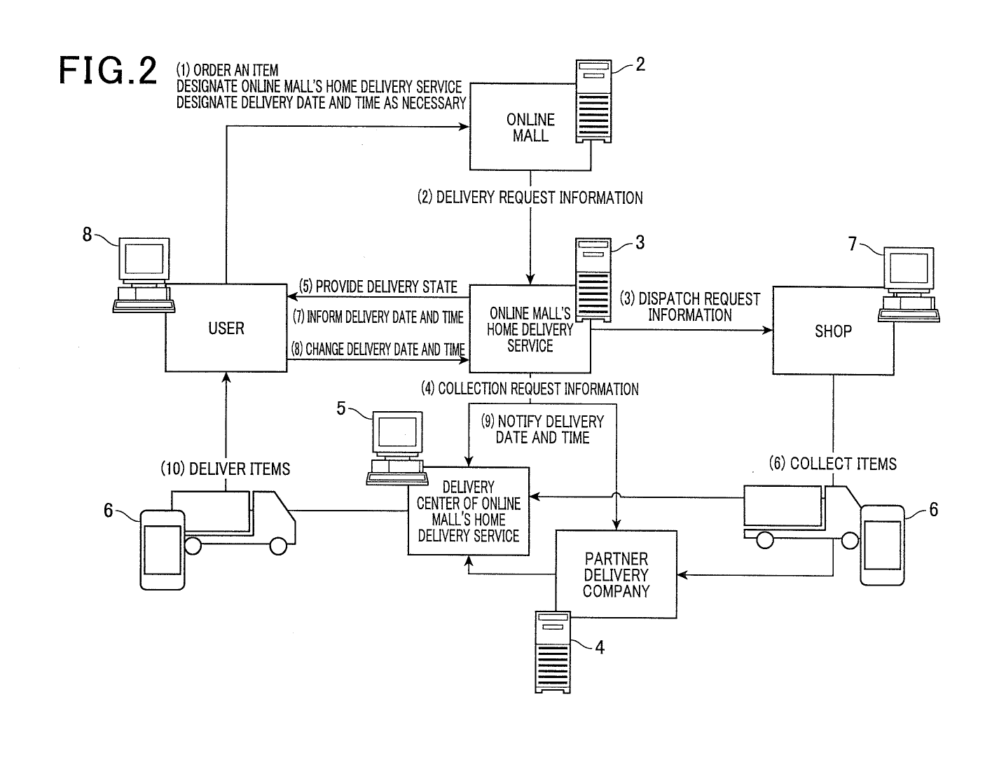

First, the overview of the configuration and function of a delivery system S according to the present embodiment will be described with reference to FIGS. 1 and 2. FIG. 1 is a diagram illustrating an example of a schematic configuration of the delivery system S according to the present embodiment.

As illustrated in FIG. 1, the delivery system S is configured to include a database management server 1, an online mall server 2, a home delivery server 3, a partner delivery company server 4, a plurality of distribution center terminals 5, a plurality of deliveryman terminals 6, a plurality of shop terminals 7, and a plurality of user terminals 8. The online mall server 2, the home delivery server 3, the partner delivery company server 4, the distribution center terminal 5, the deliveryman terminal 6, the shop terminal 7, and the user terminal 8 can transmit and receive data to and from each other through a network NW by using, for example, TCP/IP or the like as a communication protocol. The network NW is constructed by, for example, the Internet, a dedicated communication line (for example, a community antenna television (CATV) line), a mobile communication network (including a base station and the like), a gateway, and the like. Moreover, the database management server 1, the online mall server 2, and the home delivery server 3 can transmit and receive data to and from each other via a network NL. The network NL is a local area network (LAN), for example.

The database management server 1, the online mall server 2, and the home delivery server 3 are server apparatuses that belong to a domain of a service providing site operated by a company X which is a company that provides an comprehensive Internet service. The service providing site is a website for providing various services to users through a network. When a user registers as a member of the service providing site, the user can use services of various sites that belong to the service providing site.

The database management server 1 manages databases in which a plurality of pieces of common information used by various server apparatuses that belong to the domain of the service providing site is registered. For example, the database management server 1 manages a membership information database (DB) 1a which is a database of information on members of the service providing site. In the present embodiment, when the online mall server 2 or the home delivery server 3 acquires information from the membership information DB 1a, it means that the home delivery server 3 or the online mall server 2 receives information registered in the membership information DB 1a from the database management server 1 by transmitting a request to the database management server 1.

The online mall server 2 is a server apparatus that executes various processes associated with online malls that belong to the service providing site. A plurality of shops is open on an online mall as sellers of items. Each shop provides items by sending an item purchased on an online mall to a user or the like. The user can purchase a desired item from a desired shop by using the online mall. The online mall server 2 transmits a webpage of an online mall and performs processes associated with retrieving, purchasing, or the like of items, for example, in response to a request from the user terminal 8.

The home delivery server 3 is a server apparatus that executes various processes associated with an online mall's home delivery service. The home delivery server 3 is an example of an information processing apparatus of the present invention. The online mall's home delivery service is a home delivery service for delivering items purchased on an online mall. A user can select a delivery method of items when ordering items on an online mall. The online mall's home delivery service is one of selectable delivery methods. By using the online mall's home delivery service, the user can enjoy the merits that the delivery fee is lower than other home delivery services and the user can check a delivery state of items and change the delivery date and time on a website, for example. The company X has distribution centers at various areas and charters transportation trucks in order to operate the online mall's home delivery service. The distribution centers are facilities for collecting items and distributing the collected items. At present, the distribution centers of the online mall's home delivery service are located in partial areas of the whole country of Japan. Thus, the areas as a delivery destination of items where the online mall's home delivery service is available are restricted. In the future, the distribution centers of the online mall's home delivery service may be located all over Japan, and the online mall's home delivery service may become available in any area of Japan.

The partner delivery company server 4 is a server apparatus provided by a company Y which is a delivery company. The partner delivery company server 4 is a server apparatus that executes various processes associated with a home delivery service operated by the company Y. When items are delivered by an online mall's home delivery service, it is necessary to collect items from a shop located in an area as delivery destination where the online mall's home delivery service is not available. Thus, the companies X and Y make partnership agreements. The company Y collects items in areas as the delivery destination where the online mall's home delivery service is not available. The home delivery server 3 and the partner delivery company server 4 exchange information with each other to allow the company X to request the company Y to collect items and allow the company Y to notify the company X of a collection status of items.

The distribution center terminal 5 is a terminal apparatus provided in the distribution center. The distribution center terminal 5 includes a terminal apparatus provided in a distribution center of the online mall's home delivery service and a terminal apparatus provided in a distribution center of the company Y. The distribution center terminal 5 of the distribution center of the online mall's home delivery service accesses the home delivery server 3 based on an operation of an employee of the distribution center. Moreover, the distribution center terminal 5 of the distribution center of the company Y accesses the partner delivery company server 4. As a result, the distribution center terminal 5 receives a webpage from the server apparatus and displays the webpage. Software such as a browser or an email client is incorporated into the distribution center terminal 5. Moreover, a barcode reader or the like for reading a slip number from a delivery slip attached to an item is connected to the distribution center terminal 5. The delivery slip is a slip used for delivery by the online mall's home delivery service. The slip number is an identification number for identifying the delivery slip. An employee can check information such as a scheduled delivery date and time of items and register a collection status and a delivery state of items, for example, using the distribution center terminal 5. The scheduled delivery date and time is the date and the time period when delivery of an item is scheduled. The date in the scheduled delivery date and time is an example of a delivery date included in delivery information in the present invention. A personal computer or the like, for example, is used as the distribution center terminal 5.

The deliveryman terminal 6 is a portable terminal apparatus used by a deliveryman who collects and delivers items using a transportation truck. The deliveryman terminal 6 includes a terminal apparatus of the online mall's home delivery service and a terminal apparatus of the company Y. The deliveryman terminal 6 of the online mall's home delivery service accesses the home delivery server 3 based on an operation of a deliveryman. Moreover, the deliveryman terminal 6 of the company Y accesses the partner delivery company server 4. As a result, the deliveryman registers the collection status or the delivery state of items, for example. The deliveryman terminal 6 includes a barcode reader or the like for reading a slip number from a delivery slip.

The shop terminal 7 is a terminal apparatus used by an employee or the like of a shop that is open on an online mall. The shop terminal 7 accesses the server apparatus such as the online mall server 2 based on an operation of an employee or the like. As a result, the shop terminal 7 receives a webpage from the server apparatus and displays the webpage. Software such as a browser or an email client is incorporated into the shop terminal 7. The employee can register information on items to be sold to the online mall and checks the contents of an order of an item, for example, using the shop terminal 7. A personal computer or the like, for example, is used as the shop terminal 7.

The user terminal 8 is a terminal apparatus of a user who uses various websites. The user terminal 8 accesses the server apparatus of the online mall server 2, the home delivery server 3, and the like based on an operation of a user. As a result, the user terminal 8 receives a webpage from the server apparatus and displays the webpage. Software such as a browser or an email client is incorporated into the user terminal 8. A personal computer, a mobile information terminal such as a personal digital assistant (PDA) or a smartphone, a mobile phone, or the like, for example, is used as the user terminal 8.

FIG. 2 is a diagram illustrating the flow of the online mall's home delivery service from ordering of items to delivery of items.

As illustrated in FIG. 2, a user operates the user terminal 8 to order an item on an online mall (see (1) in FIG. 2). In this case, the user designates an online mall's home delivery service as a delivery method. Moreover, the user designates a delivery date and time as necessary. A user who orders an item is referred to as an “orderer.” Moreover, an item that is ordered at this time is referred to an “ordered item.”

Upon receiving an order that designates an online mall's home delivery service as a delivery method, the online mall server 2 transmits delivery request information to the home delivery server 3 (see (2) in FIG. 2). The delivery request information is information for requesting the online mall to deliver an item via the online mall's home delivery service. The home delivery server 3 registers delivery management information based on the delivery request information. The delivery management information is information used for management of delivery of items. The delivery management information is an example of delivery information in the present invention.

The home delivery server 3 transmits dispatch request information to the shop terminal 7 of an order recipient shop of an item based on the delivery management information (see (3) in FIG. 2). The dispatch request information is information for requesting a shop to dispatch items. The shop terminal 7 displays the dispatch request information on a screen, for example. The shop performs preparations for dispatching of items and requests the online mall's home delivery service to issue a slip number to be displayed in a delivery slip of the ordered item based on the dispatch request information. Then, the home delivery server 3 issues the slip number and transmits the slip number to the shop terminal 7. The shop prints or writes the issued slip number and the address, the name, the zip code, the telephone name, and the like of a destination on the delivery slip. Then, the shop attaches the delivery slip to the package of an item. Depending on an item, the item may not exist in the order recipient shop and may be ordered from the manufacturer of the item. In this case, the shop requests the manufacturer to dispatch the item and sends the delivery slip to the manufacturer. The online mall server 2 may transmit the dispatch request information to the shop terminal 7 rather than that the home delivery server 3 transmits the dispatch request information. Since the online mall server 2 also has information equivalent to the delivery management information, the online mall server 2 can also transmit the dispatch request information.

Moreover, the home delivery server 3 transmits collection request information to the distribution center terminal 5 of a distribution center that is in charge of collecting an ordered item based on the delivery management information (see (4) in FIG. 2). The collection request information is information for requesting the distribution center to collect items. Here, when the distribution center in charge of collection is the distribution center of the company Y, the home delivery server 3 transmits the collection request information to the partner delivery company server 4. Moreover, the partner delivery company server 4 transmits the collection request information to the distribution center terminal 5. The distribution center terminal 5 displays the collection request information on a screen, for example. An employee of the distribution center performs preparations for collection of items based on the collection request information.

When the delivery management information is registered, the home delivery server 3 enables the delivery state of the ordered item to be provided to the user (see (5) in FIG. 2). For example, when an item is dispatched from a shop, an item is moved to a distribution center, an item is delivered to a recipient of an item from a distribution center, delivery of an item is completed, or the like, the deliveryman may input the item delivery state to the deliveryman terminal 6 or an employee of the distribution center may input the item delivery state to the distribution center terminal 5. The input delivery state is managed by the home delivery server 3. The user can check the delivery state or the scheduled delivery date of the item in a delivery state list page which is a webpage that displays the delivery state. Moreover, the user can change the scheduled delivery date and time as necessary. When the user has designated the delivery date and time during ordering of an item, the designated delivery date and time is the scheduled delivery date and time.

The distribution center collects an ordered item from a shop based on the collection request information (see (6) in FIG. 2). Specifically, a deliveryman goes to the shop or the address of the manufacturer by a transportation truck and receives an item from the shop or the manufacturer. Moreover, the deliveryman transports the received item to the distribution center. After that, the collected item is redirected to a distribution center that is in charge of delivery to the address of the destination. The item collected to the distribution center of the company Y is also finally sent to the distribution center of the online mall's home delivery service. The company X increases the capacity of the individual distribution centers or decreases the number of distribution centers. In this way, the company X decreases the number of distribution centers that an item has to pass through from the distribution center that collected the item to the distribution center in charge of delivery. In this way, the online mall's home delivery service reduces the number of days required for delivering an item.

Before the distribution center in charge of delivery of an item loads the item on a transportation truck in order to deliver the item, the notice thereof is transmitted from the distribution center terminal 5 to the home delivery server 3. Moreover, the home delivery server 3 sends a delivery date and time notification email which is an email for informing the scheduled delivery date and time of an item loaded on the transportation truck to the user (see (7) in FIG. 2).

Immediately before the scheduled delivery date and time, the user may become unable to receive an item, for example, because the user goes outside on the scheduled delivery date and time. Thus, the user having checked the scheduled delivery date and time by the delivery date and time notification email changes the delivery date and time by replying to the delivery date and time notification email. In this case, the user writes a new scheduled delivery date and time in the response email. In this way, the user can change the scheduled delivery date and time (see (8) in FIG. 2). Even when the user is outside, an email address of a mobile phone is used as an email address of a destination of the delivery date and time notification email so that the scheduled delivery date and time is surely notified to the user. The user can change the scheduled delivery date and time at anytime by accessing the delivery state list page.

When the scheduled delivery date and time is changed, the home delivery server 3 transmits the changed scheduled delivery date and time to the distribution center terminal 5 of the distribution center in charge of delivery of an item and the deliveryman terminal 6 of the deliveryman who delivers the item (see (9) in FIG. 2).

The deliveryman delivers the item to the address of the user on the date and the time period indicated by the scheduled delivery date and time (see (10) in FIG. 2). When the scheduled delivery date and time is changed, the item is delivered on the changed scheduled delivery date and time.

### [2. Designation of Delivery Date and Time]

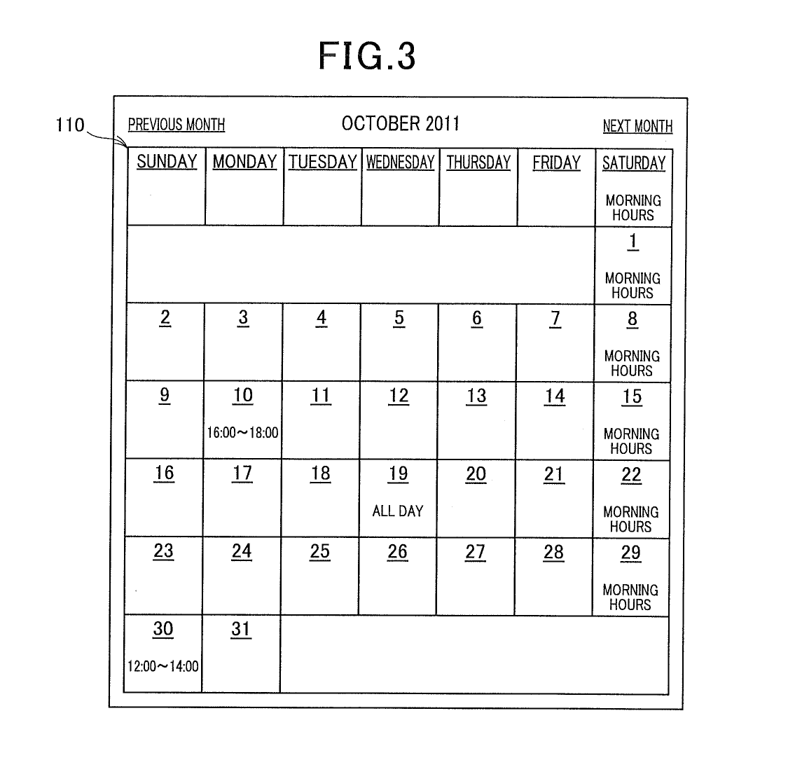

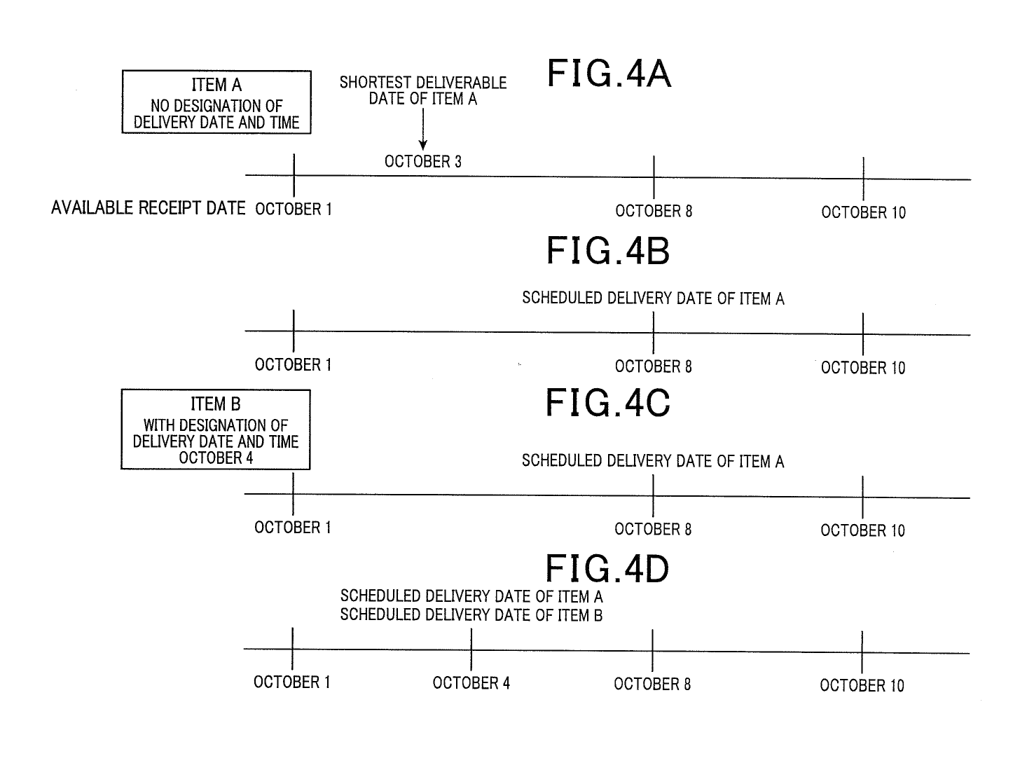

In the online mall's home delivery service, the user can designate the delivery date and time when ordering an item. The delivery date and time in the present embodiment is the date and the time period when an item is to be delivered. Examples of the designable time period includes the morning hours (8:00 to 12:00) and the time periods 12:00 to 14:00, 14:00 to 16:00, 16:00 to 18:00, 18:00 to 20:00, 20:00 to 21:00, and the like. The online mall's home delivery service provides a mechanism that the delivery date and time of an item ordered on an online mall can be easily designated by the user. This mechanism will be described with reference to FIGS. 3 and 4.

### [2-1. Setting of Available Receipt Date and Time]

In the online mall's home delivery service, the user can arrange the date and time when the user is available to receive an item in advance. The date and the time period at which the user is available to receive an item is referred to an “available receipt date and time.” The date in the available receipt date and time is an example of a preset date in the present invention. A plurality of available receipt dates and times can be set. When the user has not designated the delivery date and time during ordering of an item, a preset available receipt date is automatically set as a scheduled delivery date and time of the item. Thus, the user can receive the item when it is convenient for the user even when the user has not designated the delivery date and time of each order. This mechanism is particularly convenient for users who frequently purchase items on an online mall.

FIG. 3 is a screen display example of an available receipt date and time arrangement calendar page. The available receipt date and time arrangement calendar page is a webpage for allowing users to arrange an available receipt date and time. The available receipt date and time arrangement calendar page is transmitted from the home delivery server 3 when the user terminal 8 accesses the home delivery server 3.

As illustrated in FIG. 3, a calendar 110 or the like is displayed in the available receipt date and time arrangement calendar page. The calendar 110 is a calendar that shows an available receipt date and time. Specifically, the calendar 110 includes cells of respective days of a week, and cells of respective dates of the month and year designated by the user are displayed so as to correspond to the cells of respective days of a week. A time period at which the user is available to receive an item is displayed in a cell of a date that the user has designated as the date when the user is available to receive the item. When the user has designated the date only but not designated the time period, “all day” is displayed in the cell of the date. In the example of FIG. 3, 16:00 to 18:00 on October 10, and the like are arrange as the available receipt date and time.

When a user selects a cell of a certain date, a time period selection window is displayed on the user terminal 8. A check box or the like for selecting an available receipt time period is displayed on the time period selection window. When a user selects a certain time period in the time period selection window, the selected date and time period is set as the available receipt date and time. Moreover, when all day is selected in the time period selection window, all day of the selected date is set as the available receipt time period. In this case, practically, the selected date and 8:00 to 21:00 is set as the available receipt date and time. Moreover, when a user disables the selected all time periods and all day in the time period selection window, the selected dates are removed from the available receipt date. Moreover, when a user selects a cell of a certain day of a week, the time period selection window is displayed. In this way, the user can designate the available receipt date and time in respective days of a week. In the example of FIG. 3, the morning hours on Saturdays are set as the available receipt date and time.

FIGS. 4A and 4B are diagrams illustrating an example of determining a scheduled delivery date and time when a user has not designated a delivery date and time during ordering of items. In order to make it easy to understand, a case where only the available receipt date among the available receipt date and the available receipt time period is set as the available receipt date and time will be described as an example.

As illustrated in FIG. 4A, it is assumed that the user has arranged the dates October 1, October 8, and October 10 as the available receipt dates, for example. It is also assumed that the user has ordered an item A without designating the delivery date and time. In this case, the scheduled delivery date and time is determined by the home delivery server 3.

When an order of an item is received, the date and time when the ordered item can be delivered the earliest is calculated. This date and time will be referred to as a “shortest deliverable date and time.” The item can be delivered on a date which is on or later than the shortest deliverable date and time. The shortest deliverable date and time is determined based on the number of days or the like required for delivering an item, for example. This number of day or the like is determined based on an ordered item, the address of an item destination, or the like, for example. In the example of FIG. 4A, October 3 is determined as the shortest deliverable date and time of the item A.

The home delivery server 3 determines an earliest date and time on which the item can be delivered among the arranged available receipt dates and times as the scheduled delivery date and time. In the example of FIG. 4A, the dates October 8 and October 10 among the available receipt dates are the dates when the item A can be delivered. Moreover, the date October 8 is earlier among the dates October 8 and October 10. Thus, as illustrated in FIG. 4B, the date October 8 is determined as the scheduled delivery date. As a result, the user can receive the item the earliest date and time among the dates and times when it is convenient for the user.

Moreover, for example, it is assumed that the earliest deliverable date of the item A is the date October 12. In this case, an available receipt date when the item A can be delivered is not present. Thus, in this case, the date October 12 which is the earliest deliverable date is determined as the scheduled delivery date. When no available receipt date is set, the earliest deliverable date is determined as the scheduled delivery date.

Moreover, when an ordered item is dispatched from a shop of an order recipient, a rough date when the item will be dispatched from the shop is determined. Thus, the shortest deliverable date and time can be determined at the point in time when an order is placed. On the other hand, when an ordered item is ordered from a manufacturer, the date when the item will be dispatched from the manufacturer is not identifiable. Thus, the shortest deliverable date and time is not determined at the point in time when an order is placed. In this case, the shortest deliverable date and time is determined when an item is dispatched from the manufacturer (that is, when the deliveryman receives the item from the manufacturer).

When only the delivery time period among the delivery date and the delivery time period is designated as the delivery date and time, the method of determining the scheduled delivery date and time is optional. For example, the home delivery server 3 may determine the date when the designated delivery time period comes first on or later than the shortest deliverable date and time as the scheduled delivery date and time and may determine the designated delivery time period as the scheduled delivery date and time determining process. For example, it is assumed that the designated time period is the period 14:00 to 16:00 and the shortest deliverable date and time is the period 20:00 to 21:00 on October 1. In this case, the period 14:00 to 16:00 on October 2 is the scheduled delivery date and time. Moreover, for example, the home delivery server 3 may determine an available receipt date of an available receipt date and time of which the available receipt date is the earliest among the available receipt dates and times of which the available receipt time period includes the designated delivery time period as the scheduled delivery date and time and may determine the designated delivery time period as the scheduled delivery date and time determining process. For example, it is assumed that the designated time period is 14:00 to 16:00 and the available receipt dates and times later than the shortest deliverable date and time are the time period 12:00 to 14:00 on October 2, all day on October 3, and the time period 14:00 to 16:00 on October 4. In this case, the time period 14:00 to 16:00 on October 3 is determined as the scheduled delivery date and time.

### [2-2. Automated Change of Scheduled Delivery Date and Time of Already Ordered Item]

In an online mall's home delivery service, when a user orders an item by designating at least the delivery date among the delivery date and the delivery time period as the delivery date and time, a scheduled delivery date and time of an item that has already been ordered is changed to the delivery date and time designated presently. The item that has already been ordered is referred to as an “already ordered item.” Although a scheduled delivery date and time of an item ordered without designating the delivery date and time is automatically arranged when a user sets an available receipt date and time, the user may become unavailable to receive the item on the scheduled delivery date and time. In this case, it is necessary to change the scheduled delivery date and time.

On the other hand, although a scheduled delivery date and time of an ordered item is automatically arranged when the user arranges an available receipt date and time, there is a possibility that, when the user designates the delivery date and time, the user wants to receive the item on a date and time other than the arranged available receipt date and time. Alternatively, there is a possibility that the user wants to explicitly designate the date and time when the user receives the item among a plurality of arranged available receipt dates and times. In this case, there is a possibility that the user wants to change the scheduled delivery date and time of the already ordered item to the delivery date and time designated presently. Thus, in this case, when the home delivery server 3 changes the scheduled delivery date and time of the already ordered item, the user does not need to perform operations to change the scheduled delivery date and time of the respective already ordered items. Although the user does not want to change the scheduled delivery date and time of the already ordered item, the user may think that the user can receive the already ordered item on the designated delivery date and time. Thus, no problem occurs even when the scheduled delivery date and time of the already ordered item is changed.

FIGS. 4C and 4D are diagrams illustrating an example of determining the scheduled delivery date and time when the user has not designated the delivery date and time during ordering of an item.

As described above with reference to FIGS. 4A and 4B, it is assumed that October 8 is determined as the scheduled delivery date of the item A. It is also assumed that, after that, as illustrated in FIG. 4C, the user orders an item B by designating the delivery date. In this case, the delivery date of the item B is October 4. Then, as illustrated in FIG. 4D, October 4 is the scheduled delivery date and time of the item. B. Moreover, the scheduled delivery date and time of the item A which is an already ordered item is changed from October 8 to October 4.

For example, it is assumed that the designated delivery date and time is October 2. Since the earliest deliverable date of the item A is October 3, the item A cannot be delivered on October 2. Thus, although the scheduled delivery date and time of the item B is changed to October 2, the delivery date and time of the item A is not changed.

After that, when the user designates the delivery date and time during ordering of an item, the scheduled delivery date and time of the already ordered item is changed. For example, when the user designates an item C by designating October 5 as the delivery date and time, the scheduled delivery date and time of the item C is changed to October 5 and the scheduled delivery date and time of the items A and B is changed to October 5.

When the scheduled delivery date and time of the already ordered item is changed so that the changed scheduled delivery date and time of the already ordered item is earlier than the scheduled delivery date and time of the already ordered item before changing, the home delivery server 3 sends a delivery date and time change notification email. The delivery date and time change notification email is an example of an email for notifying a change in the scheduled delivery date and time according to the present invention. The reason why the delivery date and time change notification email is sent is to prevent a deliveryman from moving to deliver an item on the changed scheduled delivery date and time in a state where the user is not informed of. When the user is informed, from the delivery date and time change notification email, of the fact that the scheduled delivery date and time has been brought forward, the user can change the scheduled delivery date and time as necessary.

Moreover, the user can select an option so that the scheduled delivery date and time of an item to be ordered is not changed automatically when ordering an item.

[2-3. When Orderer Address is Different from Recipient Address]

When a user orders an item, the item is generally delivered to the address of the ordering user. Specifically, the item is delivered to the address set in the membership information of the orderer. The address set in the membership information of the orderer is referred to as a “registered membership address.” On the other hand, the user can designate a person other than the user as a recipient by inputting information such as the address or the name of a recipient of an item as a destination of the item when ordering the item. Information indicating the destination of an item is referred to as “destination information.” The method of determining the scheduled delivery date and time of the item of this case will be described. The destination information input by the user when ordering an item is an example of specific information in the present invention. The destination information is information that can specify a recipient of an item.

When an orderer has ordered an item without designating a delivery date and time and a recipient is a member of a service providing site, an earliest date and time when the ordered item can be delivered among the available receipt dates and times arranged by the recipient is determined as the scheduled delivery date and time. For example, whether the recipient is a member of the service providing site can be determined based on the input destination information.

When an orderer has ordered an item without designating a delivery date and time and a recipient is not a member of the service providing site, the shortest deliverable date and time of the ordered item is determined as the scheduled delivery date and time.

When the orderer has ordered an item by designating a delivery date and time, the designated delivery date and time is determined as a scheduled delivery date and time. Moreover, in this case, the scheduled delivery date and time of the already ordered item when the item is to be delivered to the recipient is not changed regardless of whether the recipient is a member of the service providing site. This is because it is not reasonable that the scheduled delivery date and time of the already ordered item when the item is to be delivered to the recipient is changed according to the delivery date and time designated by other person.

### [2-4. Family Registration]

A service providing site allows users to register as a family membership. This is referred to as “family registration.” As a result, a user can receive a service using the information of another user registered as a family. In an online mall's home delivery service, the scheduled delivery date and time of an item may be determined based on the information of a user registered as a family.

Hereinafter, a case where users U1 and U2 register as a family will be described. The users U1 and U2 register as members of the service providing site. In this case, the users U1 and U2 input a name, a zip code, an address, a telephone number, and the like. The input information is registered in the membership information DB 1a by the database management server 1 as membership information. When membership registration is completed, a user ID is assigned to each user. The user ID is information that identifies the user. The user ID is an example of identification information in the present invention. After that, the user U1 designates the user ID of the user U2 as a user ID of the family of the user U1 in order to register as a family membership. Then, the service providing site transmits an email to the user U2 to notify that the user U2 is to be registered as a family member. When the user U2 operates the user terminal 8 to access the service providing site and performs an operation of permitting the user U1 to register as a family membership, the database management server 1 associates the users U1 and U2 as a family. The user of which the user ID is designated is referred to as a “family representative.” In this case, the user U2 is a family representative.

Moreover, the user U1 selects whether the registered membership address of the user U2 may be used as destination information of items purchased on an online mall. That is, the user U1 selects whether the address of the user U1 may be the same as the address of the user U2. Here, when it is selected to use the registered membership address of the user U2, an item ordered by the user U1 is delivered to the registered membership address of the user U2. That is, the address of the user U1 is regarded to be the same as the address of the user U2. Moreover, an item ordered by the user U1 and an item ordered by the user U2 are delivered to the same address.

When any one of the users U1 and U2 as an orderer has ordered an item without designating the delivery date and time using the registered membership address as the destination of the item, the earliest date and time on which the ordered item can be delivered among the available receipt date and time arranged by the user U1 and the available receipt date and time arranged by the user U2 is determined as the scheduled delivery date and time. That is, the scheduled delivery date and time is determined by regarding the entire family as the recipient.

Moreover, when any one of the users U1 and U2 as an orderer has ordered an item by designating the delivery date and time using the registered membership address as a destination of the item, the scheduled delivery date and time of the already ordered item delivered to the user U1 and the scheduled delivery date and time of the already ordered item delivered to the user U2 are changed to the delivery date and time designated presently by the orderer. That is, the scheduled delivery date and time is changed by regarding the entire family as an orderer.

A user can select an option such that an item is to be delivered separately from the other family members when ordering an item. In this case, as for that item, the available receipt date and time arranged by the family is not set as the scheduled delivery date and time, and the scheduled delivery date and time is not changed regardless of whether the family designates the delivery date and time.

When the user U1 has selected an option such that the registered membership address of the user U2 is not to be used as the destination information of items purchased on an online mall during the family registration, the item ordered by the user U1 is delivered to the registered membership address of the user U1. In this case, as for an item ordered by any one of the users U1 and U2, the available receipt date and time arranged by the other user is not set as the scheduled delivery date and time of the item. Moreover, when any one of the users U1 and U2 has designated the delivery date and time, the scheduled delivery date and time of the already ordered item of which the recipient is set to the other user is not changed.

### [2-5. Granting of Points]

A service providing site grant points to a user depending on the user's use state in the service providing site. Points have the same value as a cash in the service providing site and can be spent for a payment of a service, for example. For example, when a user purchases an item on an online mall, the user can spend the points as a portion or the whole of the purchase price. That is, points are used as an exchanging means when selling and buying a transaction object such as an item or a service.

In an online mall's home delivery service, a user who has received an item in such a manner of reducing the delivery cost of the item is granted with points as a consideration, a reward, or a pay-back. This mechanism helps to decrease the delivery fee. The points granted to the user are an example of reward information in the present invention.

Specifically, when a user has received an item at the first delivery of the ordered item, points are granted to the user. When a recipient was absent when a deliveryman came to deliver an item, the deliveryman has to come to deliver the item again. When the user has received an item at the first delivery, the delivery cost can be reduced by the amount that is required for another delivery.

The user can arrange an available receipt date and time in advance. Moreover, the user can change the scheduled delivery date and time. As a result, it is expected that the probability of an item to be received at the first delivery increases.

Moreover, when a user has received a plurality of items of which the slip numbers of the delivery slip are different in a batch, points are granted to the user. A delivery slip is attached in units of items delivered and delivery of an item is managed by a slip number. That is, a plurality of items having different slip numbers is basically handled independently as for delivery. When a deliveryman delivers respective items on different dates and times, the delivery cost increases by the number of deliveries. In contrast, when a deliveryman delivers these items in a batch, the delivery cost can be reduced to the cost for one delivery. Thus, the points may be granted such that the larger the number of items that the user receives at a time is, the larger the granted points become.

The user can arrange the available receipt date and time in advance. Thus, it can be expected to some extent that a plurality of items is delivered in a batch on the available receipt date and time. Moreover, when a user has ordered an item by designating the delivery date and time, the scheduled delivery date and time of an already ordered item may be the same as the scheduled delivery date and time of the already ordered item. Thus, a plurality of items is delivered in a batch. Moreover, the user can change the scheduled delivery date and time so that the delivery dates and times of the plurality of items are identical.

Moreover, the user can designate an option such that an optional already ordered item is to be delivered in a batch with a presently ordered item when completing the order of an item. In this case, an order recipient shop of a presently ordered item may be different from an order recipient shop of an already ordered item. That is, the user can designate an option so that a plurality of items having different slip numbers is to be delivered in a batch. A delivery of a plurality of items having different slip numbers in a batch according to a designation of the user is referred to as a “batch delivery.”

When a user has designated a batch delivery with an already ordered item without designating the delivery date and time during ordering of an item, the scheduled delivery date and time of the presently ordered item is determined among the available receipt dates and times when both the presently ordered item and the designated already ordered item can be delivered. Moreover, the scheduled delivery date and time of the designated already ordered item is changed to the scheduled delivery date and time of the presently ordered item.

Moreover, when the user has designated a batch delivery with an already ordered item by designating the delivery date and time during ordering of an item, the scheduled delivery date and time of the already ordered item is changed to the delivery date and time designated presently as described above. That is, the scheduled delivery dates and times of the plurality of items designated to be delivered in a batch are the same regardless of whether the user has designated the delivery date and time has been designated during ordering.

After that, the plurality of items designated to be delivered in a batch is handled in a batch as for the delivery date and time. Specifically, when a user has designated the delivery date and time during ordering of an item and the already ordered item includes a plurality of already ordered items to which a batch delivery has already been designated, the scheduled delivery dates and times of the plurality of already ordered items designated to be delivered in a batch are changed in a batch only when all of the plurality of already ordered items can be delivered on the delivery date and time designated presently. That is, when there is one item that cannot be delivered on the delivery date and time designated presently, the scheduled delivery date and time of the already ordered item designated to be delivered in a batch is not changed. As a result, it is guaranteed that the plurality of items that the user has designated to be delivered in a batch is delivered in a batch.

### [3. Configuration of Each Server Apparatus and Database]

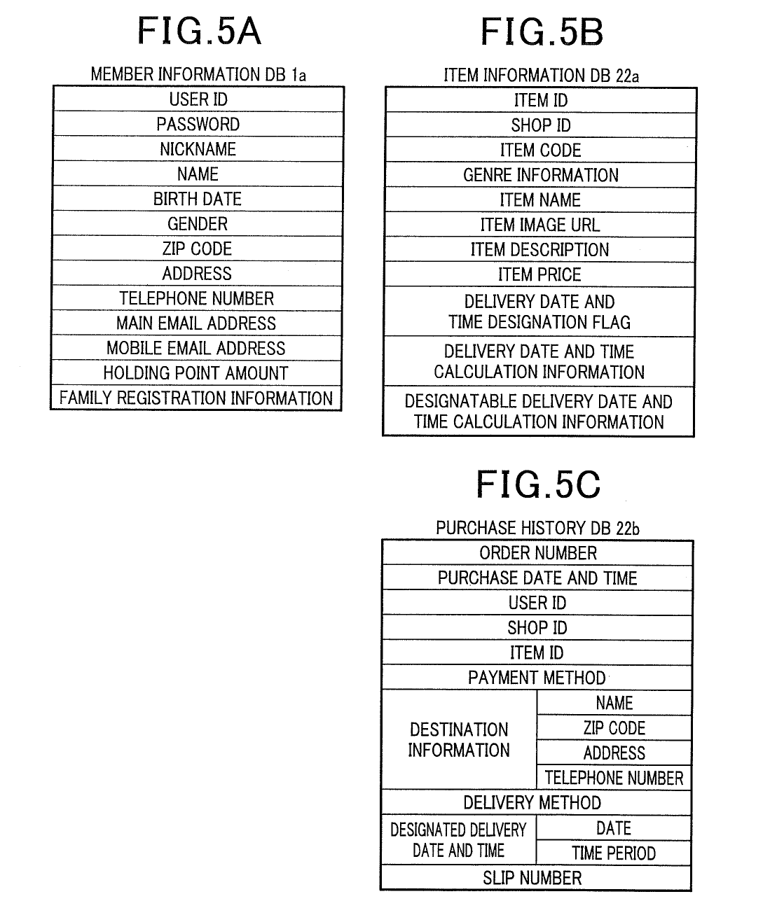

Next, the configuration of each server apparatus and the configuration of the database will be described with reference to FIGS. 5 to 8.

### [3-1. Configuration of Database Server]

FIG. 5A is a diagram illustrating an example of contents registered in the membership information DB 1a. The database management server 1 includes a system control unit configured as a central processing unit (CPU) or the like, a storage unit configured as a hard disk drive or the like, a communication unit, and the like. The membership information DB 1a is constructed in the storage unit of the database management server 1.

Membership information of users registered in the service providing site as members is registered in the membership information DB 1a. Specifically, attributes of a user such as a user ID, a password, a nickname, a name, a birth date, a gender, a zip code, an address, a telephone number, a main email address, a mobile email address, a holding point amount, and family registration information are registered in the membership information DB 1a in association with each user.

The main email address is an email address that the user uses mainly. The mobile email address is an email address of a mobile phone. Specifically, the mobile email address is an email address assigned to the user from a mobile network operator who provides services for the mobile phone. The holding point amount is the amount of points held by the user.

The family registration information is information on family registration. For example, the family registration information includes user IDs of other users registered as a family of a user indicated by the membership information. Moreover, the family registration information includes information indicating whether the user indicated by the membership information is a family representative. Moreover, when the user indicated by the membership information is not the family representative, the family registration information includes information indicating which users is the family representative and information indicating whether the user indicated by the membership information has selected to use the registered membership address of the family representative as the address of the destination of items. Moreover, the family registration information includes the user IDs of user who have selected to use the registered membership address of the family representative as the address of the destination of items.

### [3-2. Configuration of Online Mall Server]

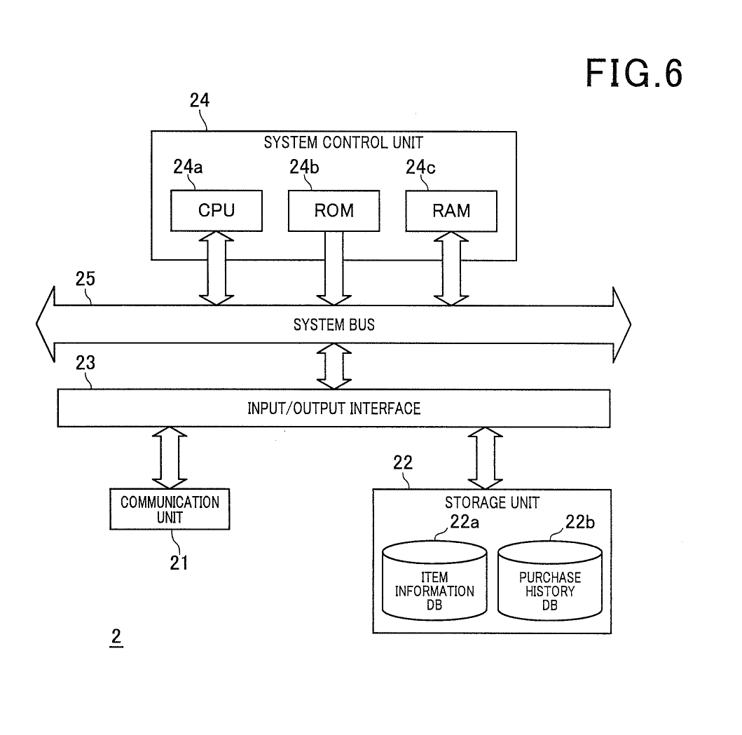

FIG. 6 is a block diagram illustrating an example of a schematic configuration of the online mall server 2 according to the present embodiment. As illustrated in FIG. 6, the online mall server 2 includes a communication unit 21, a storage unit 22, an input/output interface 23, and a system control unit 24. The system control unit 24 and the input/output interface 23 are connected by a system bus 25.

The communication unit 21 is configured to connect to the network NW or NL to control the communication state with the server apparatus and the terminal apparatus.

The storage unit 22 is configured as a hard disk drive or the like, for example. Databases such as an item information DB 22a and a purchase history DB 22b are constructed in the storage unit 22.

FIG. 5B is a diagram illustrating an example of contents registered in the item information DB 22a. Item information on items sold in an online mall is registered in the item information DB 22a. The item information is set by a shop. Specifically, attributes of an item such as an item ID, a shop ID, an item code, a genre ID, an item name, a uniform resource locator (URL) of an item image, an item description, an item price, a delivery date and time designation flag, delivery date and time calculation information, and designable delivery date and time calculation information are registered in the item information DB 22a in association with each item sold by the shop.

The item ID is identification information of an item for allowing a shop or the like to manage items sold. The item ID basically corresponds to an item page in one-to-one correspondence. The item page is a webpage in which detailed information on one item is displayed. Thus, different item IDs are assigned to a plurality of items of which the seller's shops are different although the items are actually the same. The shop ID is identification information of a seller's shop of an item. The item code is a code number for identifying an item. The same item code is assigned to the same items. The item code is a Japanese article number code (JAN) code, for example. The genre ID is an ID of a genre to which an item belongs.

The delivery date and time designation flag indicates whether a user can designate a delivery date and time during ordering of an item. When the delivery date and time designation flag is set to ON, it indicates that the delivery date and time can be designated. When the delivery date and time designation flag is set to OFF, it indicates that the delivery date and time cannot be designated. When it is not clear when an item can be dispatched during ordering of an item, the delivery date and time designation flag is set to OFF. For example, as for an item that is ordered from a manufacturer, when the item can be dispatched is not clear during ordering of the item.

The delivery date and time calculation information is information used for calculating the shortest deliverable date and time during ordering of an item. The delivery date and time calculation information is registered when the delivery date and time designation flag is set to ON. Specifically, a zip code and the number and amount of delivery days and time are arranged in the delivery date and time calculation information in association with each zip code of the addresses of the item destinations, for example. The number and amount of delivery days and time is the number and amount of days and time required for delivery. The number and amount of delivery days and time is the number and amount of days and time required until an item is delivered to a recipient after the item is ordered. It tends to be that the longer the distance from the seller's shop of an item to the district indicated by the zip code is, the longer the number and amount of delivery days and time becomes. The shortest deliverable date and time is calculated by adding the number and amount of delivery days and time to the date and time when an item is ordered.

The designable delivery date and time calculation information is information used for calculating the earliest designable date and time when the user designates the delivery date and time during ordering of an item. The designable delivery date and time calculation information is registered when the delivery date and time designation flag is set to ON. Specifically, a zip code and the number and amount of delivery days and time are arranged in the delivery date and time calculation information in association with each zip code of the addresses of the delivery destinations, for example. That is, the designable delivery date and time calculation information has basically the same format as the delivery date and time calculation information. The earliest designable delivery date and time is calculated by adding the number and amount of delivery days and time to the date and time when an item is ordered. The reason why the designable delivery date and time calculation information and the delivery date and time calculation information are registered separately is to cause the earliest designable delivery date and time to occur later than the shortest deliverable date and time. This is to guarantee that an item is surely delivered on the delivery date and time designated by the user. Thus, the number and amount of delivery days and time set in the designable delivery date and time calculation information is longer than the number and amount of delivery days and time set in the delivery date and time calculation information. The designable delivery date and time calculation information may be the same as the delivery date and time calculation information.

FIG. 5C is a diagram illustrating an example of contents registered in the purchase history DB 22b. A purchase history of items purchased by a user is registered in the purchase history DB 22b. Specifically, an order number, a purchase date and time, a user ID, a shop ID, an item ID, a payment method, destination information, delivery method, a designated delivery date and time, a slip number, and the like are registered in the purchase history DB 22b in association with each purchase of items.

The order number is identification information of an order assigned whenever an item is ordered. The purchase date and time indicates the date and time when an item is ordered. The user ID indicates a user who purchased an item. The shop ID indicates a shop which is a purchase destination. The item ID indicates an item purchased. When a plurality of items is ordered at the same time, a plurality of item IDs is registered. The destination information indicates a destination of an ordered item. Specifically, the destination information includes the name, a zip code, an address, and a telephone number of a recipient serving as a destination. The delivery method indicates a method by which an ordered item is to be delivered. The designated delivery date and time is the delivery date and time designated by an orderer during ordering of an item. The designated delivery date and time includes the date and the time period.

The slip number is a slip number displayed in a delivery slip of an ordered item. When a user orders a plurality of items at the same time, the plurality of items is basically delivered in a batch. Thus, since one delivery slip is used for delivery, one slip number is registered in the purchase history. However, the plurality of items may be delivered separately. For example, when a user orders items that are dispatched from a shop and items that are ordered from a manufacturer, the items dispatched from the shop are delivered in a batch, and the items ordered from the manufacturer are delivered separately. In this case, since a plurality of delivery slips is required, a plurality of slip numbers is registered in the purchase history.

Next, the other pieces of information stored in the storage unit 22 will be described. Various types of data such as a hypertext markup language (HTML) document, an extensible markup language (XML) document, image data, text data, and an electronic document for constituting a webpage of an online mall are stored in the storage unit 22.

Moreover, various programs such as an operating system, a world wide web (WWW) server program, a database management system (DBMS), and an electronic commerce management program are stored in the storage unit 22. The electronic commerce management program is a program for executing various processes associated with an online mall. The programs may be acquired from another server apparatus through the network NW or may be recorded in a recording medium such as a digital versatile disc (DVD) and read by a drive device.

The input/output interface 23 is configured to perform interfacing processes between the communication unit 21 and the storage unit 22, and the system control unit 24.

The system control unit 24 is configured to include a CPU 24a, a read only memory (ROM) 24b, a random access memory (RAM) 24c, and the like. The system control unit 24 is configured to control the entire online mall server 2 in a comprehensive manner when the CPU 24a reads and executes various programs.

The online mall server 2 may be configured as a plurality of server apparatuses. For example, a server apparatus that performs processes associated with electronic commerce, a server apparatus that transmits a webpage of an online mall in response to a request from the terminal apparatus, a server apparatus that manages databases, and the like may be connected by a LAN or the like.

### [3-3. Configuration of Home Delivery Server]

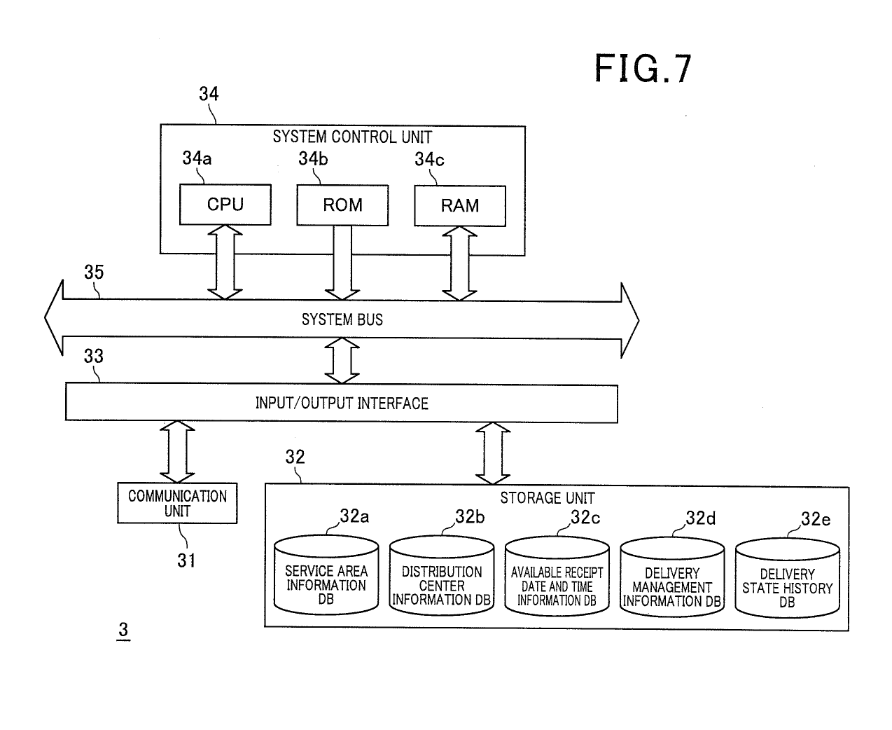

FIG. 7 is a block diagram illustrating an example of a schematic configuration of the home delivery server 3 according to the present embodiment. As illustrated in FIG. 7, the home delivery server 3 includes a communication unit 31, a storage unit 32, an input/output interface 33, and a system control unit 34. The system control unit 34 and the input/output interface 33 are connected by a system bus 35.

The communication unit 31 is configured to connect to the network NW or NL to control the communication state with the server apparatus and the terminal apparatus.

The storage unit 32 is configured as a hard disk drive or the like, for example. The storage unit 32 is an example of a date storing means, a delivery information storing means, and a history storing means in the present invention. Databases such as a service area information DB 32a, a distribution center information DB 32b, an available receipt date and time information DB 32c, a delivery management information DB 32d, and a delivery state history DB 32e are constructed in the storage unit 32.

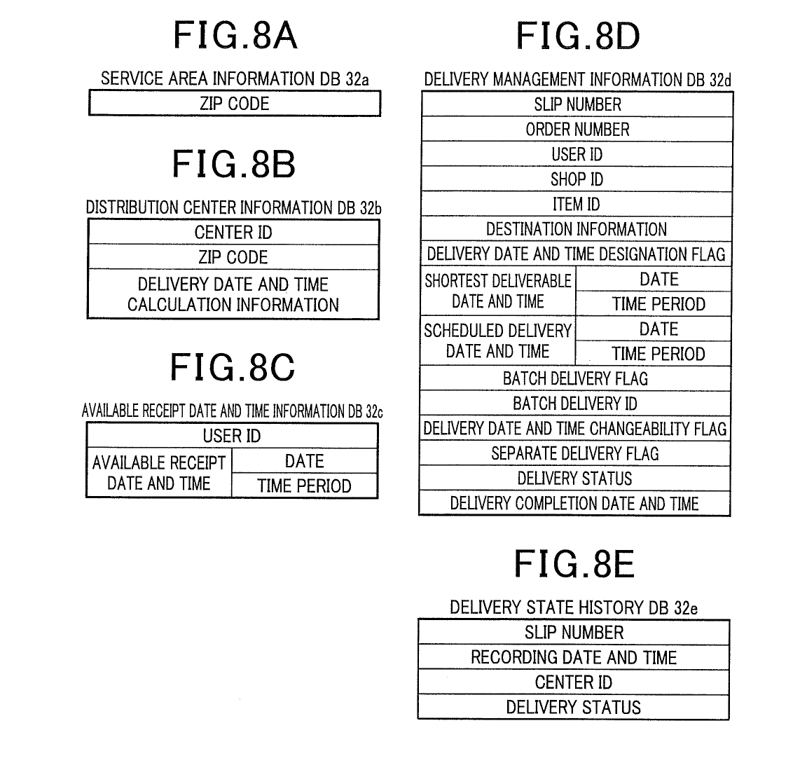

FIG. 8A is a diagram illustrating an example of contents registered in the service area information DB 32a. Information indicating an area in which items can be delivered using an online mall's home delivery service is registered in the service area information DB 32a. Specifically, zip codes of respective districts located in areas where items can be delivered are registered in the service area information DB 32a.

FIG. 8B is a diagram illustrating an example of contents registered in the distribution center information DB 32b. Distribution center information on distribution centers of the online mall's home delivery service is registered in the distribution center information DB 32b. Specifically, attributes of a distribution center such as a center ID, zip codes, and delivery date and time calculation information are registered in the distribution center information DB 32b in association with each distribution center.

The center ID is identification information of a distribution center. The zip code is a zip code of area of which the distribution center is in charge of collecting and delivering items. A plurality of zip codes may be registered as necessary. The delivery date and time calculation information is information used for calculating the shortest deliverable date and time when a deliveryman has received an item from a shop or a manufacturer or an item has been carried to a distribution center, for example. The delivery date and time calculation information registered in the distribution center information DB 32b has the same format as the delivery date and time calculation information registered in the item information DB 22a. The number and amount of delivery days and time included in the delivery date and time calculation information registered in the distribution center information DB 32b is the number and amount of days and time required until an item is delivered to a recipient after the item has arrived at the distribution center. It tends to be that the longer the distance from the distribution center to the district indicated by the zip code is, the longer the number and amount of delivery days and time become. Moreover, the longer the distance from the distribution center to the district indicated by the zip code is, the larger margin is arranged to the number and amount of delivery days and time become. That is, the shorter the distance from the distribution center to the district indicated by the zip code is, the more accurate the number and amount of delivery days and time become. The shortest deliverable date and time is calculated by adding the number and amount of delivery days and time to the date and time when an item arrives at the distribution center. When a deliveryman has received an item from a shop or a manufacturer, the shortest deliverable date and time is calculated by adding the number and amount of delivery days and time and a predetermined period to the date and time when the deliveryman has received the item, for example. The predetermined period is a period required for the deliveryman to carry the item in the distribution center. When a deliveryman of the company Y has received an item or an item has been carried to the distribution center of the company Y, the shortest deliverable date and time is calculated by the partner delivery company server 4 and the calculated the shortest deliverable date and time is transmitted to the home delivery server 3. Moreover, for example, the distribution center information of the distribution center of the company Y may be registered in the distribution center information DB 32b. When an item has been carried to the distribution center of the company Y, the home delivery server 3 may calculate the shortest deliverable date and time based on the delivery date and time calculation information included in the distribution center information.

FIG. 8C is a diagram illustrating an example of contents registered in the available receipt date and time information DB 32c. Available receipt date information on the available receipt date and time arranged by the user is registered in the available receipt date and time information DB 32c. Specifically, a user ID and an available receipt date and time are registered in the available receipt date and time information DB 32c in association with each arranged available receipt date and time. The user ID indicates a user who arranges the available receipt date and time. The available receipt date and time includes the date and the time period.

FIG. 8D is a diagram illustrating an example of contents registered in the delivery management information DB 32d. Management information used for delivery of items delivered via the online mall's home delivery service is registered in the delivery management information DB 32d. Specifically, a slip number, an order number, a user ID, a shop ID, an item ID, destination information, a delivery date designation flag, a shortest deliverable date and time, a scheduled delivery date and time, a batch delivery flag, a batch delivery ID, a delivery date and time changeability flag, a separate delivery flag, a delivery status, a delivery completion date and time, and the like are registered in the delivery management information DB 32d in association with each delivery slip.

The slip number is a slip number displayed in the delivery slip of an item to be delivered. Moreover, the slip number is also information for identifying delivery management information. The order number is an order number of an item to be delivered. Basically, one order number is registered in the delivery management information. However, a user may request an order recipient shop so that a plurality of items that have not been dispatched from a shop among a plurality of items separately ordered from the same shop is to be delivered in a batch. In this case, the shop may package a plurality of items requested to be dispatched in a batch and deliver the items using one delivery slip. In this case, a plurality of order numbers is registered in the delivery management information.

The user ID indicates a recipient user of an item to be delivered. The user ID is registered when the recipient has been registered as a member of the service providing site. The shop ID indicates an order recipient shop of the item to be delivered. The item ID indicates an item to be delivered. A plurality of item IDs is registered when a plurality of items is delivered in a batch using one delivery slip. Moreover, a combination of the order number and the item ID is information for identifying the delivery management information.

The destination information indicates a destination of an item to be delivered. The destination information registered in the delivery management information DB 32d has the same format as the destination information registered in the purchase history DB 22b.

The delivery date designation flag indicates whether the delivery date has been designated by an orderer during ordering of an item. When the delivery date designation flag is set to ON, it indicates that the delivery date has been designated. When the delivery date designation flag is set to OFF, it indicates that the delivery date has not been designated.

The shortest deliverable date and time is the earliest date and time on which an item can be delivered. The shortest deliverable date and time includes the date and the time period. The scheduled delivery date and time is a date and time on which delivery of an item is scheduled. The scheduled delivery date and time includes the date and the time period.

The batch delivery flag indicates whether batch delivery flag with another item having a different slip number from the slip number of an item to be delivered is designated. When the batch delivery flag is set to ON, it indicates that the batch delivery is designated. When the batch delivery flag is set to OFF, it indicates that the batch delivery flag is not designated.

The batch delivery ID is information for identifying a group of items designated to be delivered in a batch. The batch delivery ID is registered when the batch delivery flag is set to ON. When the same batch delivery ID is set to a plurality of pieces of delivery management information, the group of items corresponding to the plurality of pieces of delivery management information is delivered in a batch.

The delivery date and time changeability flag indicates whether the scheduled delivery date and time of an already ordered item can be changed when a user has ordered an item by designating the delivery date and time. When the delivery date and time changeability flag is set to ON, it indicates that the delivery date and time can be changed. When the delivery date and time changeability flag is set to OFF, it indicates that the delivery date and time cannot be changed. The delivery date and time changeability flag is set to ON when a user has selected an option such that the scheduled delivery date and time of an ordered item is not to be changed when ordering the item.

The separate delivery flag indicates whether an orderer who has ordered an item to be delivered has designated an option such that the item is to be delivered separately from the family of the orderer. The separate delivery flag is registered when the orderer has users who have been registered as a family. When the separate delivery flag is set to ON, it indicates that it is designated such that items are to be delivered separately. When the separate delivery flag is set to OFF, it indicates that it is designated such that items are to be delivered separately.

The delivery status indicates a delivery state of an item. The delivery status changes when an employee of a distribution center or a deliveryman inputs a delivery state. For example, “Not dispatched,” “Received by deliveryman,” “Arrived at distribution center not in charge,” “Redirected,” “Arrived at distribution center in charge,” “Delivering,” “Recipient absent,” or “Delivery completed” is set as the delivery status. “Not dispatched” indicates that the item is not dispatched from a shop or a manufacturer. When a deliveryman receives the item from the shop or the manufacturer, the delivery status is changed to “Received by deliveryman.” When the item is carried in a distribution center other than the distribution center in charge of delivery of the item, the delivery status is changed to “Arrived at distribution center not in charge.” When the item is carried from a distribution center in order to redirect the item from the distribution center to another distribution center, the delivery status is changed to “Redirected.” When the item is carried in the distribution center in charge of delivery of the item, the delivery status is changed to “Arrived at distribution center in charge.” When the item is carried out of the distribution center in order to deliver the distribution center in charge of delivery of the item to the recipient, the delivery status is changed to “Delivering.” When the recipient was absent when the delivery went to deliver the item to the recipient, the delivery status is changed to “Recipient absent.” When delivery of the item is completed, the delivery status is changed to “Delivery completed.”

FIG. 8E is a diagram illustrating an example of contents registered in the delivery state history DB 32e. A delivery state history indicating the history of a delivery state of an item input by an employee of a distribution center or a deliveryman is registered in the delivery state history DB 32e. The delivery state history allows users to understand the delivery process through which an item was delivered from a shop or a manufacturer to the recipient. Specifically, information such as a slip number, a recording date and time, a center ID, and a delivery state is registered in the delivery state history DB 32e in association with each input of the delivery status. The slip number indicates a slip number of a delivery slip of an item of which the delivery state is input. The recording date and time indicates the date and the time when the delivery state was input. The center ID indicates a distribution center to which the distribution center that has input the delivery state or the deliveryman who has input the delivery state belongs to. The delivery status indicates an input delivery state.

Next, the other pieces of information stored in the storage unit 32 will be described. Various types of data such as an HTML document, an XML document, image data, text data, and an electronic document for constituting a webpage transmitted from the home delivery server 3 are stored in the storage unit 32.

Moreover, various programs such as an operating system, a WWW server program, a DBMS, and a delivery management program are stored in the storage unit 22. The delivery management program is a program for executing various processes associated with management of item delivery by the online mall's home delivery service. The programs (including an example of an information processing program of the present invention) such as the delivery management program may be acquired from another server apparatus through the network NW or may be recorded in a recording medium such as a DVD and read by a drive device.

The input/output interface 33 is configured to perform interfacing processes between the communication unit 31 and the storage unit 32, and the system control unit 34.

The system control unit 34 is configured to include a CPU 34a, a ROM 34b, a RAM 34c, and the like. The system control unit 34 is configured to function as a date acquiring means, a delivery information storage controlling means, a changing means, a first determining means, an identification information acquiring means, a second determining means, a transmitting means, a completion information acquiring means, a third determining means, a first reward information storage controlling means, a fourth determining means, and a second reward information storage controlling means of the present invention when the CPU 34a reads and executes various programs.

The home delivery server 3 may be configured by a plurality of server apparatuses. For example, a server apparatus that manages delivery of items, a server apparatus that transmits a webpage of a shop information site in response to a request from the user terminal 8 or the like, a server apparatus that manages databases, and the like may be connected to each other via a LAN or the like.

### [4. Operation of Delivery System]

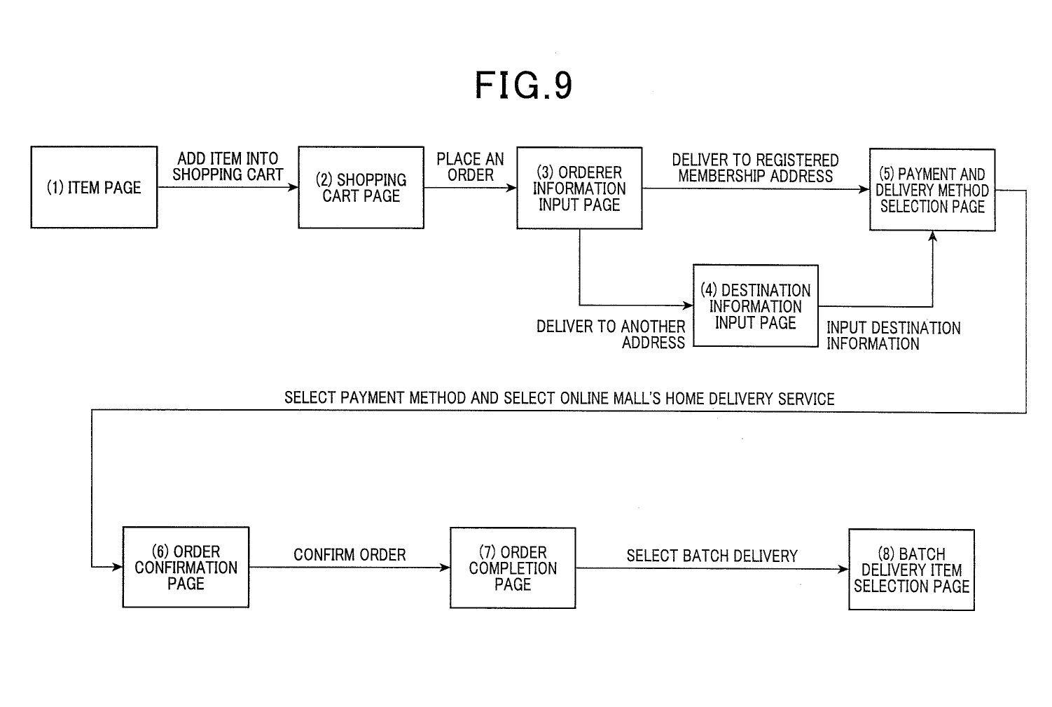

Next, the operation of the delivery system S will be described with reference to FIGS. 9 to 24. In the following description, the operation when only one item is ordered will be described mainly. The operation when a plurality of items is ordered will be appropriately described as necessary. Moreover, the details of the operation when an orderer has designated only the delivery time period among the delivery date and the delivery time period as the delivery date and time will be omitted.

[4-1. Operation when Arranging Available Receipt Date and Time]

First, the operation when specifying an available receipt date and time will be described.

A user performs an operation of logging into a service providing site in advance. In this case, the online mall server 2 or the home delivery server 3 receives the user ID from the user terminal 8 during the login process and stores the received user ID in the user terminal 8 as a cookie. Thus, since the cookie is added to the request transmitted from the user terminal 8 to the online mall server 2 and the home delivery server 3, the online mall server 2 and the home delivery server 3 can acquire the user ID of the user who uses the user terminal 8 from the user terminal 8 whenever the request is received.

For example, in a state where a webpage of an online mall is displayed on the user terminal 8, when the user selects to arrange the available receipt date and time, the user terminal 8 transmits a request for the available receipt date and time arrangement calendar page to the home delivery server 3. The user who has selected to arrange the available receipt date and time will be referred to as a “setter.”

Upon receiving a request, the home delivery server 3 retrieves an available receipt date and time corresponding to the user ID of the setter from the available receipt date and time information DB 32c. Moreover, the home delivery server 3 generates an available receipt date and time arrangement calendar page based on the retrieved available receipt date and time and transmits the generated available receipt date and time arrangement calendar page to the user terminal 8.

In the available receipt date and time arrangement calendar page, the user selects a certain date and displays a time period selection window on the screen. Subsequently, the user performs an operation to select a time period. Then, the user terminal 8 transmits an available receipt date and time arrangement request including the selected date and the selected time period to the home delivery server 3.

The home delivery server 3 uses the date and the time period included in the available receipt date and time arrangement request as an available receipt date and time. In this case, when all day is selected as the time period, only the date included in the available receipt date and time arrangement request is used as the available receipt date and time. Moreover, the home delivery server 3 registers the available receipt date information including the available receipt date and time and the user ID of the setter in the available receipt date and time information DB 32c.

### [4-2. Operation During Ordering of Item]

### [4-2-1. Overview of Operation]

Next, the operation during ordering of an item will be described together with transitions in the webpages. FIG. 9 is a diagram illustrating an example of transitions of webpages until an order of items is completed.

In an item page, an add-to-cart button for adding an item of which the item information is displayed in the item page into a shopping cart is displayed. The shopping cart in the present embodiment is a virtual container in which items selected by the user are added as purchase candidates in an online mall.

When an item page of a certain item is displayed on the screen of the user terminal 8 (see (1) in FIG. 9), and the user presses the add-to-cart button, the item is added to the shopping cart. Then, a shopping cart page is transmitted from the online mall server 2 to the user terminal 8 and the shopping cart page is displayed on the screen of the user terminal 8 (see (2) in FIG. 9). The shopping cart page is a webpage for displaying a list of items that the user has added to the shopping cart. In the shopping cart page, a checkout button for proceeding to place an order of the items added in the shopping cart is also displayed.

When the user select the checkout button, an orderer information input page is transmitted from the online mall server 2 to the user terminal 8 and the orderer information input page is displayed on the screen of the user terminal 8 (see (3) in FIG. 9). The orderer information input page is a webpage for allowing the user who has selected the checkout button to input a user ID and a password. Moreover, the orderer information input page is a webpage for allowing the user to select whether the ordered item is to be delivered to the registered membership address or to an address different from the registered membership address. At the point in time when the user selects the checkout button, this user is referred to as an orderer.

In the orderer information input page, the user inputs a user ID and a password. Moreover, the user selects whether the item is to be delivered to the registered membership address. Then, the user terminal 8 transmits an authentication request including the input user ID and password and information indicating whether the ordered item will be delivered to the registered membership address to the online mall server 2.

The online mall server 2 performs user authentication using the user ID and password included in the received authentication request. When the user authentication is successful, the online mall server 2 determines whether the ordered item is to be delivered to the registered membership address. In this case, when it is determined that the ordered item is not to be delivered to the registered membership address, the online mall server 2 transmits a payment and delivery method selection page to the user terminal 8. The user terminal 8 displays the received payment and delivery method selection page on the screen (see (5) in FIG. 9). The payment and delivery method selection page is a webpage for allowing the user to select a purchase price payment method, a delivery method, or the like of the ordered item.

On the other hand, when it is determined that the ordered item is not to be delivered to the registered membership address (that is, when the ordered item is to be delivered to an address different from the registered membership address), the online mall server 2 transmits a destination information input page to the user terminal 8. The user terminal 8 displays the received destination information input page on the screen (see (4) in FIG. 9). The destination information input page is a webpage for inputting destination information.

In the destination information input page, the user inputs the name, a zip code, an address, and a telephone number of the recipient of the ordered item as the destination information. Then, the user terminal 9 transmits the input destination information to the online mall server 2. The online mall server 2 temporarily stores the received destination information in the RAM 24c in association with the user ID of the orderer. After that, the online mall server 2 transmits the payment and delivery method selection page to the user terminal 8. The user terminal 8 displays the received payment and delivery method selection page on the screen (see (5) in FIG. 9).

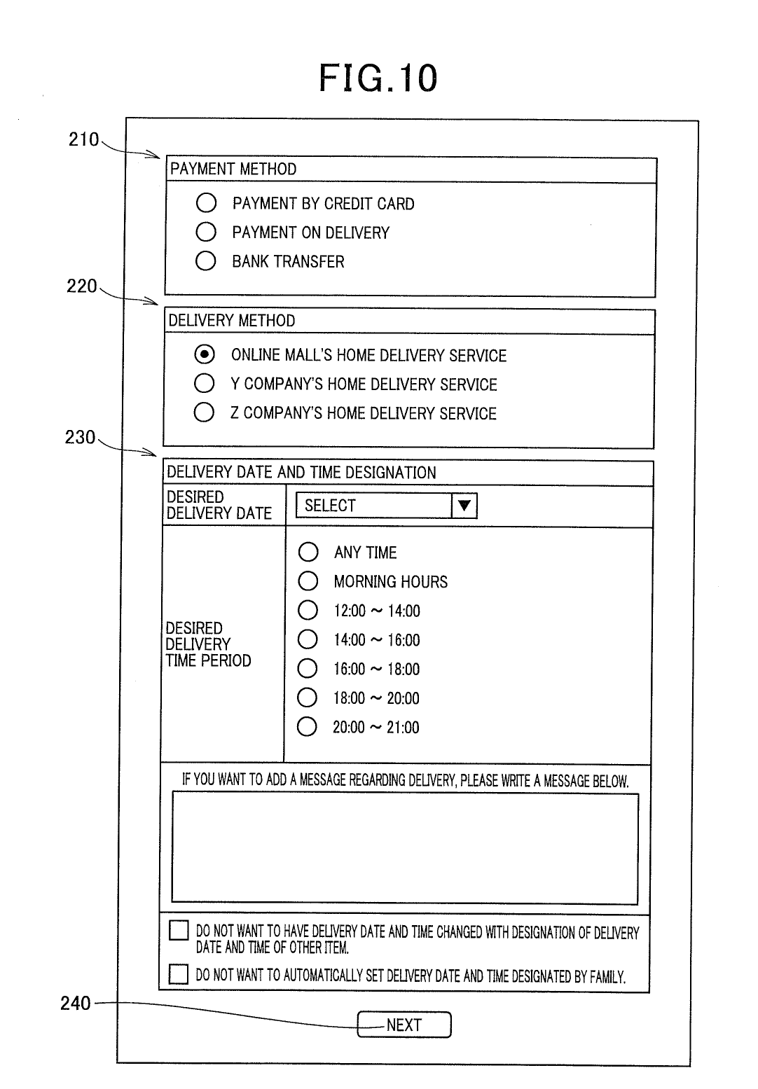

FIG. 10 is a diagram illustrating a screen display example of the payment and delivery method selection page. As illustrated in FIG. 10, the payment and delivery method selection page includes a payment method selection region 210, a delivery method selection region 220, a delivery date and time designation region 230, a Next button, and the like

A list of methods selectable as a purchase price payment method is displayed in the payment method selection region 210. Moreover, a radio button for selecting a payment method among the methods displayed in the list is also displayed in the payment method selection region 210. Examples of method selectable as the payment method include payment by credit card, payment on delivery, bank transfer, and the like.

A list of methods selectable as an ordered item delivery method is displayed in the delivery method selection region 220. Moreover, a radio button for selecting a delivery method among the methods displayed in the list is also displayed in the delivery method selection region 220. A method selectable as the delivery method includes an online mall's home delivery service. When the address of a destination of the ordered item is included in the service areas of the online mall's home delivery service, the online mall's home delivery service is displayed. Moreover, when the online mall's home delivery service is displayed, the online mall's home delivery service is selected as a default delivery method. Another method selectable as the delivery method includes other home delivery services, mailing, and the like. Which method can be selected as another method other than the online mall's home delivery service depends on the ordered item, the order recipient shop, and the like. The home delivery service of the company Y may be included as the selectable home delivery service.

A pull-down menu for selecting a delivery date and a radio button for selecting a delivery time period are displayed in the delivery date and time designation region 230. Moreover, a message field for inputting a message to the order recipient shop regarding delivery of an item is displayed in the delivery date and time designation region 230. When a delivery date and time has been designated during ordering of another item, a check box for selecting whether the orderer permits to change the scheduled delivery date and time of the presently ordered item is displayed in the delivery date and time designation region 230. Moreover, a check box for selecting whether the orderer permits to arrange the delivery date and time designated by a family of the orderer (including the available receipt date and time arranged by a family of the orderer) as the scheduled delivery date and time of the ordered item is also displayed in the delivery date and time designation region 230. These check boxes are displayed when the user has selected an option that the ordered item is to be delivered to the registered membership address. In addition to this condition, the check box for selecting whether the orderer permits to arrange the delivery date and time designated by a family of the orderer as the scheduled delivery date and time of the ordered item is displayed only when the orderer has registered for a family membership.

In the payment and delivery method selection page, the user selects the payment method and the delivery method. In this case, the user selects the online mall's home delivery service as the delivery method. Moreover, the user designates a delivery date and time as necessary by inputting a selecting operation in the delivery date and time designation region 230. Further, the user selects whether the user permits to change the scheduled delivery date and time and permits to arrange the delivery date and time designated by the family as the scheduled delivery date and time as necessary. Then, the user selects the Next button 240. Then, the user terminal 8 transmits an order confirmation request to the online mall server 2. The order confirmation request includes information on the selected payment method and delivery method and the designated delivery date and time. Moreover, when it is selected to permit to change the scheduled delivery date and time, a delivery date and time changeability flag set to ON is included in the order confirmation request. When it is selected to do not permit to change the scheduled delivery date and time, a delivery date and time changeability flag set to OFF is included in the order confirmation request. Further, when it is selected to permit to arrange the delivery date and time designated by the family as the scheduled delivery date and time, a separate delivery flag set to OFF is included in the order confirmation request. When it is selected to do not permit to arrange the delivery date and time designated by the family as the scheduled delivery date and time, a separate delivery flag set to ON is included in the order confirmation request.

The online mall server 2 having received the order confirmation request temporarily stores the information included in the order confirmation request in the RAM 24c in association with the user ID of the orderer. Moreover, the online mall server 2 transmits an order confirmation page to the user terminal 8. The user terminal 8 displays the order confirmation page on the screen (see (6) in FIG. 9). The order confirmation page is a webpage for displaying the details of orders being placed. For example, an item name of an ordered item, a shop name of an order recipient shop, destination information, a payment method, a delivery method, a delivery date and time, and the like are displayed in the order confirmation page.

When the user selects a button for confirming an order in the order confirmation page, the user terminal 8 transmits an order finalization request to the online mall server 2. The online mall server 2 having received the order finalization request executes processes required for the order of the item. For example, the online mall server 2 generates a new order number. Moreover, the online mall server 2 registers a purchase history in the purchase history DB 22b based on the information and the like stored in the RAM 22c in association with the user ID of the orderer. Moreover, when the online mall's home delivery service is determined to be selected as the delivery method, the online mall server 2 generates delivery request information based on the information and the like stored in the RAM 24c in association with the user ID of the orderer. The delivery request information includes item information of an ordered item, an order number, a user ID of an orderer, destination information, a delivery date and time designated by the orderer, a delivery date and time changeability flag, a separate delivery flag, and the like, for example. Moreover, the online mall server 2 transmits the generated delivery request information to the home delivery server 3.

The home delivery server 3 registers the delivery management information in the delivery management information DB 32d based on the received delivery request information. In this case, when the orderer has designated the delivery date and time, the home delivery server 3 arranges the designated delivery date and time as the scheduled delivery date and time. Moreover, when the orderer has designated the delivery date and time and has selected to deliver the ordered item to the registered membership address, the home delivery server 3 arranges the scheduled delivery date and time of the already ordered item as the presently designated delivery date and time. On the other hand, when the orderer has not designated the delivery date and time and the recipient of the ordered item is a member of the service providing site, the home delivery server 3 arranges the earliest date and time when the ordered item can be delivered among the available receipt dates and times arranged by the recipient or the like as the scheduled delivery date.

Subsequently, the home delivery server 3 transmits dispatch request information to the shop terminal 7 of an order recipient shop of the item based on the registered delivery management information. The dispatch request information includes an order number, an item ID and an item name of an ordered item, destination information, a scheduled delivery date and time, and the like, for example. Moreover, the home delivery server 3 transmits collection request information to the distribution center terminal 5 of the distribution center in charge of collection of the ordered item or the partner delivery company server 4 based on the delivery management information. The collection request information includes an order number, an item ID and an item name of an ordered item, a shop ID, a shop name, and an address of an order recipient shop, destination information, a scheduled delivery date and time, and the like, for example.

When the delivery management information is registered, the home delivery server 3 transmits a response message corresponding to the received delivery request information to the online mall server 2. Upon receiving the response message, the online mall server 2 transmits an order completion page to the user terminal 8. The user terminal 8 displays the order completion page on the screen (see (7) in FIG. 9). The order completion page is a webpage for displaying a message that the order is completed. When it is selected to deliver the ordered item to the registered membership address, a batch delivery item selection button for displaying a batch delivery item selection page is displayed in the order completion page. The batch delivery item selection page is a webpage for selecting items to be delivered in a batch with the ordered item among the already ordered items. When the user selects the batch delivery item selection button, the user terminal 8 transmits a batch delivery item selection page request to the home delivery server 3. The batch delivery item selection page request includes an order number of an ordered item. Upon receiving the batch delivery item selection page request, the home delivery server 3 transmits the batch delivery item selection page to the user terminal 8. The user terminal 8 displays the batch delivery item selection page on the screen (see (8) in FIG. 9).

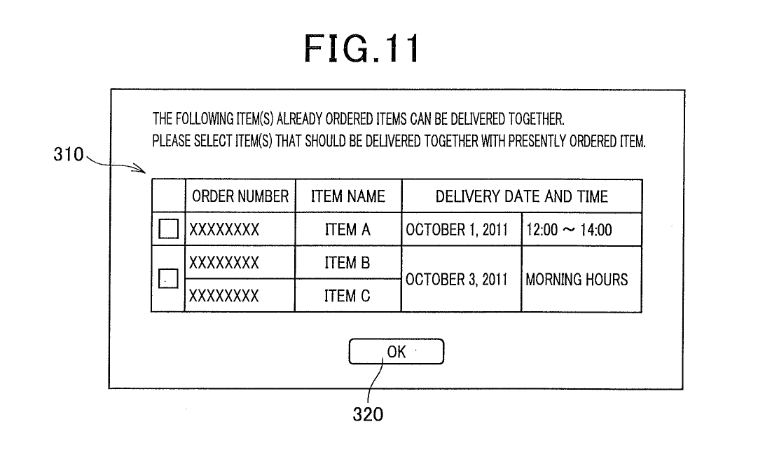

FIG. 11 is a diagram illustrating a screen display example of the batch delivery item selection page. As illustrated in FIG. 11, the batch delivery item selection page includes an item selection region 310, an OK button 320, and the like.

A list of items that can be delivered in a batch with the ordered item is displayed in the item selection region 310. Specifically, an order number, an item name, a scheduled delivery date and time, a check box for selecting whether an item is to be delivered in a batch with the ordered item, and the like are displayed for each deliverable item. When a group of items that are designated to be delivered in a batch is present in the already ordered items, the scheduled delivery date and time and the check box are displayed in the respective groups of items. That is, it is possible to select whether each group of items will be delivered in a batch with the ordered item.

When the orderer has not designated the delivery date and time, an item that can be delivered in a batch with the ordered item is the item of which the shortest deliverable date and time is determined at the present point in time. As for items of which the shortest deliverable date and time is not determined, it is not clear when the items will be dispatched. Thus, these items are excluded from the selection target. On the other hand, when the orderer has designated the delivery date and time, an item that can be delivered in a batch with the ordered item is the item of which the scheduled delivery date and time is changed to the presently designated delivery date and time.

In the batch delivery item selection page, the user selects an item that is to be delivered in a batch with the ordered item as necessary. Moreover, the user selects the OK button 320. Then, the user terminal 8 transmits batch delivery information to the home delivery server 3. When the user has selected an item, an order number and an item ID of the selected item are included in the batch delivery information.

When the orderer has not designated the delivery date and time and the already ordered item to be delivered in a batch is selected, the home delivery server 3 having received the batch delivery information determines the scheduled delivery date and time of the ordered item again. This is to allow the ordered item and the selected already ordered item to be delivered on the same date and time. Specifically, when an already ordered item to be delivered in a batch is selected, the home delivery server 3 arranges an earliest date and time on which both the ordered item and the selected already ordered item can be delivered among the available receipt dates and times arranged by the orderer or the like as the scheduled delivery date. Moreover, the scheduled delivery date and time of the already ordered item that is to be delivered in a batch is arranged to the scheduled delivery date of the ordered item.

When the scheduled delivery date and time of the ordered item is determined again whereby the scheduled delivery date and time of the ordered item or the already ordered item is changed, the home delivery server 3 transmits delivery date and time change notification information to the distribution center terminal 5 of the distribution center in charge of collection of the already ordered item. The delivery date and time change notification information is information for notifying that the scheduled delivery date and time is changed. The distribution center terminal 5 displays the delivery date and time change notification information on the screen, for example.

[4-2-2. Operation when Transmitting Payment and Delivery Method Selection Page]

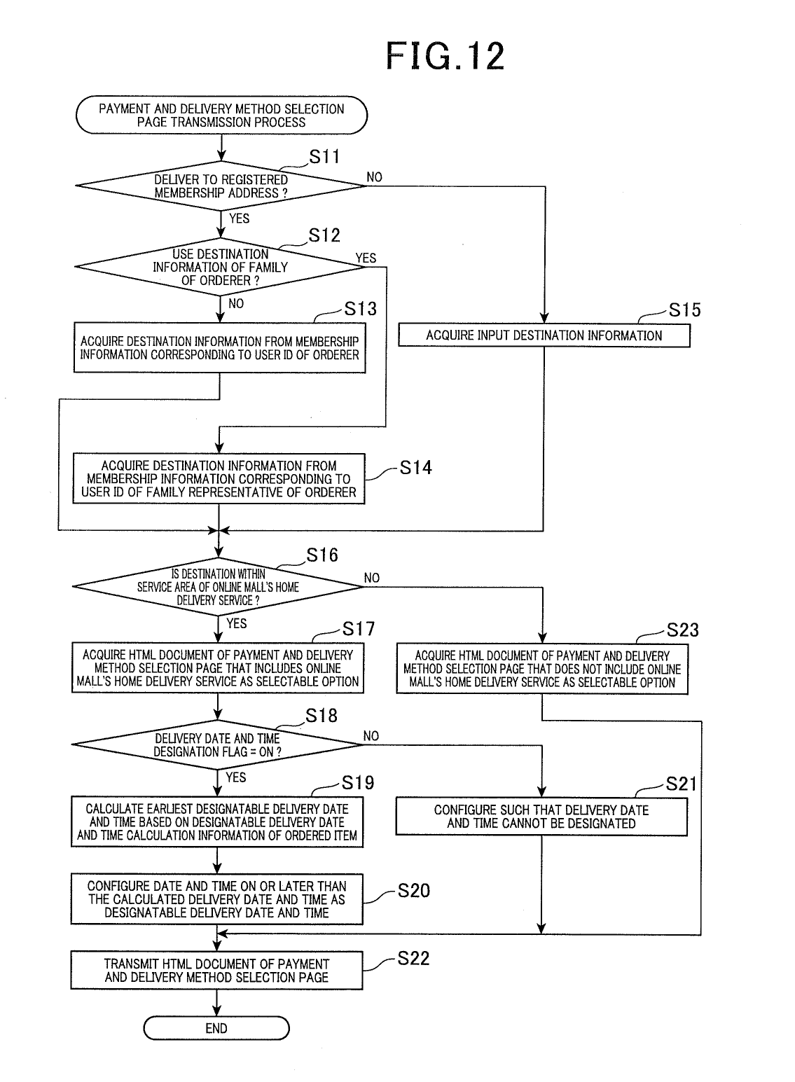

Next, the operation when the online mall server 2 generates the payment and delivery method selection page and transmits the page to the user terminal 8 will be described. FIG. 12 is a flowchart illustrating a processing example of a payment and delivery method selection page transmission process of the system control unit 24 of the online mall server 2 according to the present embodiment. The payment and delivery method selection page transmission process is executed when the home delivery server 3 receives an authentication request from the user terminal 8 on which the orderer information input page is displayed and it is selected to deliver the ordered item to the registered membership address. Moreover, the payment and delivery method selection page transmission process is executed when the home delivery server 3 receives the destination information input in the destination information input page from the user terminal 8.

First, the system control unit 24 determines whether the ordered item is to be delivered to the registered membership address (step S11). In this case, when it is determined that the ordered item is to be delivered to the registered membership address (step S11: YES), the system control unit 24 determines whether the destination information of the family of the orderer is to be used as the destination information of the ordered item (step S12). Here, the system control unit 24 performs the determination based on the family registration information included in the membership information corresponding to the user ID of the orderer. Specifically, the system control unit 24 determines that the destination information of the family of the orderer is to be used when the orderer has a user registered as a family member, the orderer is not the family representative, and the orderer has selected to use the destination information of the family representative (step S12: YES). In this case, the system control unit 24 acquires the user ID of the family representative from the family registration information of the orderer. Moreover, the system control unit 24 acquires the name, zip code, address, and telephone number included in the membership information corresponding to the user ID of the family representative as the destination information (step S14).

On the other hand, the system control unit 24 determines that the destination information of the family of the orderer is not to be used when the orderer does not have a user registered as a family member, the orderer is the family representative, or the orderer has not selected to use the destination information of the family representative (step S12: NO). In this case, the system control unit 24 acquires the name, zip code, address, and telephone number included in the membership information corresponding to the user ID of the orderer as the destination information (step S13).

When it is determined in step S11 that the ordered item is not to be delivered to the registered membership address (step S11: NO), the system control unit 24 acquires the destination information received from the user terminal 8 (step S15).

When the system control unit 24 finishes the process of any one of steps S13 to S15, the system control unit 24 determines whether the destination of the ordered item is located in the service area of the online mall's home delivery service (step S16). Specifically, the system control unit 24 transmits the zip code included in the acquired destination information to the home delivery server 3. The home delivery server 3 searches the service area information DB 32a using the received zip code. Subsequently, the home delivery server 3 determines whether the received zip code is registered in the service area information DB 32a. The home delivery server 3 transmits the determination result to the online mall server 2.

The system control unit 24 determines whether the zip code of the destination is registered in the service area information DB 32a based on the received determination result. When the zip code of the destination is registered, the system control unit 24 determines that the destination of the ordered item is located in the service area of the online mall's home delivery service (step S16: YES). In this case, the system control unit 24 acquires an HTML document of the payment and delivery method selection page in which the online mall's home delivery service is included in the delivery method selection region as a selectable delivery method option from the storage unit 22 (step S17).

Subsequently, the system control unit 24 determines whether the delivery date and time designation flag included in the item information corresponding to the item ID of the ordered item is set to ON (step S18). In this case, when it is determined that the delivery date and time designation flag is set to ON (step S18: YES), the system control unit 24 calculates the earliest designable delivery date and time based on the designable delivery date and time calculation information included in the item information corresponding to the item ID of the ordered item (step S19). Specifically, the system control unit 24 acquires a number and amount of delivery days and time corresponding to the zip code of the destination of the ordered item from the designable delivery date and time calculation information. Subsequently, the system control unit 24 adds the acquired number and amount of delivery days and time to the present date and time to calculate a temporary delivery date and time. Subsequently, the system control unit 24 specifies the earliest date and time period on which the ordered item can be actually delivered and which is on or later than the temporary delivery date and time. The system control unit 24 uses this date and time period as the earliest designable delivery date and time.

Subsequently, the system control unit 24 modifies the acquired HTML document so that a date and time on or later than the calculated earliest delivery date and time can be selected as the delivery date and time of the ordered item in the delivery date and time designation region 230 (step S20). That is, the system control unit 24 makes it impossible to select a date and time that is earlier than the calculated earliest delivery date and time.

When it is determined in step S18 that the delivery date and time designation flag is not set to ON and the online mall's home delivery service is selected as the delivery method, the system control unit 24 modifies the acquired HTML document so that the delivery date and time cannot be designated (step S21).

When the process of step S20 or S21 ends, the system control unit 24 transmits the modified HTML document to the user terminal 8 (step S22). When the system control unit 24 finishes this process, the payment and delivery method selection page transmission process ends.

Here, a case where there is a plurality of ordered items will be described. In step S18, when at least one delivery date and time designation flag among the delivery date and time designation flags of the plurality of ordered items is set to ON, the system control unit 24 proceeds to step S19. In step S19, the system control unit 24 calculates the temporary delivery date and time for each ordered item of which the delivery date and time designation flag is set to ON. Moreover, the system control unit 24 specifies an earliest designable delivery date and time based on the latest delivery date and time among the calculated temporary delivery dates and times. In this case, the delivery date and time can be designated for only those items of which the delivery date and time designation flag is set to ON.

In step S16, the system control unit 24 determines that the destination of the ordered item is not located in the service area of the online mall's home delivery service when the zip code of the destination is not registered in the service area information DB 32a (step S16: NO). In this case, the system control unit 24 acquires the HTML document of the payment and delivery method selection page in which the online mall's home delivery service is not included in the delivery method selection region 220 as a selectable delivery method option (step S23). Subsequently, the system control unit 24 transmits the acquired HTML document to the user terminal 8 (step S22). In this way, the payment and delivery method selection page transmission process ends.

[4-2-3. Operation when Receiving Delivery Request Information]

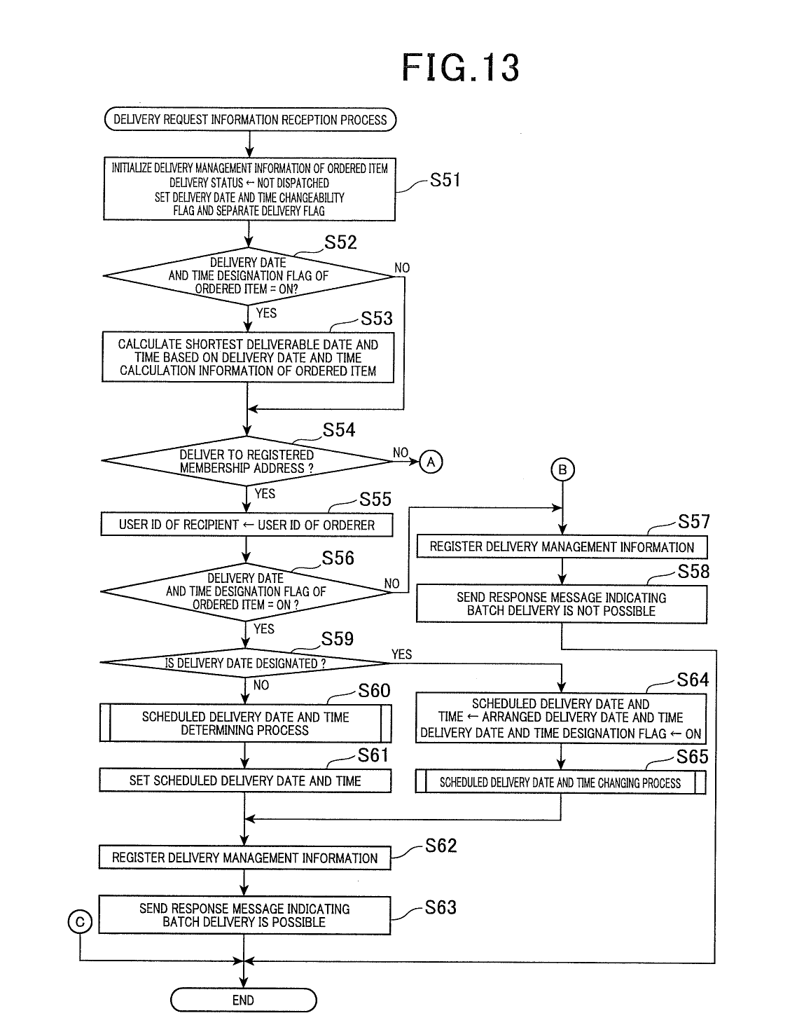

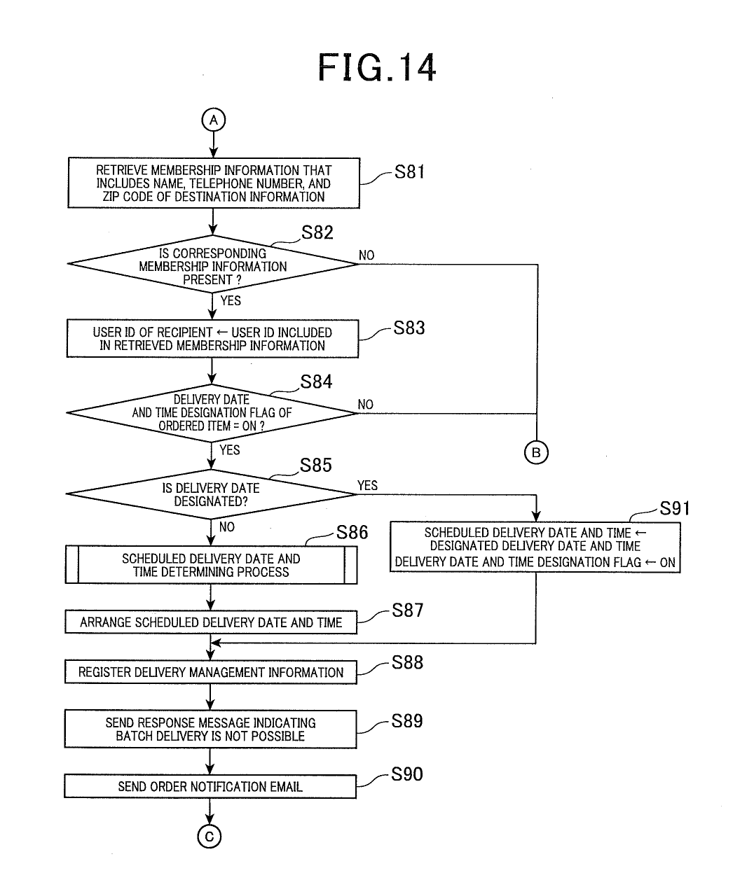

Next, the operation when the home delivery server 3 receives the delivery request information from the online mall server 2 will be described. FIGS. 13 and 14 are flowcharts illustrating a processing example of the delivery request information reception process of the system control unit 34 of the home delivery server 3 according to the present embodiment.

As illustrated in FIG. 13, the system control unit 34 initializes the delivery management information of the ordered item based on the received delivery request information (step S51). Specifically, the system control unit 34 generates the delivery management information in the RAM 34c. In this case, the system control unit 34 sets an order number, a shop ID, an item ID, destination information, a delivery date and time changeability flag, and a separate delivery flag included in the delivery request information in the delivery management information. Moreover, the system control unit 34 sets the delivery status to “Not dispatched.” Moreover, the system control unit 34 leaves the remaining information in a blank state and sets the remaining flags to OFF.

Subsequently, the system control unit 34 determines whether the delivery date and time designation flag included in the item information of the ordered item is set to ON (step S52). In this case, when it is determined that the delivery date and time designation flag is set to ON (step S52: YES), the system control unit 34 calculates the shortest deliverable date and time based on the delivery date and time calculation information included in the item information of the ordered item (step S53). Specifically, the system control unit 34 acquires a number and amount of delivery days and time corresponding to the zip code of the destination of the ordered item from the delivery date and time calculation information. Subsequently, the system control unit 34 adds the acquired number and amount of delivery days and time to the present date and time to calculate the temporary delivery date and time. Subsequently, the system control unit 34 specifies the earliest date and time period on which the ordered item can be actually delivered and which is on or later than the temporary delivery date and time. The system control unit 34 arranges this date and time period in the delivery management information of the ordered item as the shortest deliverable date and time.

When it is determined that the delivery date and time designation flag is not set to ON (step S52: NO), or when the process of step S53 ends, the system control unit 34 determines whether the ordered item is to be delivered to the registered membership address based on the delivery request information (step S54). In this case, when it is determined that the ordered item is to be delivered to the registered membership address (step S54: YES), the system control unit 34 sets the user ID of the orderer in the delivery management information of the ordered item as the user ID of the recipient (step S55).

Subsequently, the system control unit 34 determines whether the delivery date and time designation flag included in the item information of the ordered item is set to ON (step S56). In this case, when it is determined that the delivery date and time designation flag is not set to ON (step S56: NO), the system control unit 34 registers the delivery management information of the ordered item in the delivery management information DB 32d (step S57). Subsequently, the system control unit 34 transmits a response message indicating that the ordered item and the already ordered item cannot be delivered in a batch to the online mall server 2 (step S58). When the system control unit 34 finishes this process, the delivery request information reception process ends. In this case, since it is not clear when the ordered item will be dispatched, a shortest delivery date and time and a scheduled delivery date and time are not arranged in the delivery management information. Moreover, the system control unit 34 makes it impossible to select an already ordered item to be delivered in a batch with the ordered item.

On the other hand, when it is determined that the delivery date and time designation flag is set to ON (step S56: YES), the system control unit 34 determines whether at least the delivery date among the delivery date and the delivery time period is designated by the orderer as the delivery date and time based on the delivery request information (step S59). In this case, when it is determined that the delivery date is not designated (step S59: NO), the system control unit 34 executes the scheduled delivery date and time determining process (step S60). In this case, the system control unit 34 arranges the shortest deliverable date and time calculated in step S53 as an argument. In the scheduled delivery date and time determining process, the earliest date and time on which the ordered item can be delivered among the available receipt dates and times arranged by the orderer or the like is determined as the scheduled delivery date. The date and time on which the ordered item can be delivered is a date and time that is on or later than the shortest deliverable date and time set as the argument. Details of the scheduled delivery date and time determining process will be described later. Subsequently, the system control unit 34 arranges the scheduled delivery date and time determined in the scheduled delivery date and time determining process in the delivery management information of the ordered item (step S61). In this manner, the system control unit 34 as a date acquiring means acquires the earliest date and time on which the ordered item can be delivered among the available receipt dates and times arranged by the orderer or the like from the storage unit 32.

Subsequently, the system control unit 34 registers the delivery management information of the ordered item in the delivery management information DB 32d (step S62). In this way, the system control unit 34 as a delivery information storage controlling means stores the delivery management information including the scheduled delivery date and time determined in the scheduled delivery date and time determining process in the storage unit 32. Subsequently, the system control unit 34 transmits a response message indicating that the ordered item can be delivered in a batch with the already ordered item to the online mall server 2 (step S63). That is, the system control unit 34 makes it possible to select an already ordered item that is to be delivered in a batch with the ordered item. When the system control unit 34 finishes this process, the delivery request information reception process ends.

When it is determined in step S59 that the delivery date is designated (step S59: YES), the system control unit 34 acquires the designated delivery date and time from the delivery request information. Moreover, the system control unit 34 arranges the designated delivery date and time in the delivery management information of the ordered item as the scheduled delivery date and time. Further, the system control unit 34 arranges the delivery date and time designation flag of the delivery management information of the ordered item to ON (step S64).

Subsequently, the system control unit 34 executes the scheduled delivery date and time changing process (step S65). In the scheduled delivery date and time changing process, the scheduled delivery date and time of the already ordered item of the orderer or the like is changed to the presently designated delivery date and time. Details of the scheduled delivery date and time changing process will be described later. Subsequently, the system control unit 34 proceeds to step S62.

When it is determined in step S54 that the ordered item is not to be delivered to the registered membership address (step S54: NO), the system control unit 34 acquires the name, the telephone number, and the zip code from the destination information included in the delivery request information as illustrated in FIG. 14. Moreover, the system control unit 34 retrieves membership information including the same name, telephone number, and zip code as the acquired name, telephone number, and zip code from the membership information DB 1a (step S81). That is, the system control unit 34 retrieves the membership information of the recipient specified by the destination information. The system control unit 34 may retrieve the membership information of the recipient using the name and address included in the destination information, for example. Subsequently, the system control unit 34 determines whether the corresponding membership information has been retrieved (step S82). In this case, when it is determined that the corresponding membership information has not been retrieved (step S82: NO), the system control unit 34 proceeds to step S57. In this case, when the delivery date and time is designated, the system control unit 34 arranges the designated delivery date and time as the scheduled delivery date and time of the ordered item.

On the other hand, when it is determined that the corresponding membership information has been retrieved (step S82: YES), the system control unit 34 as an identification information acquiring means acquires the user ID from the retrieved membership information. Moreover, the system control unit 34 sets the acquired user ID in the delivery management information of the ordered item as the user ID of the recipient (step S83). Subsequently, the system control unit 34 determines whether the delivery date and time designation flag included in the item information of the ordered item is set to ON (step S84). In this case, when it is determined that the delivery date and time designation flag is not set to ON (step S84: NO), the system control unit 34 proceeds to step S57.

On the other hand, when it is determined that the delivery date and time designation flag is set to ON (step S84: YES), the system control unit 34 determines whether at least the delivery date among the delivery date and the delivery time period has been designated by the orderer as the delivery date and time based on the delivery request information (step S85). In this case, when it is determined that the delivery date has not been designated (step S85: NO), the system control unit 34 executes the scheduled delivery date and time determining process (step S86). In this case, the system control unit 34 arranges the shortest deliverable date and time calculated in step S53 as an argument. Subsequently, the system control unit 34 arranges the scheduled delivery date and time determined in the scheduled delivery date and time determining process in the delivery management information of the ordered item (step S87). Subsequently, the system control unit 34 registers the delivery management information of the ordered item in the delivery management information DB 32d. In this way, the system control unit 34 as a date acquiring means acquires the earliest date and time on which the ordered item can be delivered among the available receipt dates and times arranged by the orderer or the like from the storage unit 32. Moreover, the system control unit 34 as a delivery information storage controlling means stores the delivery management information including the acquired date and time as the scheduled delivery date and time in the storage unit 32. Subsequently, the system control unit 34 transmits a response message indicating that the ordered item and the already ordered item cannot be delivered in a batch to the online mall server 2 (step S89).

Subsequently, the system control unit 34 sends an order notification email (step S90). The order notification email is an email for notifying the recipient of the fact that an item has been ordered when the orderer and the recipient of the item are different. Specifically, the system control unit 34 acquires a main email address from the membership information corresponding to the user ID of the recipient set in the delivery management information of the ordered item. Subsequently, the system control unit 34 sets the acquired main email address as the destination of the order notification email. Subsequently, the system control unit 34 inserts a message indicating that an item of which the destination is the recipient has been ordered in the main text of the order notification email. Moreover, the system control unit 34 inserts the order number, the orderer name, and the like set in the selected delivery management information in the main text of the order notification email. Then, the system control unit 34 sends the order notification email. When the system control unit 34 finishes this process, the delivery request information reception process ends.

When it is determined in step S85 that the delivery date has been designated (step S85: YES), the system control unit 34 acquires the designated delivery date and time from the delivery request information. Moreover, the system control unit 34 arranges the designated delivery date and time in the delivery management information of the ordered item as the scheduled delivery date and time. Further, the system control unit 34 arranges the delivery date and time designation flag of the delivery management information of the ordered item to ON (step S91). Subsequently, the system control unit 34 proceeds to step S88.

In this way, when it is selected to deliver the ordered item to an address different from the registered membership address whereby the orderer and the recipient are different, the system control unit 34 makes it impossible to select an already ordered item (that is, an item delivered to the address of the orderer) that is to be delivered in a batch with the ordered item (that is, an item delivered to the address of the recipient). The batch delivery item selection page that is to be displayed after the order is completed is a webpage for arranging batch delivery of items delivered to the orderer. That is, since the presently ordered item is an item that is delivered to the orderer, it is possible to set the ordered item to be delivered in a batch with the already ordered item of the orderer. When the presently ordered item is an item that is delivered to a user different from the orderer, it is basically impossible to deliver the ordered item in a batch with the already ordered item of the orderer. In this case, the recipient of the ordered item can set an option such that the presently ordered item and the other item are to be delivered in a batch in the delivery state list page.

Upon receiving the response message from the home delivery server 3, the online mall server 2 transmits on order completion page to the user terminal 8. In this case, when the response message indicates that the batch delivery is possible, the online mall server 2 transmits an order completion page in which a batch delivery item selection button is displayed.

Here, a case where a plurality of ordered items is present will be described. The system control unit 34 classifies the plurality of ordered items into an ordered item of which delivery date and time designation flag is ON and an ordered item of which delivery date and time designation flag is OFF. Subsequently, the system control unit 34 registers one piece of delivery management information collectively for the ordered items of which delivery date and time designation flag is ON. The detailed processes of this case are basically the same as the detailed processes when the delivery date and time designation flag is ON in FIGS. 13 and 14. In this case, a plurality of item IDs is set in the delivery management information. Moreover, the system control unit 34 calculates the shortest deliverable date and time for each item in step S53. Moreover, the latest shortest deliverable date and time among the calculated shortest deliverable dates and times is arranged in the delivery management information of the ordered item.

On the other hand, the system control unit 34 registers the delivery management information separately for the ordered items of which delivery date and time designation flag is OFF. The detailed processes of this case are basically the same as the detailed processes when the delivery date and time designation flag is OFF in FIGS. 13 and 14.

After the delivery management information has been registered for all ordered items, when the plurality of ordered items includes an ordered item of which delivery date and time designation flag is ON and an ordered item of which delivery date and time designation flag is OFF, the system control unit 34 sends a response message that the ordered item and the already ordered item can be delivered in a batch to the online mall server 2. In this case, the ordered items of which delivery date and time designation flag is ON among the plurality of ordered items are subjected to the batch delivery.

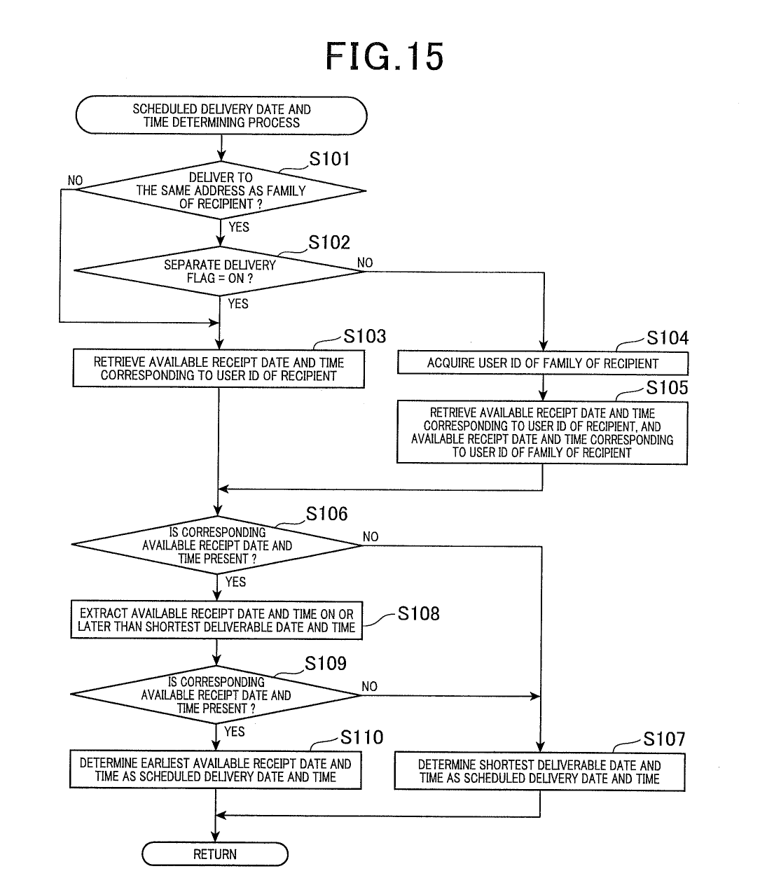

FIG. 15 is a flowchart illustrating a processing example of the scheduled delivery date and time determining process of the system control unit 34 of the home delivery server 3 according to the present embodiment. The scheduled delivery date and time determining process is called from the delivery request information reception process, a batch delivery information reception process described later, and a delivery state information reception process described later. That is, the scheduled delivery date and time determining process is executed when a user orders an item without designating the delivery date and time. Moreover, the scheduled delivery date and time determining process is executed when a deliveryman receives an item of which scheduled delivery date and time is not clear at the time of ordering from a shop or a manufacturer. Further, the scheduled delivery date and time determining process is executed when a user selects an item to be delivered in a batch with the ordered item and selects the OK button 320 in the batch delivery item selection page.

As illustrated in FIG. 15, the system control unit 34 determines whether the recipient of the ordered item and the family of the recipient have selected to deliver items to the same address (step S101). Here, the system control unit 34 performs the determination based on the family registration information included in the membership information corresponding to the user ID of the recipient.

Specifically, when the recipient does not have a user registered as a family member, the system control unit 34 determines that it is not selected such that the recipient and the family want items to be delivered to the same address. On the other hand, when the recipient has a user registered as a family member, the system control unit 34 determines whether the recipient is the family representative. In this case, when it is determined that the recipient is the family representative, the system control unit 34 determines whether such a user who has selected to use the registered membership address of the recipient as the address of the destination of the item is present. In this case, when it is determined that such a user is present, the system control unit 34 determines that it is selected such that the recipient and the family want items to be delivered to the same address. When it is determined that such a user is not present, the system control unit 34 determines that it is not selected to deliver the item to the same address as the family of the recipient. When it is determined that the recipient is not the family representative, the system control unit 34 determines whether the recipient has selected to use the registered membership address of the family representative as the address of the destination of the item. In this case, when it is determined that the recipient has selected to do so, it is determined that it is selected such that the recipient and the family want items to be delivered to the same address. When it is determined that the recipient has not selected to do so, it is determined that it is not selected such that the recipient and the family want items to be delivered to the same address.

When it is determined that it is not selected such that the recipient and the family want items to be delivered to the same address (step S101: NO), the system control unit 34 retrieves an available receipt date and time corresponding to the user ID of the recipient from the available receipt date and time information DB 32c (step S103).

On the other hand, when it is determined that it is selected such that the recipient and the family want items to be delivered to the same address (step S101: YES), the system control unit 34 determines whether the separate delivery flag set in the delivery management information of the ordered item is set to ON (step S102). In this case, when it is determined that the separate delivery flag is set to ON (step S102: YES), the system control unit 34 proceeds to step S103. That is, since it is selected such that the presently ordered item is to be separately delivered from the other family, the system control unit 34 determines the scheduled delivery date and time based on the available receipt date and time of the recipient only.

On the other hand, when it is determined that the separate delivery flag is not set to ON (step S102: NO), the system control unit 34 acquires the user ID of the family who has selected to deliver an item to the same address as the recipient (step S104). Specifically, when the recipient is the family representative, the system control unit 34 acquires the user ID of a user who has selected to use the registered membership address of the family representative as the address of the destination of the item from the family registration information. On the other hand, when the recipient is not the family representative, the system control unit 34 acquires the user ID of the family representative and the user ID of a user who has selected to use the registered membership address of the family representative as the address of the destination of the item from the family registration information.

Subsequently, the system control unit 34 retrieves the available receipt date and time corresponding to the user ID of the recipient from the available receipt date and time information DB 32c and retrieves the available receipt date and time corresponding to the acquired user ID of the family from the available receipt date and time information DB 32c (step S105).

When the system control unit 34 finishes the process of step S103 or S105, the system control unit 34 determines whether the corresponding available receipt date and time has been retrieved (step S106). In this case, when it is determined that the available receipt date and time has not been retrieved (step S106: NO), the system control unit 34 determines the shortest deliverable date and time set in the delivery management information of the ordered item as the scheduled delivery date and time (step S107). When the system control unit 34 finishes this process, the scheduled delivery date and time determining process ends.

On the other hand, when it is determined that the available receipt date and time has been retrieved (step S106: YES), the system control unit 34 extracts an available receipt date and time that is on or later than the shortest deliverable date and time set as the argument from the retrieved available receipt date and time (step S108). Subsequently, the system control unit 34 determines whether the corresponding available receipt date and time has been extracted (step S109). In this case, when it is determined that the available receipt date and time has not been extracted (step S109: NO), the system control unit 34 proceeds to step S107.

On the other hand, when it is determined that the available receipt date and time has been extracted (step S109: YES), the system control unit 34 determines the earliest available receipt date and time among the extracted available receipt dates and times as the scheduled delivery date and time (step S110). When the system control unit 34 finishes this process, the scheduled delivery date and time determining process ends.

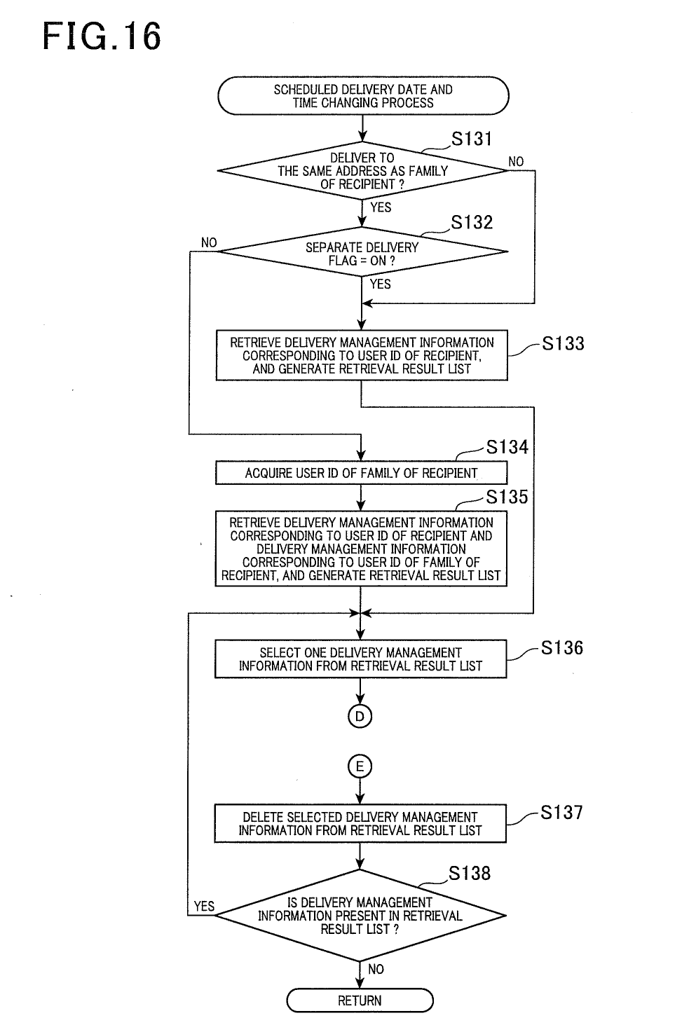

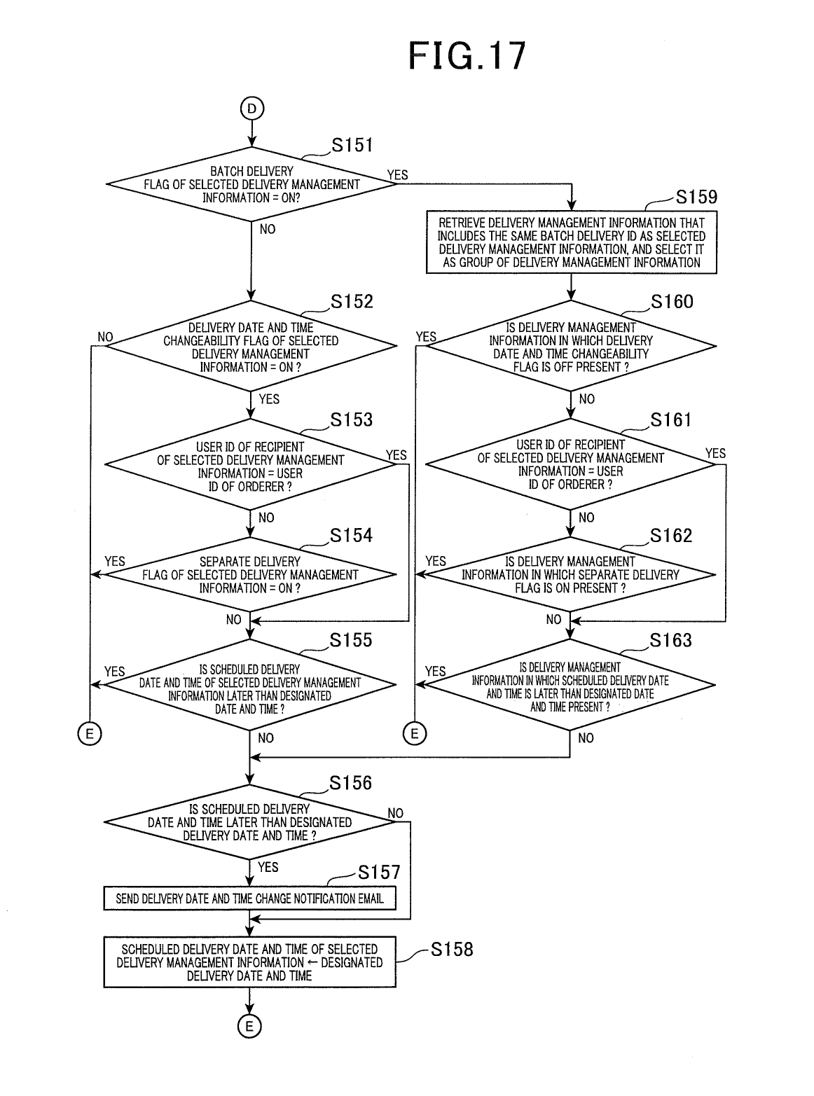

FIGS. 16 and 17 are flowcharts illustrating a processing example of the scheduled delivery date and time changing process of the system control unit 34 of the home delivery server 3 according to the present embodiment. The scheduled delivery date and time changing process is called from the delivery request information reception process. That is, the scheduled delivery date and time changing process is executed when a user orders an item by designating the delivery date and time.

As illustrated in FIG. 16, the system control unit 34 determines whether the recipient of an ordered item and the family have selected to deliver items to the same address (step S131). This determination method is the same as the determination method of step S101 illustrated in FIG. 15. In this case, when it is determined that it is not selected such that the recipient and the family want items to be delivered to the same address (step S131: NO), the system control unit 34 retrieves delivery management information including the user ID of the recipient from the delivery management information DB 32d. In this case, the system control unit 34 excludes delivery management information in which the delivery status is set to “Delivery completed” or “Delivering” from searching targets. Moreover, the system control unit 34 generates a retrieval result list including the retrieved pieces of delivery management information (step S133).

On the other hand, when it is determined that it is selected such that the recipient and the family want items to be delivered to the same address (step S131: YES), the system control unit 34 determines whether the separate delivery flag set in the delivery management information of the ordered item is set to ON (step S132). In this case, when it is determined that the separate delivery flag is set to ON (step S132: YES), the system control unit 34 proceeds to step S133. That is, since it is selected such that the presently ordered item is to be delivered separately from the other family, the system control unit 34 controls such that the scheduled delivery date and time of the already ordered item of the family of the recipient is not changed to the presently designated delivery date and time.

On the other hand, when it is determined that the separate delivery flag is not set to ON (step S132: NO), the system control unit 34 acquires the user ID of the family who has selected to have an item to be delivered to the same address as the recipient (step S134). The detailed process thereof is the same as the detailed process of step S104 illustrated in FIG. 15. Subsequently, the system control unit 34 retrieves the delivery management information that includes the user ID of the recipient from the delivery management information DB 32d and retrieves the delivery management information that includes the user ID of the family. In this case, the system control unit 34 excludes delivery management information in which the server apparatus is set to “Delivery completed” or “Delivering” from searching targets. Moreover, the system control unit 34 generates a retrieval result list including the retrieved pieces of delivery management information (step S135).

When the system control unit 34 finishes the process of step S133 or S135, the system control unit 34 selects one piece of delivery management information from the retrieval result list (step S136).

Subsequently, as illustrated in FIG. 17, the system control unit 34 determines whether the batch delivery flag set in the selected delivery management information is set to ON (step S151). In this case, when it is determined that the batch delivery flag is set to ON (step S151: NO), the system control unit 34 determines whether the delivery date and time changeability flag included in the selected delivery management information is set to ON (step S152). In this case, when it is determined that the delivery date and time changeability flag is not set to ON (step S152: NO), the system control unit 34 deletes the selected delivery management information from the retrieval result list as illustrated in FIG. 16 (step S137). In this case, the scheduled delivery date and time set in the selected delivery management information is not changed.

On the other hand, when it is determined that the delivery date and time changeability flag is set to ON (step S152: YES), the system control unit 34 determines whether the user ID of the recipient set in the selected delivery management information is identical to the user ID of the orderer (step S153). In this case, when it is determined that the user IDs are not identical (step S153: NO), the system control unit 34 determines whether the separate delivery flag included in the selected delivery management information is set to ON (step S154). In this case, when it is determined that the separate delivery flag is set to ON (step S154: YES), the system control unit 34 proceeds to step S137. In this case, the recipient of the already ordered item corresponding to the selected delivery management information is the family of the orderer. Moreover, the recipient has selected such that the already ordered item is to be delivered separately from the other family. Thus, the scheduled delivery date and time is not changed.

On the other hand, when it is determined in step S153 that the user ID of the recipient set in the selected delivery management information is identical to the user ID of the orderer (step S153: YES) or when it is determined in step S154 that the separate delivery flag is not set to ON (step S154: NO), the system control unit 34 determines whether the shortest deliverable date and time included in the selected delivery management information is later than the presently designated delivery date and time (step S155). That is, the system control unit 34 as a first determining means determines whether the already ordered item corresponding to the selected delivery management information can be delivered on the presently designated delivery date and time. In this case, when it is determined that the shortest deliverable date and time is later than the presently designated delivery date and time (step S155: YES), the system control unit 34 proceeds to step S137. In this case, the already ordered item corresponding to the selected delivery management information is an item that cannot be delivered on the presently designated delivery date and time. Thus, the scheduled delivery date and time is not changed.

On the other hand, when it is determined that the shortest deliverable date and time is not later than the presently designated delivery date and time (step S155: NO), the system control unit 34 determines whether the scheduled delivery date and time set in the selected delivery management information is later than the presently designated delivery date and time (step S156). In this case, when it is determined that the scheduled delivery date and time is later than the presently designated delivery date and time (step S156: YES), the system control unit 34 as a transmitting means transmits a delivery date and time change notification email (step S157). Specifically, the system control unit 34 acquires a main email address from the membership information corresponding to the user ID of the recipient set in the selected delivery management information. Subsequently, the system control unit 34 sets the acquired main email address as the destination of the delivery date and time change notification email. Subsequently, the system control unit 34 inserts a message indicating that the scheduled delivery date has been brought forward in the main text of the delivery date and time change notification email. Moreover, the system control unit 34 inserts the order number set in the selected delivery management information, an item name of the item corresponding to the item ID set in the delivery management information, the presently designated delivery date and time, and the like in the main text of the delivery date and time change notification email. After that, the system control unit 34 sends the delivery date and time change notification email.

When it is determined that the scheduled delivery date and time is not later than the presently designated delivery date and time (step S156: NO), or when the process of step S157 has been finished, the system control unit 34 changes the scheduled delivery date and time of the selected delivery management information to the presently designated delivery date and time (step S158). Subsequently, the system control unit 34 proceeds to step S137.

When it is determined in step S151 that the batch delivery flag is set to ON (step S151: YES), the system control unit 34 acquires the batch delivery ID from the selected delivery management information. Subsequently, the system control unit 34 retrieves the delivery management information that includes the same batch delivery ID as the acquired batch delivery ID from the retrieval result list. Moreover, the system control unit 34 selects the selected delivery management information and the retrieved pieces of delivery management information as a group of pieces of delivery management information (step S159).

Subsequently, the system control unit 34 determines whether delivery management information in which the delivery date and time changeability flag is set to OFF is present in the selected group of pieces of delivery management information (step S160). In this case, when it is determined that the delivery management information in which the delivery date and time changeability flag is set to OFF is present (step S160: YES), the system control unit 34 deletes the selected group of pieces of delivery management information from the retrieval result list (step S137). In this case, the scheduled delivery date and time set in the selected group of pieces of delivery management information is not changed.

On the other hand, when it is determined that the delivery management information in which the delivery date and time changeability flag is set to OFF is not present (step S160: NO), the system control unit 34 determines whether the user ID of the recipient set in the selected delivery management information is identical to the user ID of the orderer (step S161). In this case, when it is determined that the user IDs are not identical (step S161: NO), the system control unit 34 determines whether the delivery management information in which the separate delivery flag is set to ON is present in the selected group of pieces of delivery management information (step S162). In this case, when it is determined that the delivery management information in which the separate delivery flag is set to ON is present (step S162: YES), the system control unit 34 proceeds to step S137.

On the other hand, when it is determined in step S161 that the user ID of the recipient set in the selected delivery management information is identical to the user ID of the orderer (step S161: YES), or when it is determined in step S162 that the delivery management information in which the separate delivery flag is set to ON is not present (step S162: NO), the system control unit 34 determines whether the delivery management information in which the shortest deliverable date and time later than the presently designated delivery date and time is set is present in the selected group of pieces of delivery management information (step S163). In this case, when it is determined that the delivery management information in which the shortest deliverable date and time later than the presently designated delivery date and time is set is present (step S163: YES), the system control unit 34 proceeds to step S137. In this way, the system control unit 34 as a first determining means determines whether the already ordered item corresponding to the selected delivery management information can be delivered on the presently designated delivery date and time. When it is determined that at least one of the plurality of already ordered items designated to be delivered in a batch cannot be delivered, the scheduled delivery date and time of the group of already ordered items is not changed.

On the other hand, when it is determined that the delivery management information in which the shortest deliverable date and time later than the presently designated delivery date and time is set is not present (step S163: NO), the system control unit 34 proceeds to step S156. That is, the system control unit 34 changes the scheduled delivery date and time included in the selected group of pieces of delivery management information to the presently designated delivery date and time.

As illustrated in FIG. 16, when the system control unit 34 finishes the process of step S137, the system control unit 34 determines whether the delivery management information is still included in the retrieval result list (step S138). In this case, when it is determined that the delivery management information is still included in the retrieval result list (step S138: YES), the system control unit 34 proceeds to step S136. By repeatedly executing the processes of steps S136 to S138 and S151 to S163, the system control unit 34 changes the scheduled delivery date and time to the presently designated delivery date and time when the scheduled delivery date and time of the already ordered items of the recipient or the already ordered items of the families of the recipient can be changed. Moreover, when it is determined that the delivery management information is not included in the retrieval result list (step S138: NO), the system control unit 34 ends the scheduled delivery date and time changing process.

[4-2-4. Operation when Receiving Batch Delivery Item Selection Page Request]

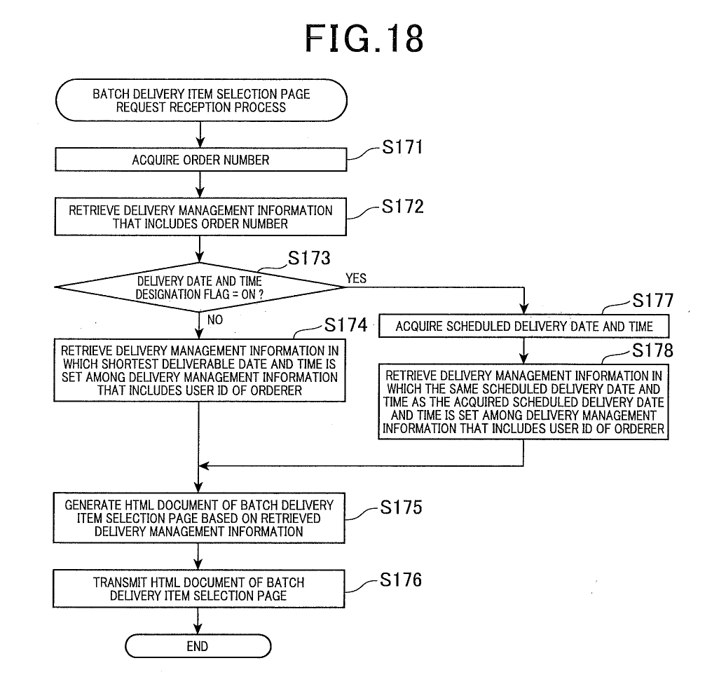

Next, the operation when the home delivery server 3 receives a batch delivery item selection page request from the user terminal 8 on which the order completion page is displayed will be described. FIG. 18 is a flowchart illustrating a processing example of a batch delivery item selection page request reception process of the system control unit 34 of the home delivery server 3 according to the present embodiment.

As illustrated in FIG. 18, the system control unit 34 acquires order numbers from the batch delivery item selection page request (step S171). Subsequently, the system control unit 34 temporarily stores the acquired order numbers in the RAM 34c in association with the user ID of the orderer. Subsequently, the system control unit 34 retrieves delivery management information that includes the acquired order numbers from the delivery management information DB 32d (step S172). In this case, the system control unit 34 excludes delivery management information in which the delivery status is set to “Delivery completed” or “Delivering” from searching targets. Subsequently, the system control unit 34 determines whether the delivery date and time designation flag included in the retrieved delivery management information is set to ON (step S173).

In this case, when it is determined that the delivery date and time designation flag is not set to ON (step S173: NO), the system control unit 34 retrieves delivery management information in which the shortest deliverable date and time is set among the pieces of delivery management information that includes the user ID of the orderer as the user ID of the recipient from the delivery management information DB 32d (step S174). In this case, the system control unit 34 excludes delivery management information in which the delivery status is set to “Delivery completed” or “Delivering” from searching targets. Moreover, the system control unit 34 deletes the delivery management information retrieved in step S172 from the retrieval results.

Subsequently, the system control unit 34 generated an HTML document of the batch delivery item selection page based on the retrieved delivery management information (step S175). Specifically, the system control unit 34 generates the HTML document so that the information on the already ordered items is displayed in the item selection region 310 in units of delivery management information. In this case, the system control unit 34 generates the HTML document so that a group of pieces of delivery management information in which the same batch delivery ID is set can be selected in units of a group of already ordered items designated to be delivered in a batch. Subsequently, the system control unit 34 transmits the generated HTML document to the user terminal 8 (step S176). When the system control unit 34 finishes this process, the batch delivery item selection page request reception process ends.

When it is determined in step S173 that the delivery date and time designation flag is set to ON (step S173: YES), the system control unit 34 acquires the scheduled delivery date and time from the retrieved delivery management information (step S177). The scheduled delivery date and time is the delivery date and time presently designated by the orderer. Subsequently, the system control unit 34 retrieves delivery management information in which the same scheduled delivery date and time as the acquired scheduled delivery date and time is set among the pieces of delivery management information that includes the user ID of the orderer as the user ID of the recipient from the delivery management information DB 32d (step S178). In this case, the system control unit 34 excludes delivery management information in which the delivery status is set to “Delivering” from searching targets. Moreover, the system control unit 34 deletes the delivery management information retrieved in step S172 from the retrieval results. Subsequently, the system control unit 34 generates an HTML document of the batch delivery item selection page based on the retrieved delivery management information and transmits the HTML document (steps S175 and S176).

The user terminal 8 having received the HTML document displays the batch delivery item selection page on the screen based on the received HTML document as illustrated in FIG. 11, for example.

[4-2-5. Operation when Receiving Batch Delivery Information]

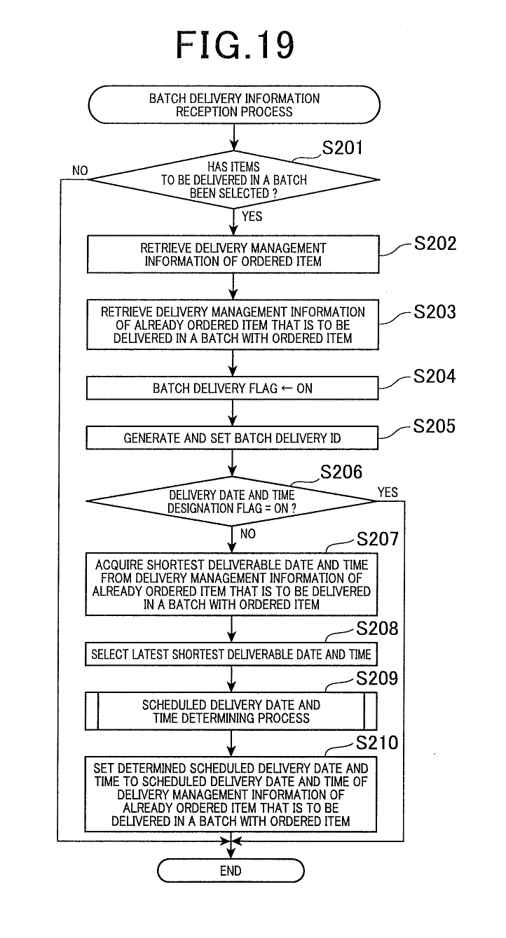

Next, the operation when the home delivery server 3 receives the batch delivery information from the user terminal 8 on which the batch delivery item selection page is displayed will be described. FIG. 19 is a flowchart illustrating a processing example of a batch delivery information reception process of the system control unit 34 of the home delivery server 3 according to the present embodiment. The batch delivery information is transmitted from the user terminal 8 when the user selects the OK button 320 in the batch delivery item selection page illustrated in FIG. 11.

As illustrated in FIG. 19, the system control unit 34 determines whether an order number and an item ID are included in the received batch delivery information (step S201). That is, the system control unit 34 determines whether an already ordered item that is to be delivered in a batch with the ordered item has been selected. In this case, when it is determined that the order number and the item ID are not included (step S201: NO), the system control unit 34 ends the batch delivery information reception process.

On the other hand, when it is determined that the order number and the item ID are included (step S201: YES), the system control unit 34 acquires an order number associated with the user ID of the orderer from the RAM 24c. Subsequently, the system control unit 34 retrieves delivery management information that includes the acquired order number from the delivery management information DB 32d (step S202). That is, the system control unit 34 retrieves the delivery management information of the ordered item. Subsequently, the system control unit 34 acquires the order number and the item ID from the batch delivery information. Subsequently, the system control unit 34 retrieves delivery management information that includes the acquired order number and item ID from the delivery management information DB 32d (step S203). That is, the system control unit 34 retrieves the delivery management information of the already ordered item that is to be delivered in a batch with the ordered item. In this case, when a plurality of sets of order number and item ID is included in the batch delivery information, the system control unit 34 retrieves the delivery management information for each set.

Subsequently, the system control unit 34 sets the batch delivery flag of the delivery management information of the ordered item and the batch delivery flag of the delivery management information retrieved in step S203 to ON (step S204). Subsequently, the system control unit 34 generates a new batch delivery ID. Subsequently, the system control unit 34 sets the generated batch delivery ID to the delivery management information of the ordered item and the delivery management information retrieved in step S203 (step S205).

Subsequently, the system control unit 34 determines whether the delivery date and time designation flag included in the delivery management information of the ordered item is set to ON (step S206). In this case, when it is determined that the delivery date and time designation flag is set to ON (step S206: YES), the system control unit 34 ends the batch delivery information reception process.

On the other hand, when it is determined that the delivery date and time designation flag is not set to ON (step S206: NO), the system control unit 34 acquires the shortest deliverable date and time from the delivery management information of the ordered item and the delivery management information retrieved in step S203 (step S207). Subsequently, the system control unit 34 selects the latest shortest deliverable date and time among the acquired shortest deliverable dates and times as an argument of the scheduled delivery date and time determining process (step S208).

Subsequently, the system control unit 34 executes the scheduled delivery date and time determining process (step S209) (see FIG. 15). In this case, in the scheduled delivery date and time determining process, the earliest date and time on which both the ordered item and an already ordered item selected as an item to be delivered in a batch with the ordered item can be delivered among the available receipt dates and times arranged by the orderer or the like is determined as the scheduled delivery date. Subsequently, the system control unit 34 arranges the scheduled delivery date and time determined in the scheduled delivery date and time determining process in the delivery management information of the ordered item (step S210). When the system control unit 34 finishes this process, the batch delivery information reception process ends.

### [4-3. Slip Number Issuing Operation]

Next, the operation of the delivery system S when issuing slip numbers will be described.

An employee of a shop input an order number of an ordered item to the shop terminal 7. Moreover, the employee selects to issue a slip number. Then, the shop terminal 7 transmits the input order number to the home delivery server 3.

The home delivery server 3 retrieves the delivery management information that includes the received order number from the delivery management information DB 32d. Subsequently, the home delivery server 3 generates a new slip number. Subsequently, the home delivery server 3 sets the generated slip number in the retrieved delivery management information. Moreover, the home delivery server 3 acquires an order number from the retrieved delivery management information. Subsequently, the home delivery server 3 retrieves a purchase history that includes the acquired order number from the purchase history DB 22b. Moreover, the home delivery server 3 sets a slip number in the retrieved purchase history. Subsequently, the home delivery server 3 transmits the generated slip number to the shop terminal 7.

When an orderer has ordered a plurality of items at the same time, a plurality of pieces of delivery management information that includes the same order number as the order number input by the employee of the shop may be registered in the delivery management information DB 23d. In this case, the home delivery server 3 may generate a slip number for each piece of delivery management information and transmit the slip numbers to the shop terminal 7, for example.

Moreover, the orderer may input a message in the message input field of the payment and delivery method selection page, requesting that a presently ordered item and an already ordered item that has not been dispatched from a shop are to be packaged and delivered in a batch. In this case, the employee having read the message inputs the order numbers of the respective items to the shop terminal 7. Then, the shop terminal 7 transmits the plurality of input order numbers to the home delivery server 3.

When a plurality of order numbers has been received, the home delivery server 3 retrieves delivery management information that includes respective order numbers. Moreover, the home delivery server 3 integrates the retrieved pieces of delivery management information. In this case, the home delivery server 3 allows the information set in the delivery management information before integration to be inherited to the new delivery management information as necessary. In this case, the home delivery server 3 allows the order numbers and the item IDs set in the respective pieces of delivery management information before integration to be inherited to the new delivery management information. Moreover, the home delivery server 3 allows the latest shortest deliverable date and time among the shortest deliverable dates and times set in the respective pieces of delivery management information before integration to be inherited to the new delivery management information. Further, the home delivery server 3 allows the latest scheduled delivery date and time among the scheduled delivery dates and times set in the respective pieces of delivery management information before integration to be inherited to the new delivery management information. Subsequently, the home delivery server 3 generates a new slip number. Subsequently, the home delivery server 3 sets the generated slip number in the new delivery management information. Subsequently, the home delivery server 3 transmits the generated slip number to the shop terminal 7.

### [4-4. Delivery State Input Operation]

Next, the operation when an employee of a distribution center or a deliveryman inputs a delivery state of an item will be described.

When an employee of a distribution center inputs a delivery state, the employee inputs a slip number from a delivery slip attached to an item using a barcode reader or the like. Moreover, the employee operates the distribution center terminal 5 to select a delivery status corresponding to the delivery state. Then, the distribution center terminal 5 transmits delivery state information to the home delivery server 3.

Moreover, when a deliveryman inputs the delivery state, similarly, the deliveryman inputs a slip number from a delivery slip attached to an item and operates the deliveryman terminal 6 to select a delivery status. Then, the deliveryman terminal 6 transmits delivery state information to the home delivery server 3.

The delivery state information includes the input slip number and the selected delivery status. Moreover, the delivery state information includes the present date and time as a recording date and time. Moreover, the delivery state information includes a center ID of a distribution center to which an employee or a deliveryman who input the delivery state belongs to. When the employee of the distribution center or the deliveryman belongs to the company Y, the delivery state information is transmitted to the partner delivery company server 4 from the distribution center terminal 5 or the deliveryman terminal 6, and the delivery state information is transmitted from the partner delivery company server 4 to the home delivery server 3.

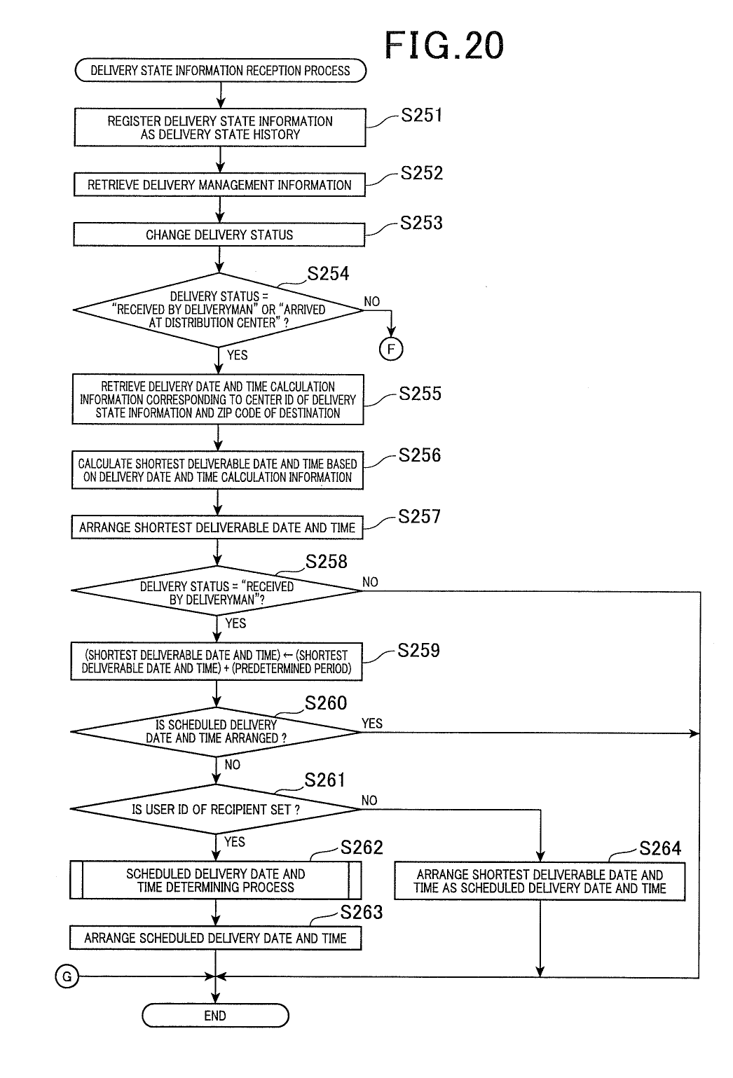

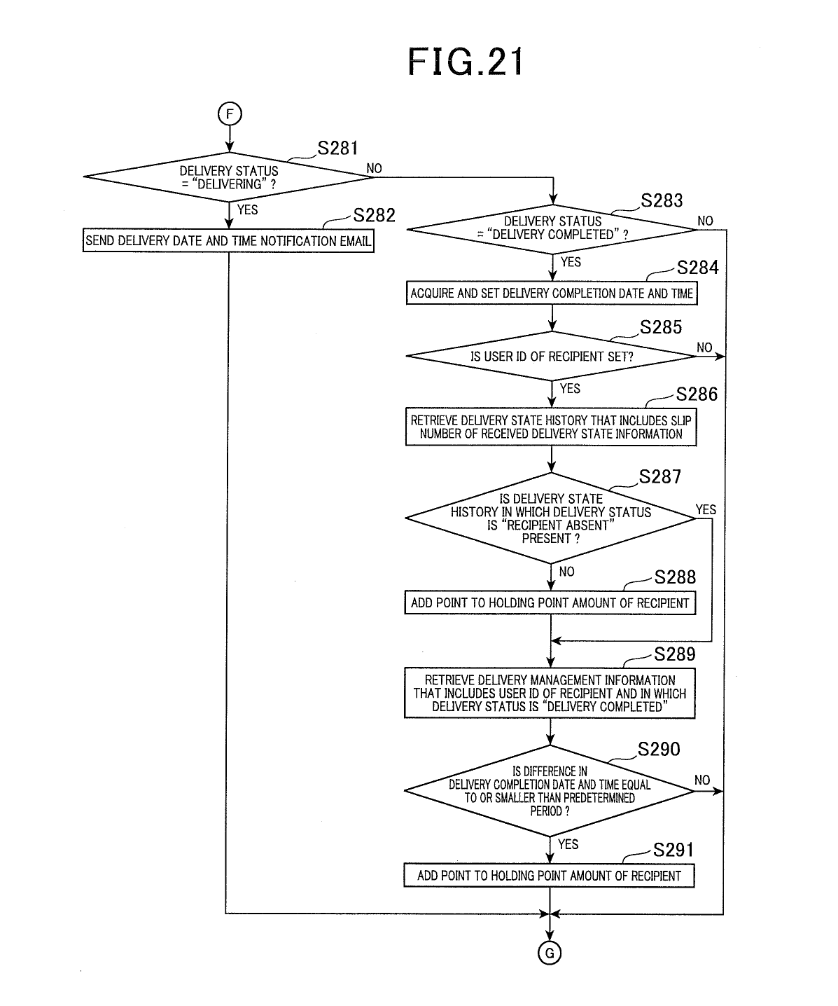

FIGS. 20 and 21 are flowcharts illustrating a processing example of a delivery state information reception process of the system control unit 34 of the home delivery server 3 according to the present embodiment. The delivery state information reception process starts when the home delivery server 3 receives the delivery state information.

As illustrated in FIG. 20, the system control unit 34 registers the received delivery state information in the delivery state history DB 32e as a delivery state history (step S251). Subsequently, the system control unit 34 acquires a slip number from the delivery state information. Subsequently, the system control unit 34 retrieves the delivery management information that includes the acquired slip number from the delivery management information DB 32d (step S252). Subsequently, the system control unit 34 changes the delivery status included in the delivery management information to the delivery status included in the received delivery state information (step S253).

Subsequently, the system control unit 34 determines whether the delivery status included in the received delivery state information is “Received by deliveryman,” “Arrived at distribution center not in charge,” or “Arrived at distribution center in charge” (step S254). In this case, when it is determined that the delivery status is “Received by deliveryman,” “Arrived at distribution center not in charge,” or “Arrived at distribution center in charge” (step S254: YES), the system control unit 34 retrieves delivery date and time calculation information corresponding to the distribution center ID included in the received delivery state information and the zip code included in the destination information of the retrieved delivery management information from the distribution center information DB 32b (step S255). Subsequently, the system control unit 34 calculates the shortest deliverable date and time based on the delivery date and time calculation information (step S256). This calculation method is basically the same as the calculation method in step S53 illustrated in FIG. 13. Subsequently, the system control unit 34 arranges the calculated shortest deliverable date and time in the retrieved delivery management information (step S257). That is, the system control unit 34 rearranges the shortest deliverable date and time when an item is dispatched and rearranges the shortest deliverable date and time whenever an item is carried in a distribution center. In this way, in the process where items are redirected between distribution centers, the closer the item is moved to the address of the user, the more accurate the shortest deliverable date and time become. Basically, the closer the item is moved to the address of the user, the shorter the shortest deliverable date and time become.

Subsequently, the system control unit 34 determines whether the delivery status included in the received delivery state information is “Received by deliveryman” (step S258). In this case, when it is determined that the delivery status is not “Received by deliveryman” (step S258: NO), the system control unit 34 ends the delivery state information reception process. On the other hand, when it is determined that the delivery status is “Received by deliveryman” (step S258: YES), the system control unit 34 adds a predetermined period as a period required for the deliveryman to carry the item in the distribution center to the shortest deliverable date and time set in the retrieved delivery management information (step S259).

Subsequently, the system control unit 34 determines whether the scheduled delivery date and time is arranged in the retrieved delivery management information (step S260). In this case, when it is determined that the scheduled delivery date and time is arranged (step S260: YES), the system control unit 34 ends the delivery state information reception process.

On the other hand, when it is determined that the scheduled delivery date and time is not arranged (step S260: NO), the system control unit 34 determines whether the user ID of the recipient is set in the retrieved delivery management information (step S261). That is, the system control unit 34 determines whether the recipient is a member of a service providing site. In this case, when it is determined that the user ID of the recipient is set (step S261: YES), the system control unit 34 executes the scheduled delivery date and time determining process (step S262). In this case, the system control unit 34 arranges the calculated shortest deliverable date and time as an argument. Subsequently, the system control unit 34 arranges the scheduled delivery date and time determined in the scheduled delivery date and time determining process in the retrieved delivery management information (step S263). That is, the system control unit 34 arranges the scheduled delivery date and time of an item, which, at the time of ordering, it is not clear when the item will be dispatched, at the time of dispatching. In this way, the system control unit 34 as a date acquiring means acquires the earliest date and time on which the ordered item can be delivered among the available receipt dates and times arranged by the recipient or the like from the storage unit 32. Moreover, the system control unit 34 as a delivery information storage controlling means stores the delivery management information that includes the acquired date and time as the scheduled delivery date and time in the storage unit 32. When the system control unit 34 finishes this process, the delivery state information reception process ends.

On the other hand, when it is determined that the user ID of the recipient is not set (step S261: NO), the system control unit 34 arranges the calculated shortest deliverable date and time in the retrieved delivery management information as the scheduled delivery date and time (step S264). When the system control unit 34 finishes this process, the delivery state information reception process ends.

When it is determined in step S254 that the delivery status is not “Received by deliveryman,” “Arrived at distribution center not in charge,” or “Arrived at distribution center in charge” (step S254: NO), the system control unit 34 determines whether the delivery status included in the received delivery state information is “Delivering” as illustrated in FIG. 21 (step S281). In this case, when it is determined that the delivery status is “Delivering” (step S281: YES), the system control unit 34 sends a delivery date and time notification email (step S282). Specifically, the system control unit 34 acquires a mobile email address from the membership information corresponding to the user ID of the recipient set in the retrieved delivery management information. Subsequently, the system control unit 34 sets the acquired mobile email address as a destination of the delivery date and time notification email. Subsequently, the system control unit 34 inserts a message indicating that an item starts to be delivered to the recipient in the main text of the delivery date and time notification email. Moreover, the system control unit 34 inserts the order number, slip number, and scheduled delivery date and time set in the retrieved delivery management information and an item name or the like of the item corresponding to the item ID set in the delivery management information in the main text of the delivery date and time notification email. Then, the system control unit 34 transmits the delivery date and time notification email. When the system control unit 34 finishes this process, the delivery state information reception process ends.

On the other hand, when it is determined that the delivery status is not “Delivering” (step S281: NO), the system control unit 34 determines whether the delivery status included in the received delivery state information is “Delivery completed” (step S283). In this case, when it is determined that the delivery status is not “Delivery completed” (step S283: NO), the system control unit 34 ends the delivery state information reception process.

On the other hand, when it is determined that the delivery status is “Delivery completed” (step S283: YES), the system control unit 34 acquires the recording date and time included in the received delivery state information as the delivery completion date and time. Moreover, the system control unit 34 arranges the acquired delivery completion date and time in the delivery management information retrieved in step S252 (step S284). The delivery state information that includes the delivery status set to “Delivery completed” is an example of delivery completion information in the present invention. Subsequently, the system control unit 34 determines whether the user ID of the recipient is set in the retrieved delivery management information (step S285). In this case, when it is determined that the user ID of the recipient is not set (step S285: NO), the system control unit 34 ends the delivery state information reception process.

On the other hand, when it is determined that the user ID of the recipient is set (step S285: YES), the system control unit 34 retrieves the delivery state history that includes the slip number acquired from the retrieved delivery management information in step S252 from the delivery state history DB 32e (step S286). Subsequently, the system control unit 34 determines whether the delivery state history in which the delivery status is set to “Recipient absent” is present in the delivery state histories retrieved in step S286 (step S287). In this case, when it is determined that the delivery state history in which the delivery status is set to “Recipient absent” is not present (step S287: NO), the system control unit 34 adds a point to the holding point amount of the recipient (step S288). That is, since the recipient has received an item at the first delivery, points are granted to the recipient. Specifically, the system control unit 34 acquires the user ID of the recipient from the retrieved delivery management information. Subsequently, the system control unit 34 adds a predetermined point amount to the holding point amount included in the membership information corresponding to the acquired user ID.

In this way, the system control unit 34 as a fourth determining means determines whether the item has been received at the first delivery based on the delivery state history. Moreover, when it is determined that the item was received at the first delivery, the system control unit 34 as a second reward information storage controlling means stores a holding point amount to which a point amount as a reward is added in the storage unit 32.

When it is determined in step S287 that the delivery state history in which the delivery status is set to “Recipient absent” is present (step S287: YES) or when the process of step S288 has been finished, the system control unit 34 acquires the user ID of the recipient from the delivery management information retrieved in step S252. Subsequently, the system control unit 34 retrieves the delivery management information in which the delivery status is set to “Delivery completed” among the pieces of delivery management information that include the same user ID as the acquired user ID from the delivery management information DB 32d (step S289). That is, the system control unit 34 retrieves the delivery state history corresponding to the item which has been delivered to the recipient. In this case, the system control unit 34 deletes the delivery management information retrieved in step S252 from the retrieval results.

Subsequently, the system control unit 34 acquires the delivery completion date and time from the delivery management information retrieved in step S289. Subsequently, the system control unit 34 selects the latest delivery completion date and time among the acquired delivery completion dates and times. Subsequently, the system control unit 34 determines whether a difference between the selected latest delivery completion date and time and the delivery completion date and time acquired in step S284 is equal to or smaller than a predetermined period stored in the storage unit 32 (step S290). That is, the system control unit 34 determines whether the deliveryman has input a notice of completion of delivery of another item to the deliveryman terminal 6 in the predetermined period after the deliveryman input a notice of completion of delivery of a certain item to the same recipient to the deliveryman terminal 6.

In this case, when it is determined that the difference is equal to or smaller than the predetermined period (step S290: YES), the system control unit 34 adds a point to the holding point amount of the recipient (step S291). The detailed process thereof is the same as that of step S288. When the deliveryman has input the completion of delivery of another item in the predetermined period after the deliveryman input the completion of delivery of a certain item to the same recipient, the system control unit 34 grants a point to the recipient by regarding that the recipient has received these items in a batch. The predetermined period is set in advance by an administrator of the home delivery server 3. For example, the predetermined period is shorter than the shortest delivery time period (in the present embodiment, one hour) among the delivery time periods designable as the delivery time period. Moreover, the predetermined period is set to such a length that it can be regarded that the recipient has received two items in a batch. For example, the predetermined period is set to ten minutes or the like. The larger the number of items that the recipient receives at the same time is, the larger the added points become. For example, it is assumed that a recipient has received items A, B, and C. Moreover, it is assumed that the deliveryman has input the completion of delivery in the order of items A, B, and C. Here, if the period taken from the input for the item A to the input for the item B is within the predetermined period, a predetermined point amount is added. Moreover, if the period taken from the input for the item B to the input for the item C is within the predetermined period, a predetermined point amount is added further.

When a deliveryman carries items to be delivered out of a distribution center, the items carried out may include a plurality of items of the same recipient. In this case, the plurality of items of the same recipient is generally delivered in a batch. Thus, the system control unit 34 may regard that the recipient has received a plurality of items in a batch at the point in time when a plurality of items of the same recipient is carried out of a distribution center at the same time, and the delivery of at least one of the items is completed and grant a point to the recipient. Specifically, a plurality of items of which the recipient is the same and the scheduled delivery date and time is the same is delivered in a batch. Thus, the system control unit 34 may regard that the recipient has received the plurality of items in a batch at the point in time when the delivery of one of the plurality of items satisfying such a condition is completed. When delivery state information in which the delivery status is set to “Delivery completed” is received, the system control unit 34 acquires the user ID of the recipient and the scheduled delivery date and time from the corresponding delivery management information. Subsequently, the system control unit 34 retrieves the delivery management information that includes the acquired user ID and the scheduled delivery date and time from the delivery management information DB 32d. In this case, when a plurality of pieces of delivery management information is retrieved, a plurality of items is delivered in a batch. Thus, the system control unit 34 grants a point to the recipient when a plurality of pieces of delivery management information is retrieved. In this case, the system control unit 34 may retrieve only the delivery management information in which the delivery status is set to “Delivering.” However, the system control unit 34 updates the delivery management information of respective items. Thus, the deliveryman inputs a notice of completion of delivery of each item to the deliveryman terminal 6. The system control unit 34 receives the delivery state information with respect to each of the plurality of items being delivered in a batch. Here, the system control unit 34 may grant a point to the recipient in response to the delivery state information received first. Moreover, the system control unit 34 may not grant a point to the recipient in response to the delivery state information received subsequently.

In this way, the system control unit 34 as a third determining means determines whether a plurality of items has been received in a batch based on the delivery completion date and time included in the received delivery state information. Moreover, when it is determined that the plurality of items has been received in a batch, the system control unit 34 as a first reward information storage controlling means stores a holding point amount to which a point amount as a reward is added in the storage unit 32.

When it is determined in step S290 that the difference is larger than the predetermined period (step S290: NO), or when the process of step S291 has been finished, the system control unit 34 ends the delivery state information reception process.

### [4-5. Delivery State Viewing Operation]

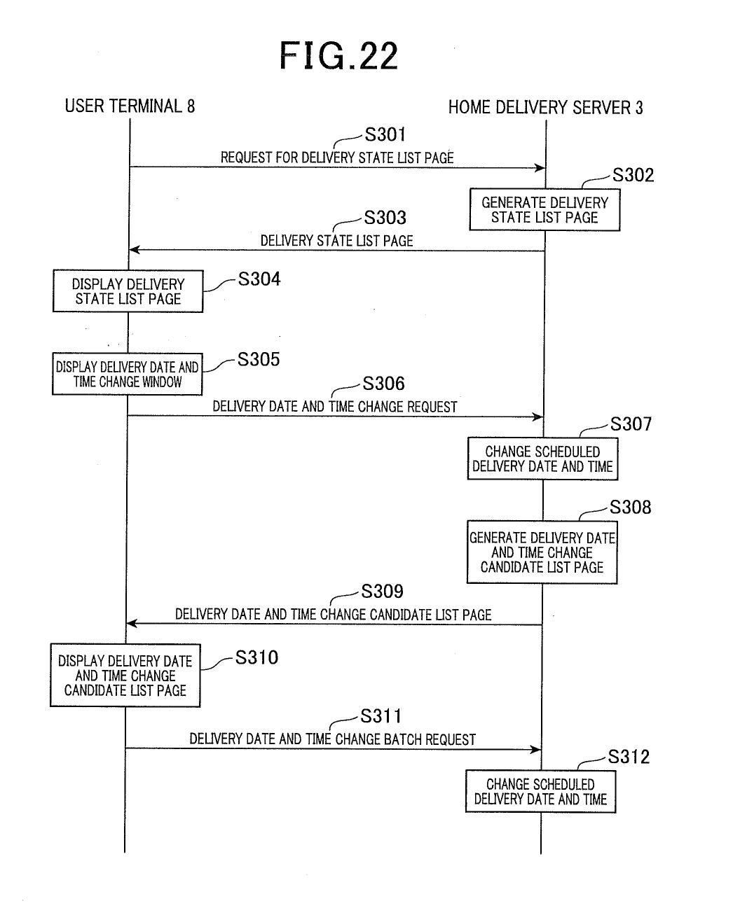

Next, the operation when a user views a delivery state of an item will be described. FIG. 22 is a sequence diagram illustrating a processing example during viewing of the delivery state of the delivery system S according to the present embodiment.

For example, when a user selects to view a delivery state in a state where a webpage of an online mall is displayed on the user terminal 8, the user terminal 8 transmits a request for a delivery state list page to the home delivery server 3 (step S301). The delivery state list page is a webpage for displaying a list of delivery states of items. The user who views the delivery state is referred to as a “viewer.”

Upon receiving the request, the home delivery server 3 retrieves delivery management information that includes the user ID of the viewer from the delivery management information DB 32d. As for the delivery management information in which the delivery status is set to “Delivery completed,” the home delivery server 3 may retrieve only the delivery management information in which the delivery completion date is within a predetermined period (for example, within past one method) from the present point in time. Moreover, the home delivery server 3 generates a delivery state list page based on the retrieved delivery management information (step S302). Specifically, the home delivery server 3 generates the delivery state list page so that the delivery state is displayed for each piece of delivery management information. Moreover, as for the delivery management information in which the delivery status is not set to “Delivery completed” but a scheduled delivery date and time is arranged, the home delivery server 3 generates the delivery state list page so that the viewer can change the delivery date and time. In this case, as for a group of pieces of delivery management information in which the delivery information is set to ON and the view IDs are the same, the home delivery server 3 allows the delivery dates and times to be changed in a batch only. The home delivery server 3 transmits the generated delivery state list page to the user terminal 8 (step S303). The user terminal 8 displays the received delivery state list page on the screen (step S304).

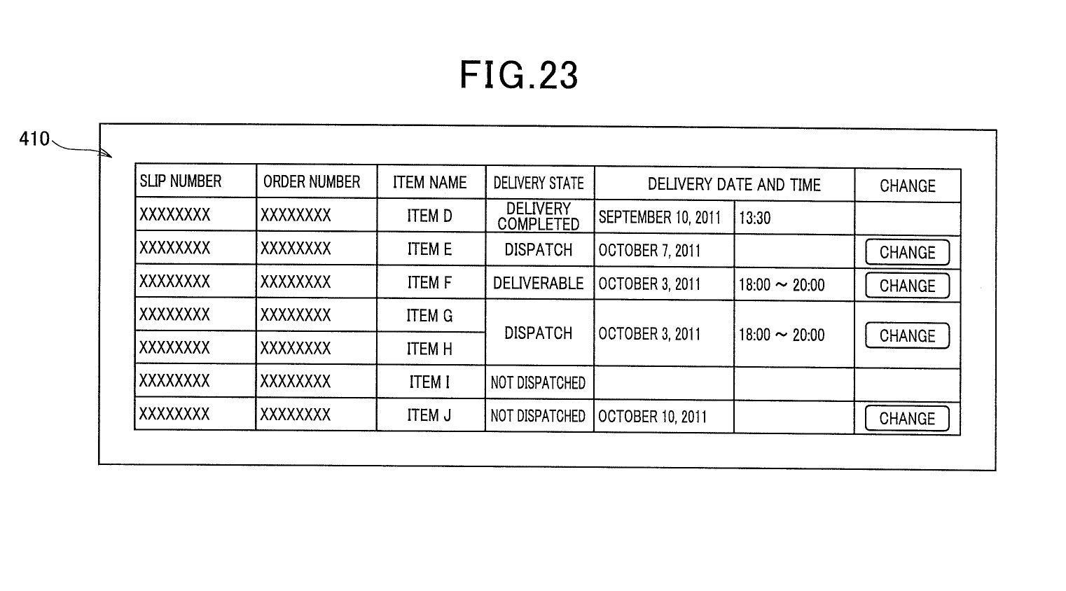

FIG. 23 is a diagram illustrating a screen display example of the delivery state list page. As illustrated in FIG. 23, the delivery state list page includes a delivery state list display region 410 and the like.

A list of delivery states is displayed in the delivery state list display region 410. Specifically, a slip number, an order number, an item name, a delivery state, a scheduled delivery date and time (delivery completion date and time when delivery is completed), and the like are displayed for each slip number. The home delivery server 3 may not display an item name of an item of which the orderer is different from the recipient. For example, this is because, when an orderer orders an item as a present to a recipient, the orderer may not want to have the recipient informed of which item will be sent.

Examples of the delivery state include “Not dispatched,” “Dispatched,” “Deliverable,” “Delivering,” “Delivery completed,” and the like. When the delivery status is “Not dispatched,” the delivery state is “Not dispatched.” Moreover, when the delivery status is “Received by deliveryman,” “Arrived at distribution center not in charge,” or “Redirected,” the delivery state is “Dispatched.” Moreover, when the delivery status is “Arrived at distribution center in charge” or “Recipient absent,” the delivery state is “Deliverable.” Further, when the delivery status is “Delivering,” the delivery state is “Delivering.” Furthermore, when the delivery status is “Delivery completed,” the delivery state is “Delivery completed.”

In addition to the delivery state, the names of a distribution center that holds an item presently and a distribution center to which a deliveryman who is delivering the item belongs may be displayed. The distribution center that holds an item presently and the distribution center to which a deliveryman who is delivering the item belongs are referred to “handling distribution centers.” Specifically, the system control unit 34 allows the center ID of the handling distribution center to be registered in the delivery management information that is registered in the delivery management information DB 32d. The delivery state information that the online mall server 1 receives from the distribution center terminal 5, the deliveryman terminal 6, and the like includes the center ID of the distribution center to which an employee or a deliveryman who inputs the delivery state belongs to. Thus, the system control unit 34 sets the center ID included in the delivery state information in the delivery management information as the center ID of the handling distribution center when receiving the delivery state information and updating the delivery status of the delivery management information. Moreover, the system control unit 34 generates the delivery state list page so that the name of the distribution center indicated by the center ID included in the delivery management information is displayed in the delivery state list display region 410.

Moreover, a change button is displayed in the delivery state list display region 410 so as to correspond to an item of which delivery state is not “Delivery completed” and the scheduled delivery date and time is displayed.

When a user selects a certain change button, the user terminal 8 displays a delivery date and time change window on the screen (step S305). The delivery date and time change window is a window for designating a new delivery date and time. When the user designates a changed delivery date and time by operating a pull-down menu and a check box displayed in the delivery date and time change window, the user terminal 8 transmits a delivery date and time change request that includes a slip number corresponding to the selected change button and the designated delivery date and time to the home delivery server 3 (step S306).

The home delivery server 3 retrieves delivery management information that includes the slip number included in the delivery date and time change request from the delivery management information DB 32d. Moreover, the home delivery server 3 changes the scheduled delivery date and time included in the retrieved delivery management information to the delivery date and time included in the received delivery date and time change request (step S307).

Moreover, the home delivery server 3 retrieves delivery management information in which the delivery status is not “Delivery completed” and the shortest deliverable date and time is earlier than the changed scheduled delivery date among the pieces of delivery management information that includes the user ID of the viewer as the user ID of the recipient from the delivery management information DB 32d. The home delivery server 3 generates a delivery date and time change candidate list page based on the retrieved delivery management information (step S308). The delivery date and time change candidate list page is a webpage for displaying a list of items of which scheduled delivery date and time can be changed to the same date and time as the item of which the scheduled delivery date and time has been changed. The home delivery server 3 transmits the generated delivery date and time change candidate list page to the user terminal 8 (step S309). The user terminal 8 displays the received delivery date and time change candidate list page on the screen (step S310).

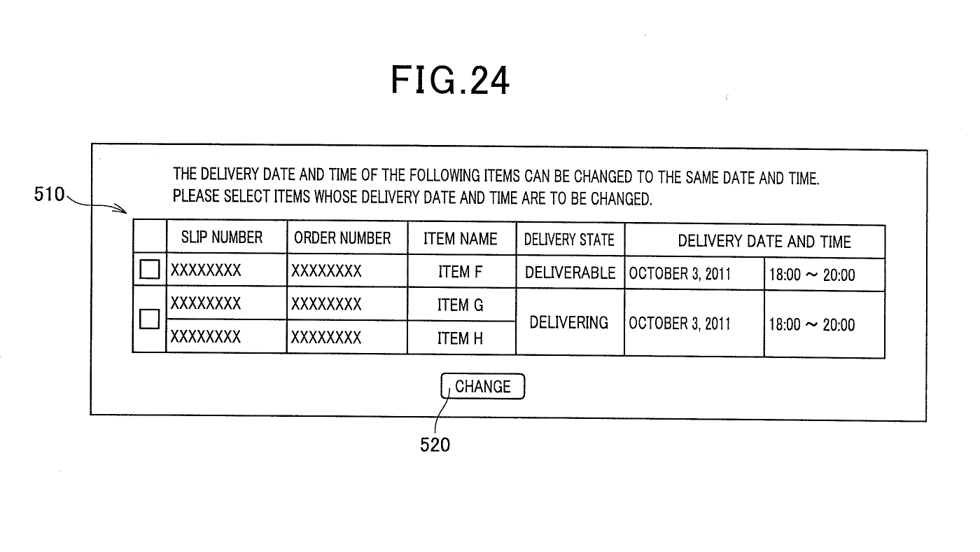

FIG. 24 is a diagram illustrating a screen display example of the delivery date and time change candidate list page. As illustrated in FIG. 24, the delivery date and time change candidate list page includes a change candidate list display region 510, a change button 520, and the like.

A list of delivery states of items which are candidate items of which the scheduled delivery date and time can be changed is displayed in the change candidate list display region 510. Specifically, a slip number, an order number, an item name, a delivery state, a scheduled delivery date and time, and a check box for selecting whether or not to change the scheduled delivery date and time, and the like are displayed for each slip number.

In the delivery date and time change candidate list page, the user selects the change button 520 by selecting an item as necessary. Then, the user terminal 8 transmits a delivery date and time change request that includes the slip number of the selected item to the home delivery server 3 (step S311).

The home delivery server 3 retrieves delivery management information that includes the slip number included in the delivery date and time change request from the delivery management information DB 32d. The home delivery server 3 changes the scheduled delivery date and time included in the retrieved delivery management information to the delivery date and time included in the delivery date and time change request received earlier (step S312). In this case, when the delivery date and time change request includes a plurality of slip numbers, the home delivery server 3 changes the scheduled delivery date and time of all slip numbers.

In this manner, the user can check the delivery state of items of which the recipient is the user. Moreover, the user can freely change the delivery date and time of items. Further, the user can easily change the delivery dates and times of a plurality of items to the same delivery date and time in a batch.

The delivery state of an item can be viewed from the purchase history. For example, when a viewer selects to view a purchase history of items in a state where a webpage of an online mall is displayed on the user terminal 8, the user terminal 8 transmits a request for a purchase history list page to the online mall server 2. The purchase history list page is a webpage for displaying a list of purchase histories. The online mall server 2 retrieves a purchase history that includes the user ID of the viewer from the purchase history DB 22b. Moreover, the online mall server 2 generates a purchase history list page based on the retrieved purchase history. Further, the online mall server 2 transmits the generated purchase history list page to the user terminal 8. In the purchase history list page, a purchase date and time, a shop name of an order recipient shop, an item name of an ordered item, a delivery method, and the like are displayed for each past order. When the delivery method is an online mall s home delivery service, a delivery state button for viewing the delivery state is further displayed.

When the viewer selects the delivery state button, the user terminal 8 transmits a request for the delivery state page to the home delivery server 3. The delivery state page is a webpage for displaying delivery states of items designated by the user. The request for the delivery state page includes a slip number of an item corresponding to the selected delivery state button. The home delivery server 3 retrieves delivery management information that includes the slip number included in the received request from the delivery management information DB 32d and generates a delivery state page based on the retrieved delivery management information. A method of generating the delivery state page is basically the same as a method of generating the delivery state list page. The home delivery server 3 transmits the generated delivery state page to the user terminal 8.

The user may designate an option such that the item the user selects in the delivery date and time change candidate list page and the item of which the scheduled delivery date and time has been changed are to be delivered in a batch. In this case, these items are subject to the batch delivery as a group of items.

Moreover, the scheduled delivery date and time when a user replies to the delivery date and time notification email may be changed manually by the administrator of the home delivery server 3 and may be changed by the home delivery server 3 based on the response email, for example.

As described above, according to the present embodiment, when an orderer has ordered an item without designating a delivery date, the system control unit 34 of the home delivery server 3 acquires an earliest available receipt date on which an ordered item can be delivered among available receipt dates stored in the storage unit 32 as the predetermined dates arranged by the user and stores the delivery management information that includes the acquired available receipt date as a scheduled delivery date of the ordered item in the storage unit 32. Moreover, when an orderer has ordered by designating a delivery date, the system control unit 34 changes a scheduled delivery date included in the delivery management information that is stored in advance in the storage unit 32 to the presently designated delivery date. Thus, it is possible to easily change the delivery date of the ordered item after the date arranged in advance by the orderer is set as the delivery date.

Moreover, when an orderer has ordered an item without designating a delivery date and an already ordered item and a presently ordered item are designated to be delivered in a batch, the system control unit 34 acquires an earliest available receipt date on which both the already ordered item and the presently ordered item can be delivered from the storage unit 32, stores the delivery management information that includes the acquired available receipt date as a scheduled delivery date in the storage unit 32, and arranges the acquired available receipt date to the scheduled delivery date included in the delivery management information of the already ordered item that is designated to be delivered in a batch with the presently ordered item. Thus, the orderer can receive items in a batch.

Moreover, when an orderer has ordered an item by designating a delivery date, the system control unit 34 determines whether an already ordered item can be delivered on the presently designated delivery date, and changes the scheduled delivery date of the already ordered item that is determined to be deliverable on the presently designated delivery date among the already ordered items. When it is determined that at least one of the plurality of already ordered items designated to be delivered in a batch cannot be delivered on the presently designated delivery date, the system control unit 34 does not change the scheduled delivery date included in the delivery management information of each of the plurality of items. Thus, it is possible to prevent the scheduled delivery date of a partial item among a plurality of items designated to be delivered in a batch from being changed. Thus, since the scheduled delivery dates of the plurality of items are the same, the orderer can receive items in a batch.

Moreover, when an orderer has ordered an item without designating a delivery date, the system control unit 34 acquires an earliest available receipt date on which an ordered item can be delivered among available receipt dates and times stored in the storage unit 32 in association with any one of the user ID of the orderer and the user ID of a user who is registered as a family of the orderer and is regarded to have the same address as the orderer and stores delivery management information that includes the acquired available receipt date as a scheduled delivery date of the ordered item in the storage unit 32. Thus, another user can receive the item even when it is not convenient for the orderer to receive the item. As a result, the orderer who has ordered the item can receive the item.

Moreover, when an orderer has ordered an item by designating a delivery date, the system control unit 34 changes a scheduled delivery date included in the delivery management information associated with any one of the user ID of the orderer and the user ID of a user who is registered as a family of the orderer and is regarded to have the same address as the orderer among respective pieces of delivery management information stored in advance in the storage unit 32 to the presently designated delivery date. Thus, a user who has ordered a present item can receive the item that was ordered by another user. As a result, the other user can receive the item that the user has ordered.

Further, when an orderer has ordered an item without designating a delivery date, and destination information of a recipient is input by the orderer, the system control unit 34 acquires the user ID of the recipient based on the destination information, acquires an earliest available receipt date on which the ordered item can be delivered among available receipt dates stored in the storage unit 32 in association with the acquired user ID, and stores delivery management information that includes the acquired available receipt date as a scheduled delivery date of the ordered item in the storage unit 32. Thus, even when the recipient is different from the orderer, the recipient can receive an item when it is convenient for the recipient.

Further, when the scheduled delivery date included in the delivery management information stored in the storage unit 32 is changed to a delivery date that is earlier than the scheduled delivery date, the system control unit 34 sends the delivery date and time change notification email to the recipient. Thus, it is possible to prevent the deliveryman from going out to deliver an item when the recipient is not informed of.

Further, when delivery state information in which the delivery status is set to “Delivery completed” is acquired from the deliveryman terminal 6, the system control unit 34 determines whether a plurality of items having different delivery slips has been received in a batch by the user, and adds a predetermined point amount to a holding point amount included in the membership information of the user when it is determined the items are received. Thus, since it can be expected that the user receives a plurality of items in a batch, it is possible to prevent the deliveryman from going out to deliver to the same address a plurality of times.

Further, the system control unit 34 determines whether an item has been received by the user at the first delivery based on the delivery state history stored in the storage unit 32 and adds a predetermined point amount to the holding point amount included in the membership information of the user. Thus, it can be expected that the user receives the item on the scheduled delivery date. Thus, it is possible to prevent the deliveryman from going out to deliver the same item a plurality of times.

In the embodiment, when an orderer has ordered an item by designating a delivery date and time, the home delivery server 3 has changed the scheduled delivery date and time of the already ordered item regardless of whether the scheduled delivery date and time of the already ordered item is earlier or later than the designated delivery date and time. However, the home delivery server 3 may change the scheduled delivery date and time only when the scheduled delivery date and time of the already ordered item is later than the designated delivery date and time. By doing so, the user can receive the already ordered item on an early date and it is possible to prevent the delivery date and time of the already ordered item from being delayed.

Specifically, in step S156 of the scheduled delivery date and time changing process illustrated in FIG. 17, the system control unit 34 determines whether the scheduled delivery date and time set in the selected delivery management information is later than the presently designated delivery date and time. When it is determined that the scheduled delivery date and time is later than the presently designated delivery date and time (step S156: YES), the system control unit 34 sends a delivery date and time change notification email (step S157) and changes the scheduled delivery date and time of the selected delivery management information to the presently designated delivery date and time (step S158). This is the same as the embodiment. On the other hand, when it is determined that the scheduled delivery date and time is later than the presently designated delivery date and time (step S156: NO), the system control unit 34 does not change the scheduled delivery date and time and proceeds to step S137.

In the above embodiment, when the orderer selects to have an item to be delivered to an address different from the registered membership address, the home delivery server 3 specifies a recipient based on the destination information input by the orderer and acquires the user ID of the recipient. However, the orderer may input an email address of the recipient together with the destination information. Moreover, the home delivery server 3 may acquire the user ID of the recipient based on the input email address. In this case, the email address of the recipient is an example of specific information in the present invention.

Specifically, an orderer information input page includes an input field for inputting an email address of the recipient. When the orderer inputs the destination information and the email address, the user terminal 8 transmits the input destination information and email address to the online mall server 2. When transmitting the delivery request information to the home delivery server 3, the online mall server 2 includes the email address of the recipient in the delivery request information.

In step S54 of the delivery request information reception process illustrated in FIG. 13, when it is determined that the ordered item is not to be delivered to the registered membership address (step S54: NO), the system control unit 34 of the home delivery server 3 does not execute the processes of steps S81 to S84 but proceeds to step S85. Moreover, when it is determined in step S85 that the delivery date is not designated (step S85: NO), the system control unit 34 does not execute steps S86 and S87 but proceeds to step S88. That is, at this point in time, the system control unit 34 does not arrange the scheduled delivery date and time of the ordered item. Moreover, in step S90, the system control unit 34 sends an order notification email. In this case, the system control unit 34 sets the email address input by the orderer to the destination of the order notification email. Moreover, the system control unit 34 inserts an URL for associating the ordered item and the recipient in the main text of the order notification email. In this case, the system control unit 34 adds an order number of the ordered item to the URL.

The recipient receives the order notification email by operating the user terminal 8. Moreover, the recipient selects the URL inserted in the main text of the order notification email. Then, the user terminal 8 transmits an association request that includes the selected URL to the home delivery server 3. The home delivery server 3 having received the association request transmits an authentication page to the user terminal 8. The authentication page is a webpage for inputting a user ID and a password. The reason why these pieces of information are input by the recipient is to specify whether the recipient is a member of the service providing site and to identify the recipient. When the recipient inputs the user ID and the password, the user terminal 8 transmits the authentication page that includes the input user ID and password to the home delivery server 3.

The home delivery server 3 retrieves membership information corresponding to the user ID included in the received authentication request from the membership information DB 1a and determines whether the password included in the authentication request is identical to that of the retrieved membership information. In this way, the system control unit 34 performs user authentication and retrieves the delivery management information that includes the order number included in the association request from the delivery management information DB 32d when the user authentication is successful. Subsequently, the home delivery server 3 sets the user ID included in the authentication request in the retrieved delivery management information. In this way, it is possible to associate the ordered item and the recipient. In this case, the home delivery server 3 may arrange the earliest date and time on which the ordered item can be delivered among the available receipt dates and times arranged by the recipient or the like as the scheduled delivery date of the ordered item. When the association has been finished, the home delivery server 3 transmits the delivery state page to the user terminal 8. In the delivery state page, a delivery state of the ordered item associated with the present recipient is displayed.

When a cookie that includes the user ID has been received from the user terminal 8 together with the association request (that is, when the user has already logged in), the home delivery server 3 may transmit the delivery state list page without performing user authentication.

Moreover, when the association between the ordered item and the recipient has been performed, the home delivery server 3 may allow the destination information input by the orderer to be changed. For example, after the user authentication succeeded, the home delivery server 3 transmits the destination information input by the orderer to the user terminal 8. The user terminal 8 displays the received destination information on the screen. Here, when there is no problem in the displayed destination information, the recipient performs an operation to agree with the destination information. In this case, the destination information is not changed. On the other hand, when the recipient wants to change the destination information, the recipient performs an operation to input new destination information. Then, the user terminal 8 transmits the input destination information to the home delivery server 3. The home delivery server 3 changes the destination information included in the management information of the ordered item to the received destination information. Moreover, the home delivery server 3 may acquire destination information from the membership information of the recipient and change the destination information included in the management information to the destination information acquired from the membership information.

Moreover, when a user has ordered an item by designating a delivery date and time, the home delivery server 3 may permit bringing forward of the scheduled delivery date but not permit delaying of the scheduled delivery date depending on an already ordered item. For example, if the scheduled delivery date is delayed, food such as raw food of which the expiration date is several days may be delivered after the expiration date expires. To prevent this from occurring, delaying of the scheduled delivery date is inhibited for such an item.

Specifically, a delivery date and time delay flag is registered in each piece of item information. The delivery date and time delay flag indicates whether the scheduled delivery date and time can be delayed. When the delivery date and time delay flag is set to ON, it indicates that the scheduled delivery date and time can be delayed. When the delivery date and time delay flag is set to OFF, it indicates that the scheduled delivery date and time cannot be delayed.

In the delivery request information reception process illustrated in FIG. 13, when initializing the delivery management information of the ordered item (step S51), the system control unit 34 sets the delivery date and time delay flag included in the item information of the ordered item in the delivery management information of the ordered item. After that, in the scheduled delivery date and time changing process illustrated in FIG. 17, when it is determined that the shortest deliverable date and time set in the selected delivery management information is not later than the presently designated delivery date and time (step S155: NO), or when it is determined that the delivery management information in which the shortest deliverable date and time later than the presently designated delivery date and time is set is not present (step S163: NO), the system control unit 34 determines whether the scheduled delivery date and time set in the selected delivery management information is earlier than the presently designated delivery date and time. In this case, when it is determined that the scheduled delivery date and time is not earlier than the presently designated delivery date and time, the system control unit 34 proceeds to step S156. That is, the system control unit 34 changes the scheduled delivery date and time of the already ordered item to the presently designated delivery date and time. On the other hand, when it is determined that the scheduled delivery date and time is earlier than the presently designated delivery date and time, the system control unit 34 determines whether the delivery date and time delay flag included in the selected delivery management information is set to ON. In this case, when it is determined that the delivery date and time delay flag is set to ON, the system control unit 34 proceeds to step S156. That is, the system control unit 34 changes the scheduled delivery date and time of the already ordered item to the presently designated delivery date and time. On the other hand, when the delivery date and time delay flag is set to OFF, the system control unit 34 proceeds to step S137. That is, the system control unit 34 does not change the scheduled delivery date and time of the already ordered item.

Moreover, during ordering of an item of which the scheduled delivery date and time cannot be delayed, users may not be allowed to designate a delivery date and time that is later than the expiration date or the like of such an item in the payment and delivery method selection page.

Moreover, when a user orders an item, the user may be able to select whether the scheduled delivery date and time of the ordered item is to be allowed to be delayed. The detailed process when the user does not allow the delaying is basically the same as the above.

Moreover, in the above embodiment, when a user has ordered an item by designating a delivery date and time, the home delivery server 3 always changes the scheduled delivery date and time of an already ordered item of which the scheduled delivery date and time can be changed to the presently designated delivery date and time. However, the home delivery server 3 may change the scheduled delivery date and time of only an already ordered item that the user has selected in the batch delivery item selection page. In this case, the home delivery server 3 generates the delivery item selection page so that only already ordered items of which scheduled delivery date and time can be changed to the presently designated delivery date and time are displayed as selection candidates.

Moreover, in the above embodiment, the home delivery server 3 issues the slip number when a shop performs an operation for issuing the slip number. However, the home delivery server 3 may issue the slip number when an item is ordered. Specifically, in the delivery request information reception process illustrated in FIG. 13, when the delivery management information of the ordered item is initialized (step S51), the system control unit 34 generates a new slip number. Moreover, the system control unit 34 sets the generated slip number in the delivery management information of the ordered item. When transmitting the dispatch request information to the shop terminal 7, the home delivery server 3 includes the generated slip number in the dispatch request information.

Further, in the above embodiment, a point is granted as a reward to the user. However, for example, a cash, an electronic money, a coupon, or the like may be granted. Moreover, information on a cash or the like granted to the user may be stored in the storage unit 32 as an example of reward information of the present invention.

Further, in the above embodiment, both the delivery date and the delivery time period can be designated as the delivery date and time of items. However, only the delivery date can be designated.

Further, instead of the database management server 1, the online mall server 2 or the home delivery server 3 may include a configuration corresponding to the database management server 1. Moreover, for example, instead of the home delivery server 3, the online mall server 2 may include a configuration corresponding to the home delivery server 3.

Moreover, the entities who operate the online mall and the online mall's home delivery service may not be identical.

In the present embodiment, the present invention is applied to delivery of items ordered in an online mall where items can be ordered from a plurality of shops. However, the present invention may be applied to delivery of items ordered in a website or the like for ordering items from a single seller, for example.

### REFERENCE SIGN LIST

1 Database management server
1a Membership information DB
2 Online mall server
3 Home delivery server
4 Partner delivery company server
5 Distribution center terminal
6 Deliveryman terminal
7 Shop terminal
8 User terminal
21 Communication unit
22 Storage unit
22a Item information DB
22b Purchase history DB
23 Input/output interface
24 System control unit
24a CPU
24b ROM
24c RAM
25 System bus
31 Communication unit
32 Storage unit
32a Service area information DB
32b Distribution center information DB
32c Available receipt date and time information DB
32d Delivery management information DB
32e Delivery state history DB
33 Input/output interface
34 System control unit
34a CPU
34b ROM
34c RAM
35 System bus
NW, NL Network
S Delivery system

1. An information processing apparatus comprising:
a date acquiring unit that, when a user has ordered a first item without designating a delivery date, acquires an earliest date on which the ordered first item can be delivered among dates stored in a date storing unit that stores predetermined dates arranged in advance by the user as dates when the user can receive an item;
a first delivery information storage controlling unit that stores delivery information of the first item that includes the date acquired by the date acquiring unit as a delivery date in a delivery information storing unit that stores delivery information that includes a delivery date of an ordered item as delivery information of the ordered item; and
a changing unit that, when a user has ordered a second item by designating a delivery date, changes the delivery date included in the delivery information of the first item stored in the delivery information storing unit to the designated delivery date,
a second delivery information storage controlling unit that stores delivery information of the second item that includes the designated delivery date in the delivery information storing unit.

2. The information processing apparatus according to claim 1,
wherein the delivery information storing unit stores the delivery information for each slip used for delivery of items,
when an item whose delivery information is stored in the delivery information storing unit is designated by a user as a third item to be delivered in a batch with the presently ordered first item, the date acquiring unit acquires an earliest date on which both the third item and the first item can be delivered from the date storing unit, and
the first delivery information storage controlling unit stores the delivery information of the first item that includes the date acquired by the date acquiring unit as a delivery date in the delivery information storing unit, and arranges the date acquired by the date acquiring unit in the delivery date included in the delivery information of the third item.

3. The information processing apparatus according to claim 2, further comprising:
a first determining unit that, when a user has ordered the second item by designating a delivery date, determines whether the first item whose delivery information is stored in the delivery information storing unit can be delivered on the designated delivery date,
wherein the changing unit changes the delivery date included in the delivery information of the first item which is determined by the first determining unit to be deliverable on the designated delivery date among the delivery information stored in the delivery information storing unit, and does not change the delivery date included in the delivery information of each of a plurality of the first items when the first determining unit determines that at least one of a plurality of the first items delivered in a batch cannot be delivered on the designated delivery date.

4. The information processing apparatus according to claim 1,
wherein the date storing unit stores the date in association with identification information for identifying a user who has arranged the date when the user can receive an item,
the date acquiring unit acquires an earliest date on which the first item can be delivered among the dates associated with the identification information of the user who has ordered the first item and the date associated with the identification information of another user having the same address as the user.

5. The information processing apparatus according to claim 1,
wherein the delivery information storing unit stores the delivery information in association with the identification information of a user who has ordered an item, and
the changing unit changes the delivery date included in the delivery information of the first item associated with the identification information of the user who has ordered the second item, and the delivery date included in the delivery information associated with the identification information of another user having the same address as the user.

6. The information processing apparatus according to claim 1,
wherein the date storing unit stores the date in association with identification information for identifying a user who has arranged the date when the user can receive an item,
the information processing apparatus further comprises an identification information acquiring unit that, when the user who has ordered the first item has input specific information that specifies another user who receives the first item, acquires the identification information of the another user based on the specific information, and
the date acquiring unit acquires an earliest date on which the first item can be delivered among the dates associated with the identification information acquired by the identification information acquiring unit.

7. The information processing apparatus according to claim 1, further comprising:
a second determining unit that, when a user has ordered the second item by designating a delivery date, determines whether the delivery date included in the delivery information of the first item stored in the delivery information storing unit is later than the designated delivery date,
wherein the changing unit changes the delivery date which is determined by the second determining unit to be later than the designated delivery date among the delivery dates included in the delivery information of the first item stored in the delivery information storing unit, to the designated delivery date.

8. The information processing apparatus according to claim 1, further comprising:
a transmitting unit that, when the changing unit has changed the delivery date to a delivery date that is earlier than the delivery date before changing, sends an email for notifying a user who receives the first item of the change in the delivery date.

9. The information processing apparatus according to claim 1,
wherein the delivery information storing unit stores the delivery information for each slip used for delivery of items, the information processing apparatus,
the information processing apparatus further comprising:
a completion information acquiring unit that acquires completion information indicating completion of delivery of an item whose delivery information is stored in the delivery information storing unit;
a third determining unit that, when the completion information is acquired by the completion information acquiring unit, determines whether a plurality of items having different slips has been received in a batch by the user; and
a first reward information storage controlling unit, when the third determining unit determines that a plurality of items having different slips has been received in a batch by the user, stores reward information in a reward information storing unit that stores the reward information indicating a reward that the user obtains.

10. The information processing apparatus according to claim 1, further comprising:
a fourth determining unit that determines whether the item has been received by the user at the first delivery based on a history stored in a history storing unit that stores the history of a delivery state of an item whose delivery information is stored in the delivery information storing unit; and
a second reward information storage controlling unit that, when the fourth determining unit determines that the item has been received by the user at the first delivery, stores the reward information in a reward information storing unit that stores the reward information indicating reward information that the user obtains.

11-13. (canceled)

14. A method, comprising:
receiving designation of future time by a user via network, irrespective of process of an order of an item;
determining whether time associated with delivery of an item to be ordered is designated by an user in the process of ordering the item to be ordered via network or not;
arranging, if determined not, the time associated with delivery of the item to be ordered based on the designated future time; and
otherwise arranging the time associated with delivery of the item to be ordered as designated.

15. The method according to claim 11, further comprising:
when another item whose time associated with delivery is arranged based on the designated future time is present, determining whether the time associated with delivery of the another item is changeable based on the designated time associated with delivery of the item to be ordered.

16. The method according to claim 12,
wherein the otherwise arranging includes changing, if determined as changeable, the time associated with delivery of the another item based on the designated time associated with delivery of the item to be ordered, and otherwise maintaining the time associated with delivery of the another item.

17. The method according to claim 11, further comprising:
acquiring information on relationship between users via network, irrespective of process of an order of an item; and
determining whether at least one of the determining step and the otherwise arranging step is to be executed or not based on the acquired information on relationship.

18. A method, comprising:
asking a user whether it is allowed to deliver a plurality of items together or not via network; and
performing a process for granting at least one point to the user when a response that it is allowed to deliver the plurality of items together is received.
